(19) United States
(12) Patent Application Publication
(10) Pub. No.: US 2026/0167783 A1
(43) Pub. Date: Jun. 18, 2026

(54) STABILIZER COMPOSITION

(71) Applicant: BASF SE, Ludwigshafen am Rhein (DE)

(72) Inventors: Bernd HOEVEL, Ludwigshafen am Rhein (DE); Rou Hua CHUA, Ludwigshafen am Rhein (DE); Thomas HINKEL, Ludwigshafen am Rhein (DE); Peter GAST, Ludwigshafen am Rhein (DE); Lothar SEIDEMANN, Ludwigshafen am Rhein (DE)

(21) Appl. No.: 18/577,292

(22) PCT Filed: Jul. 4, 2022
(86) PCT No.: PCT/EP2022/068403

§ 371 Date: Jan. 8, 2024

(30) Foreign Application Priority Data
Jul. 9, 2021 (EP) 21184755.3

(51) Int. Cl. C08J 3/12; C08J 3/22; C08K 5/134; C08K 5/375; C09D 7/63; C09D 7/65; C09J 11/06; C09J 11/08

(52) U.S. Cl. CPC C08J 3/12; C08J 3/226; C08K 5/1345; C08K 5/375; C09D 7/63; C09D 7/65; C09J 11/06; C09J 11/08; C08J 2301/02

(57) ABSTRACT

Presently claimed invention is directed to a stabilizer composition in granulate form (S) comprising of at least one stabilizer compound (B) having at least one thioether functionality using microfibrillar cellulose (A) via a novel process for the manufacture of flowable, non-dusty granulates with improved storage stability.

### FIELD OF THE INVENTION

Presently claimed invention is directed to a stabilizer composition in granulate form (S) comprising of at least one stabilizer compound (B) having at least one thioether functionality using microfibrillar cellulose (A)

### BACKGROUND OF THE INVENTION

Presently claimed invention is directed to a stabilizer composition for polymers comprising microfibrillar cellulose and at least one thioether compound. Polymers, such as natural rubber, synthetic rubber such as butyl rubber, ethylene-propylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefine-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymers find versatile applications in many fields due to their interesting properties. However, often these materials can only be used, if they are well stabilized against degradation induced by heat, light, mechanical stress, etc. Thus, it is advisable to stabilize hot melt adhesives in order to protect them from degradation induced by heat, light, mechanical stress, etc.

Stabilizer compounds having at least one thioether functional group such as Irganox 1726 etc. are well known stabilizers to protect the polymers from degradation induced by heat, light, mechanical stress, etc. However, one problem associated with the stabilizer compounds having at least one thioether functional group, such as Irganox 1726 is their low melting temperature. Thus, these stabilizer compounds tend to form solid masses or tend to cake which makes storage and subsequent dosing difficult. It is desirable to provide these thioether stabilizers in the form of powder or granules, which can be stored and can used without any or at least little caking effect for long time.

Thus, it is an object of the presently claimed invention to provide a stabilizer composition in the form of powder or granules.

### SUMMARY OF THE INVENTION

Surprisingly, it has been found that flowable, non-dusty, and storage-stable granulates can be manufactured by providing a composition (S) comprising
a. microfibrillar cellulose (A);
b. at least one stabilizer compound (B) having at least one thioether functional group; and
c. at least one component (C) selected from the group consisting of

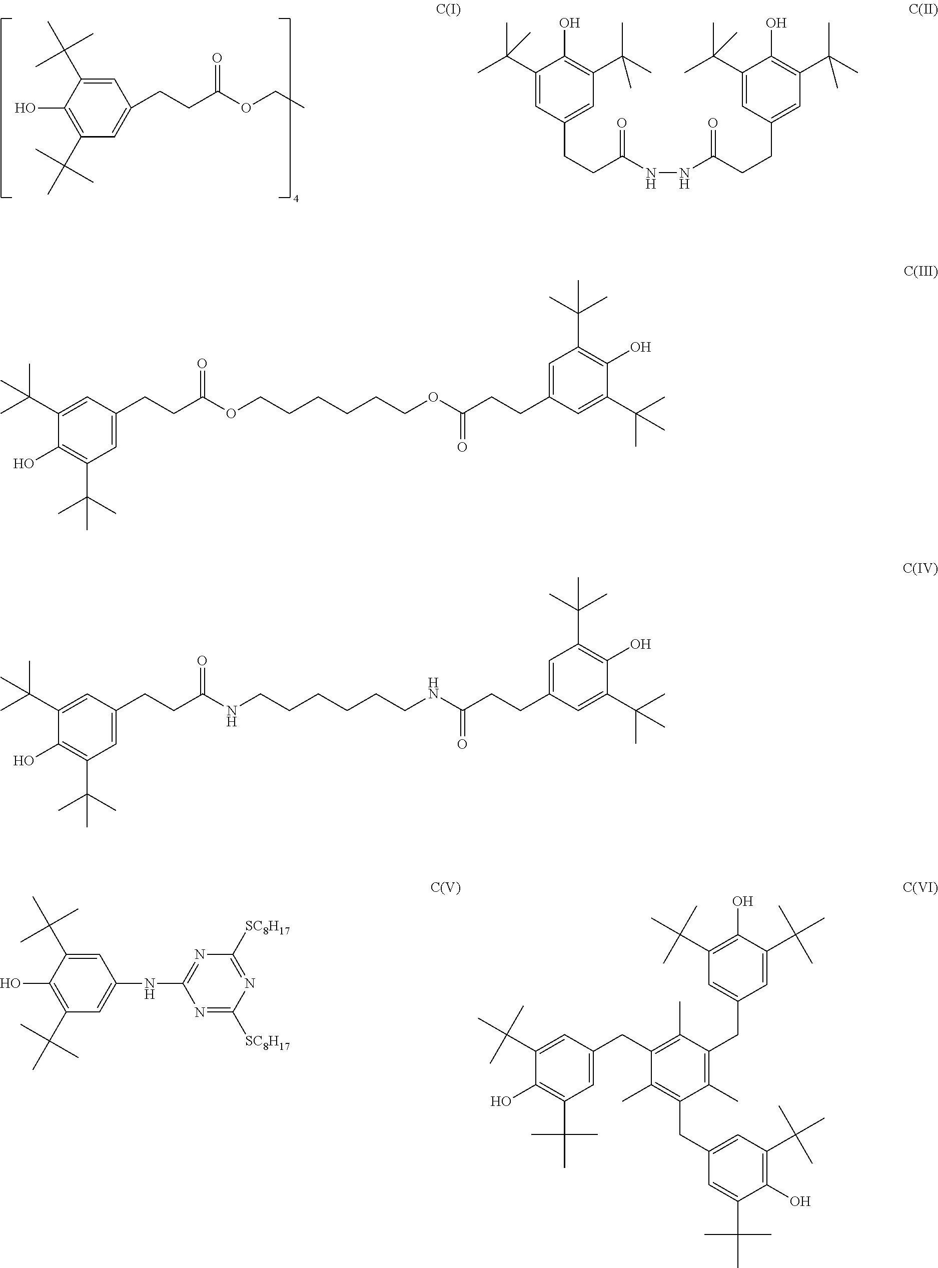

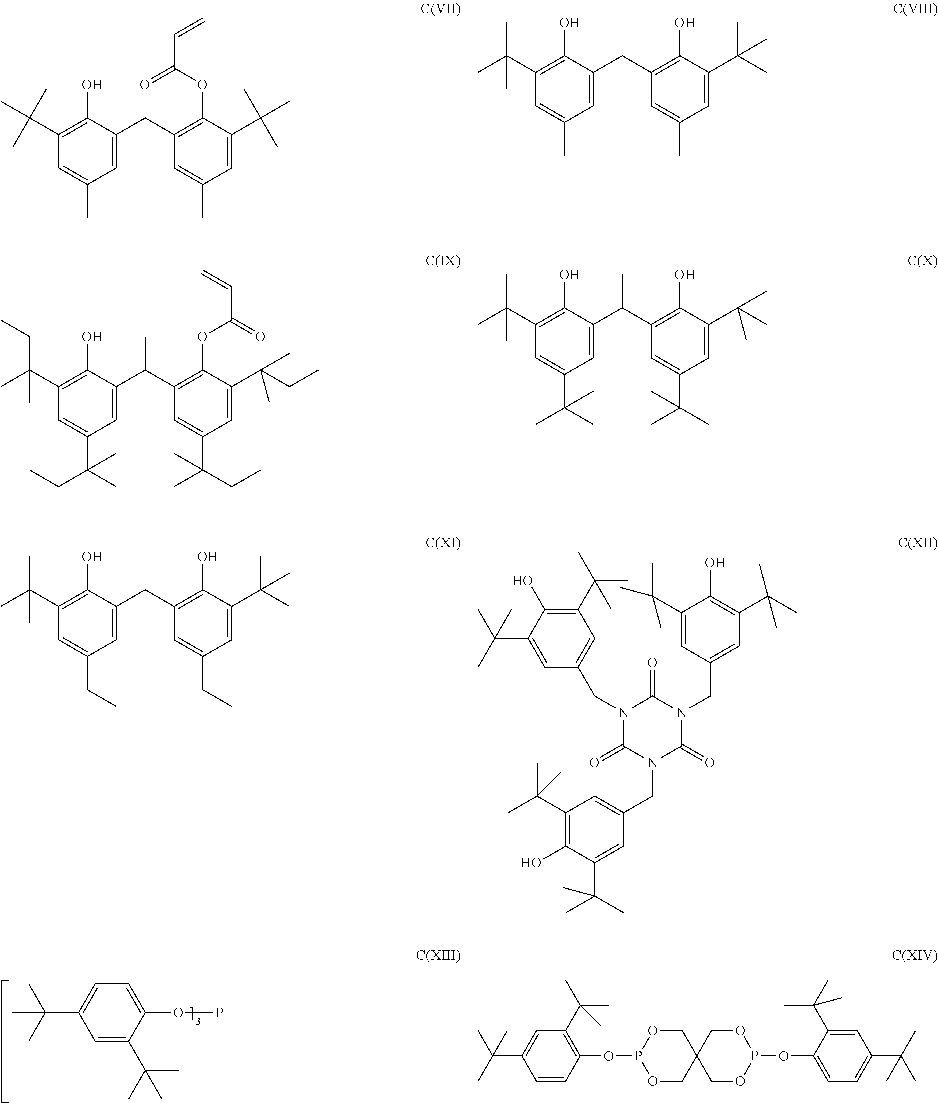

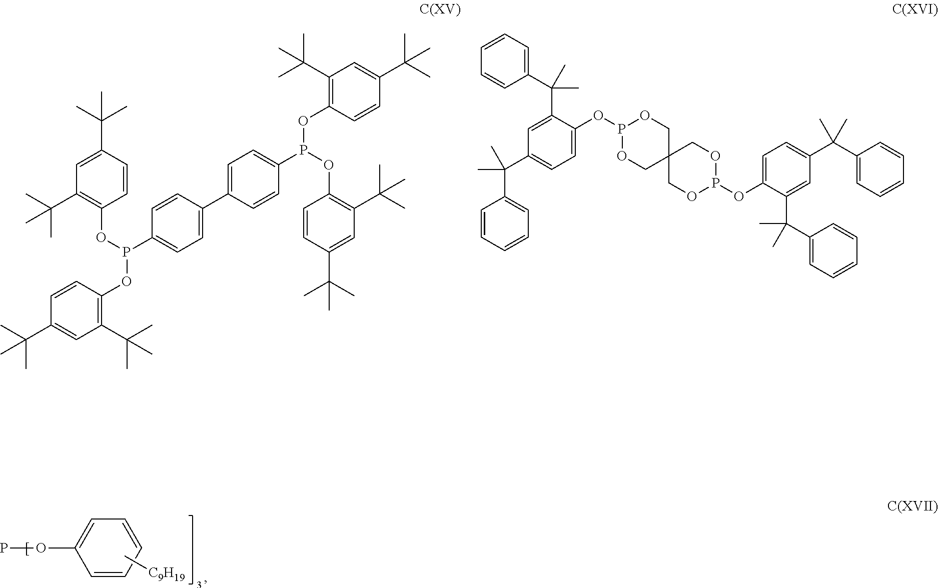

and mixtures thereof,
   wherein the at least one stabilizer (B) is at least partially absorbed on the microfibrillar cellulose (A) and wherein the absorbed stabilizer (B) is at least partly coated with component (C).

Thus, in a first aspect, the presently claimed invention is directed to a composition (S) comprising
a. microfibrillar celluose (A);
b. at least one stabilizer compound (B) having at least one thioether functional group; and
c. at least one component (C) selected from the group consisting of

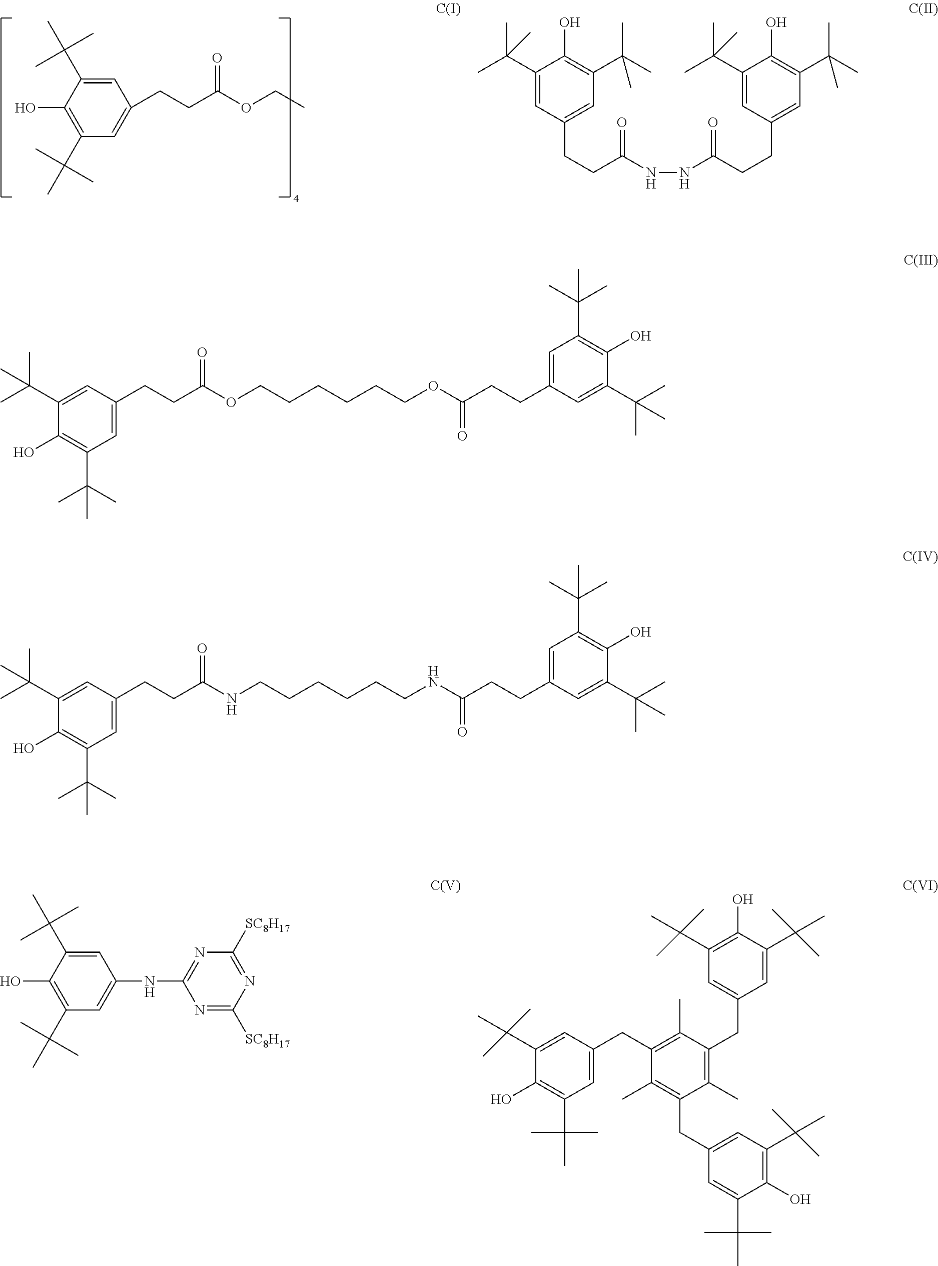

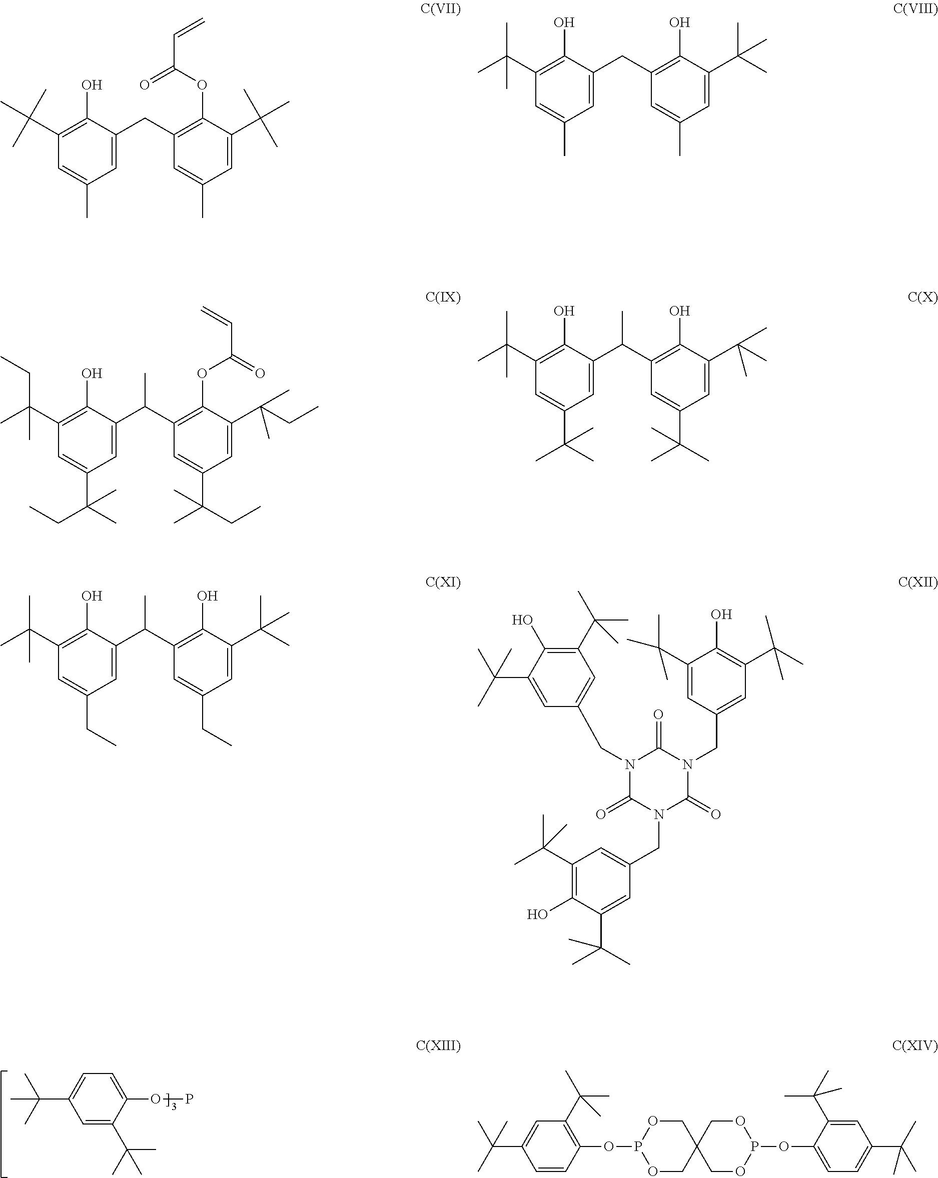

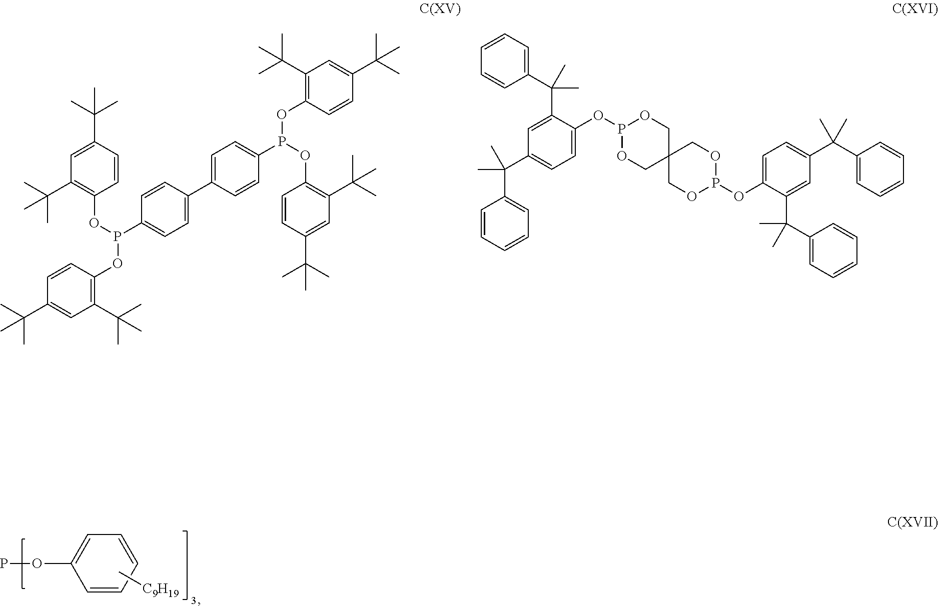

and mixtures thereof,
wherein the at least one stabilizer (B) is at least partially absorbed on the microfibrillar cellulose (A) and wherein the absorbed stabilizer (B) is at least partly coated with component (C).

In a second aspect of the presently claimed invention is directed to a process for the preparation of a composition (S) comprising the steps of:
a. providing microfibrillar cellulose (A);
b. providing at least one component (C) to obtain a mixture of component (A) and at least one component (C); and
c. dispensing at least one stabilizer (B) to the mixture obtained in step b. to obtain a ternary mixture,
e. mixing the ternary mixture obtained step c to obtain a homogenous composition,
   wherein component (A), stabilizer (B) and component (C) are as defined as in first aspect.

The third aspect of the presently claimed invention is directed to a stabilized hot melt adhesive composition comprising:
i. at least one hot melt adhesive material selected from the group consisting of natural rubber, synthetic rubber such as butyl rubber, ethylene-propylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymerspolyolefine, polyurethane, polyimide, and mixture thereof; and
ii. a composition (S) according to the first aspect.

The fourth aspect of the presently claimed invention is directed to a method of stabilizing a hot melt adhesive against degradation by one or more of light, oxygen, and heat, comprising the steps of:
a. providing one or more hot melt adhesive materials selected from the group consisting of natural rubber, synthetic rubber such as butyl rubber, ethylenepropylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyurethane, polyimide, silane-modified polyolefin, silane-modified polyether, silane-modified polyurethane and silane-modified acrylic polymers, and mixture thereof; and
b. adding a composition (S) according to the first aspect.

The fifth aspect of the presently claimed invention is directed to the use of a composition (S) according to the first aspect, for stabilizing a hot melt adhesive, stabilizing sealants, and coatings, especially industrial coatings.

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’. ‘c’, etc. and the like in the description and in the claims, are used for distinguishing between similar elements and not necessarily for describing a sequential or chronological order. It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)’ and ‘(C)’ or ‘(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment, but may.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

In a first embodiment, the presently claimed invention is directed to a composition (S) comprising
a. microfibrillar cellulose (A);
b. at least one stabilizer compound (B) having at least one thioether functional group; and
c. at least one component (C) selected from the group consisting of

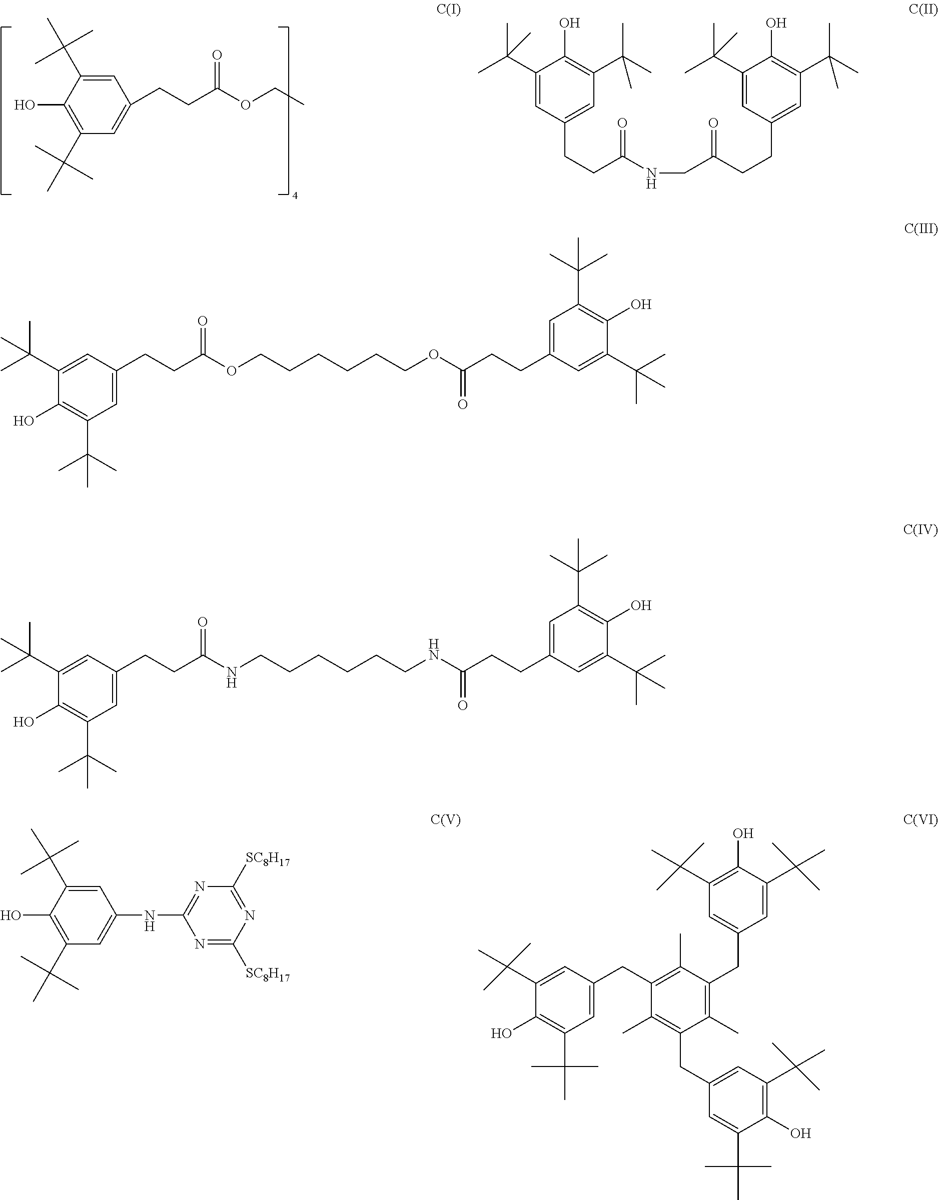

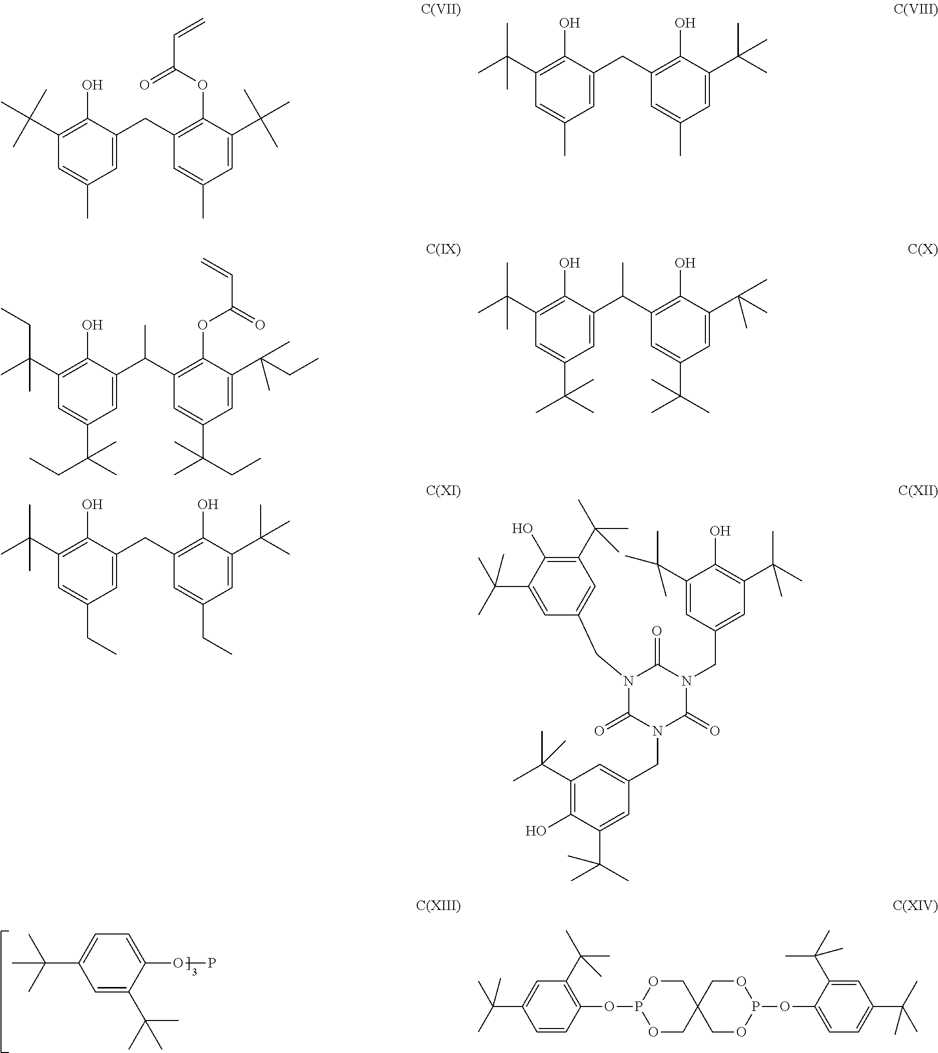

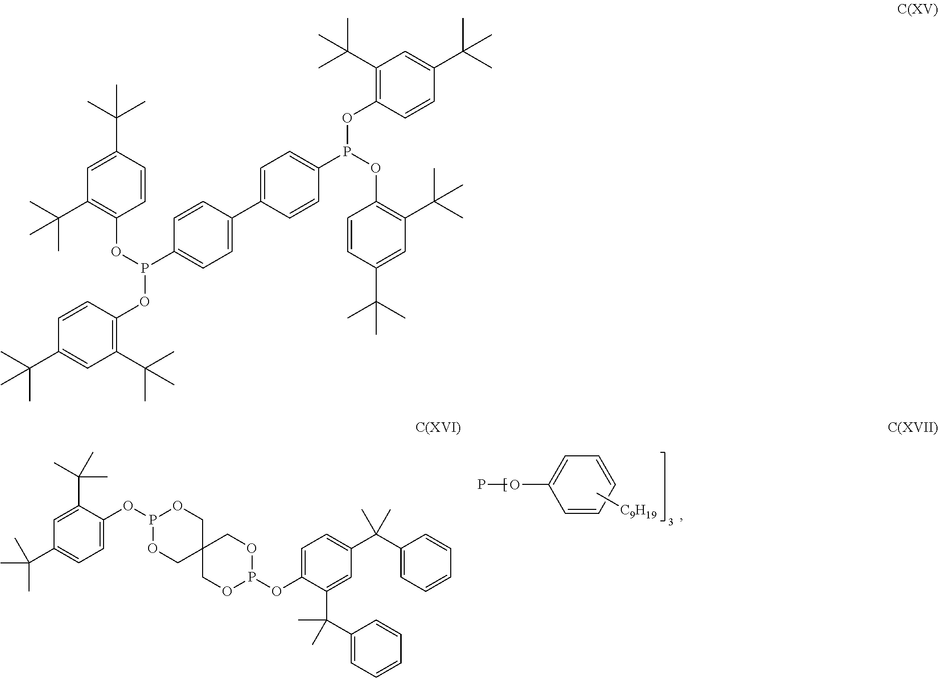

and mixtures thereof,
wherein the at least one stabilizer compound (B) is at least partially absorbed on the microfibrillar cellulose (A) and the absorbed stabilizer compound (B) is at least partly coated with component (C).

More preferably, the composition (S) comprises
a. microfibrillar cellulose (A);
b. at least one stabilizer component (B) having at least one thioether functional group; and
c. at least one component (C) selected from the group consisting of

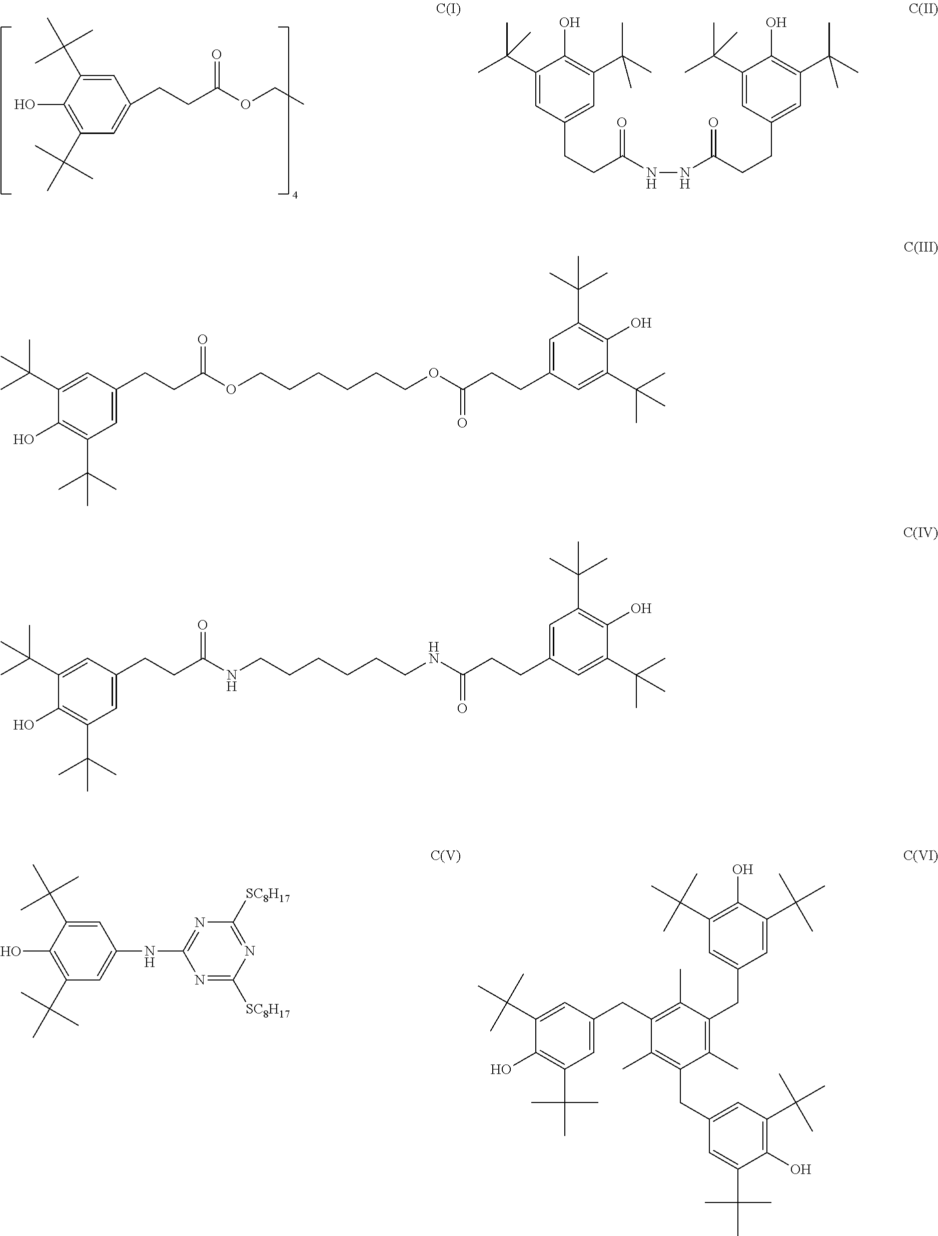

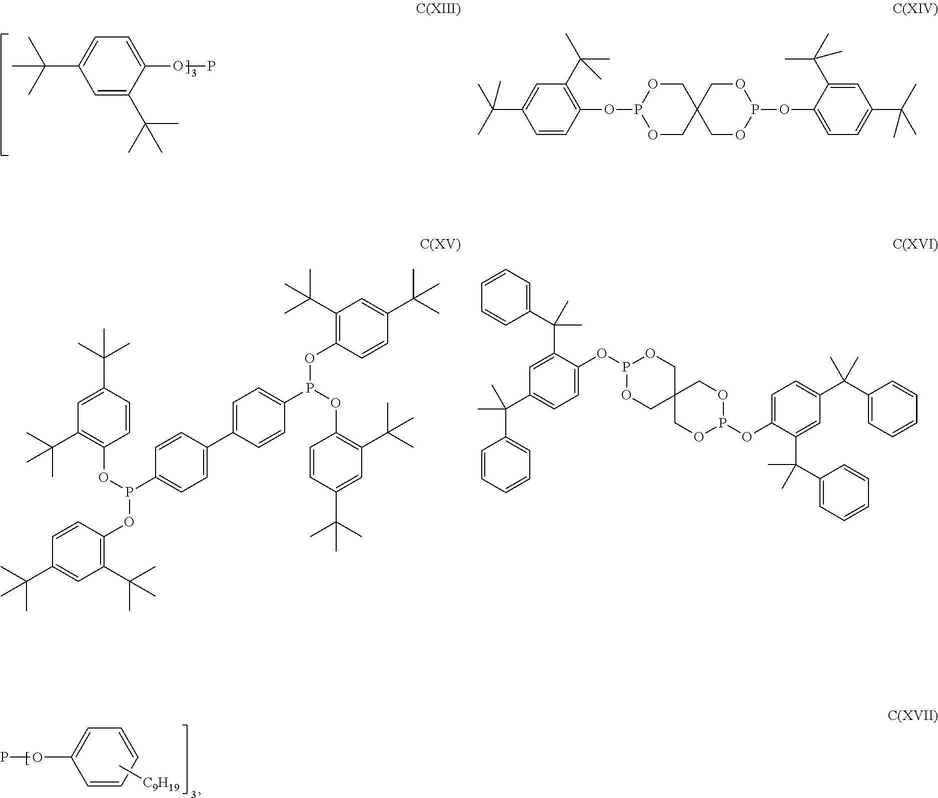

and mixtures thereof,
wherein the at least one stabilizer compound (B) is at least partly absorbed on the microfibrillar celluose (A) and the absorbed stabilizer compound (B) is at least partly coated with component (C).

Most preferably the composition (S) comprises
a. microfibrillar cellulose (A);
b. at least one stabilizer compound (B) having at least one thioether functional group; and
c. at least one component (C) selected from the group consisting of

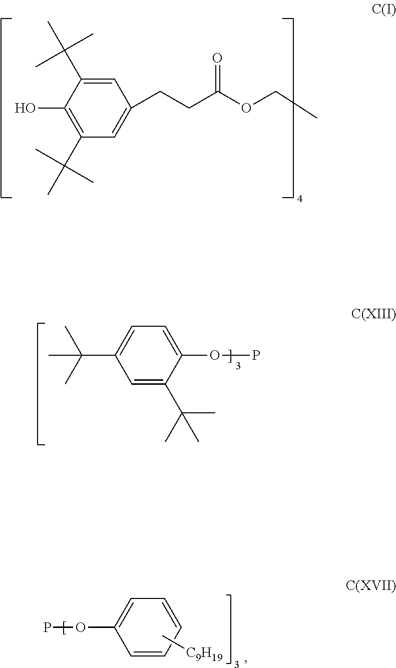

and mixtures thereof,
wherein the at least one stabilizer compound (B) is at least partly absorbed on the microfibrillar cellulose (A) and the absorbed stabilizer compound (B) is at least partly coated with component (C).

In another preferred embodiment, the presently claimed invention is directed to a composition (S) comprising
a. microfibrillar cellulose (A);
b. at least one stabilizer (B) selected form the group consisting of

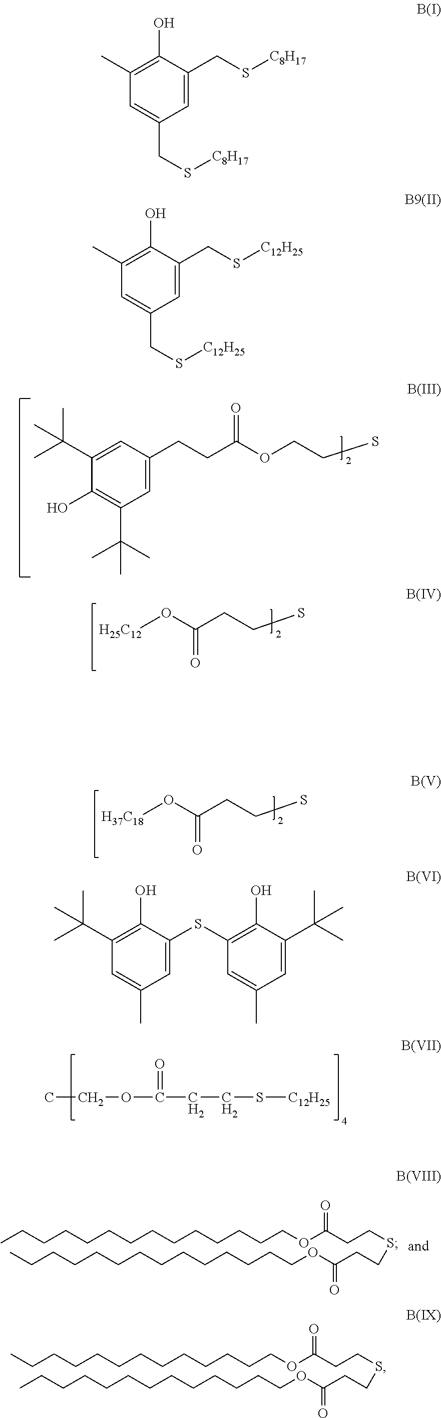

and mixtures thereof,
c. at least one component (C) selected from the group consisting of

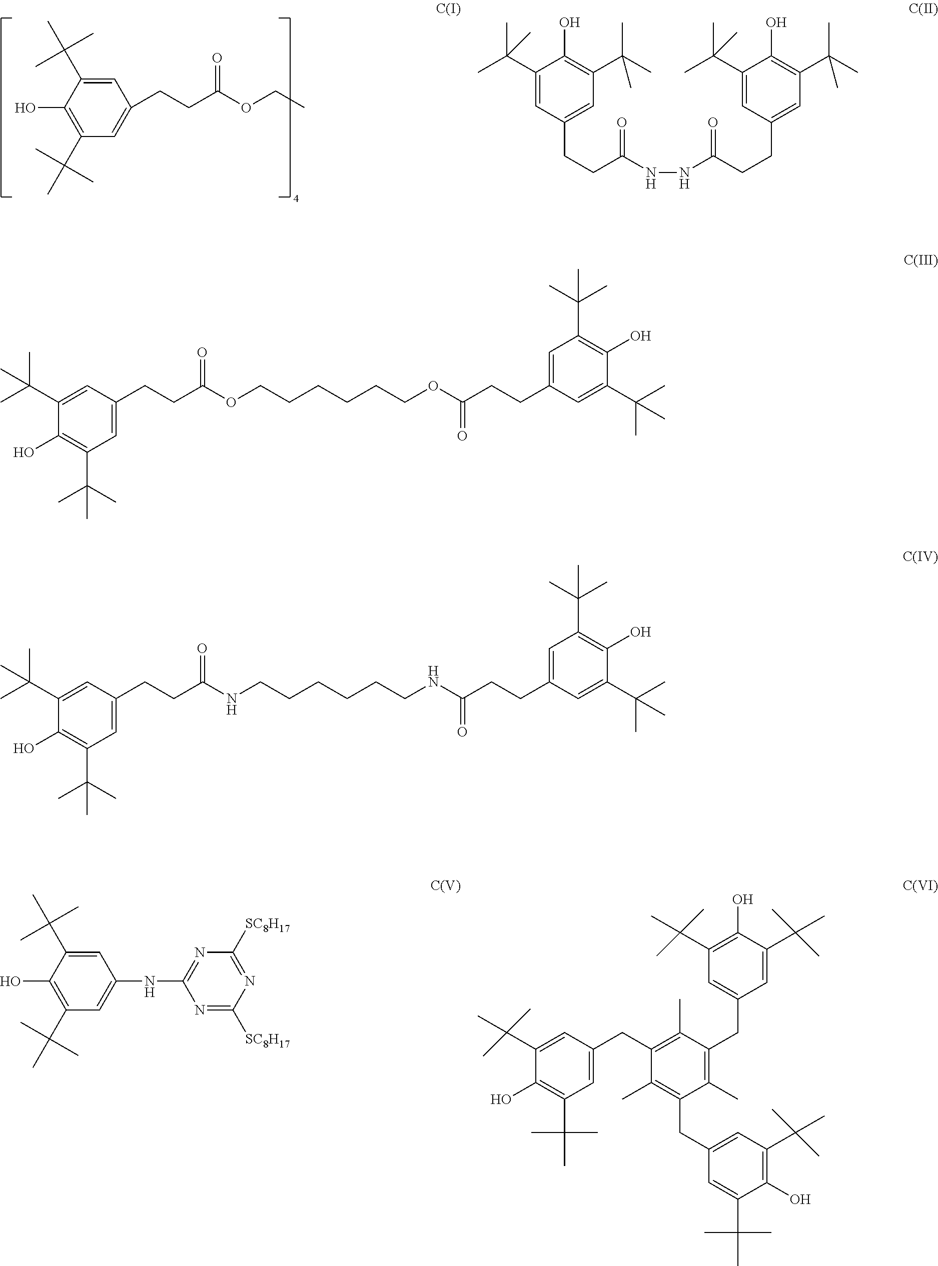

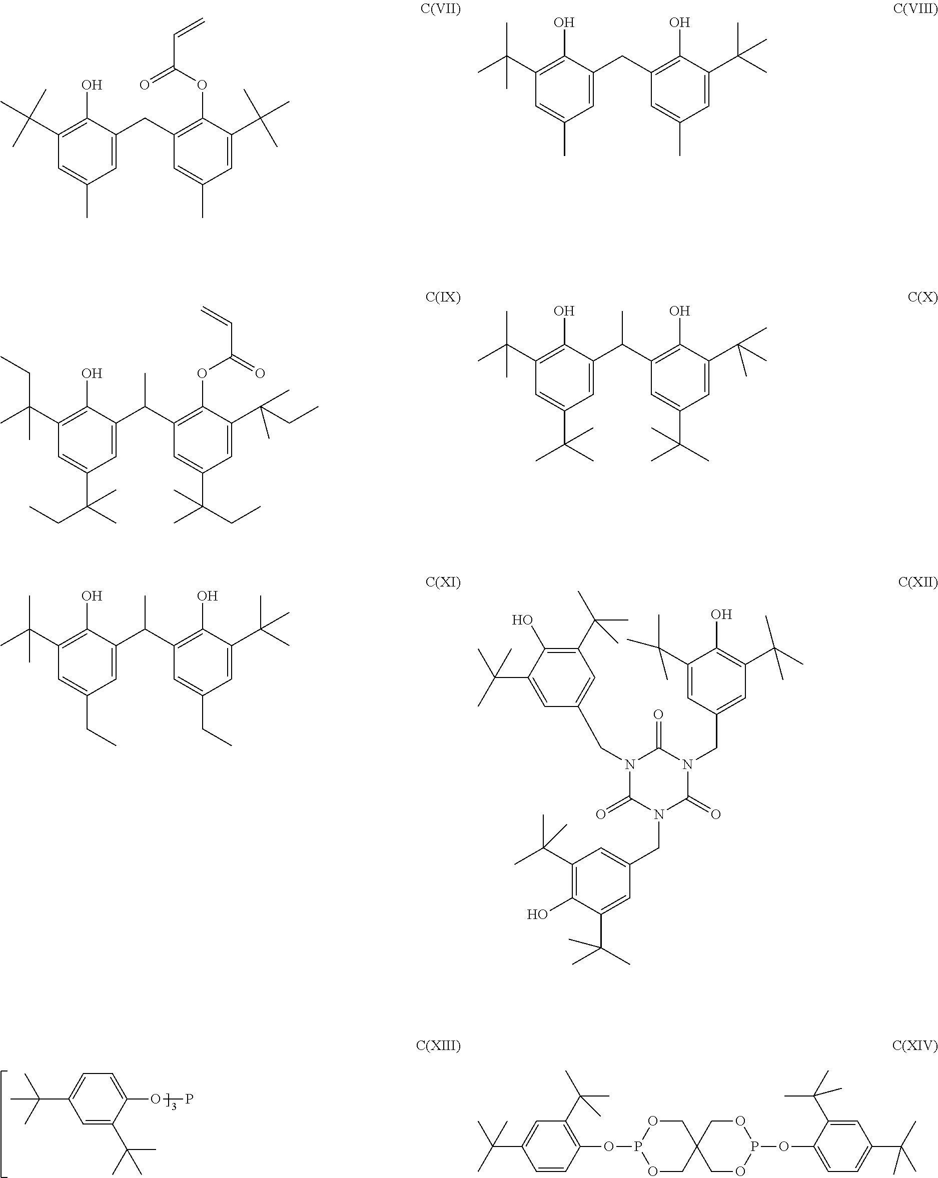

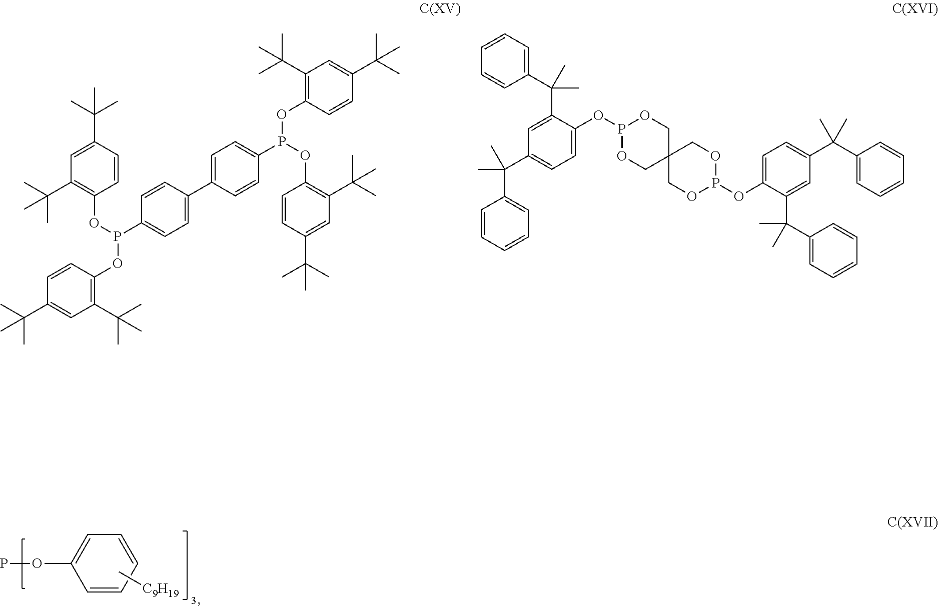

and mixtures thereof,
wherein the at least one stabilizer (B) is at least partly absorbed on the microfibrillar cellulose (A) and the absorbed stabilizer (B) is at least partly coated with component (C).

More preferably, the presently claimed invention is directed to a composition (S) comprising
a. microfibrillar celluose (A);
b. at least one stabilizer (B) selected form the group consisting of

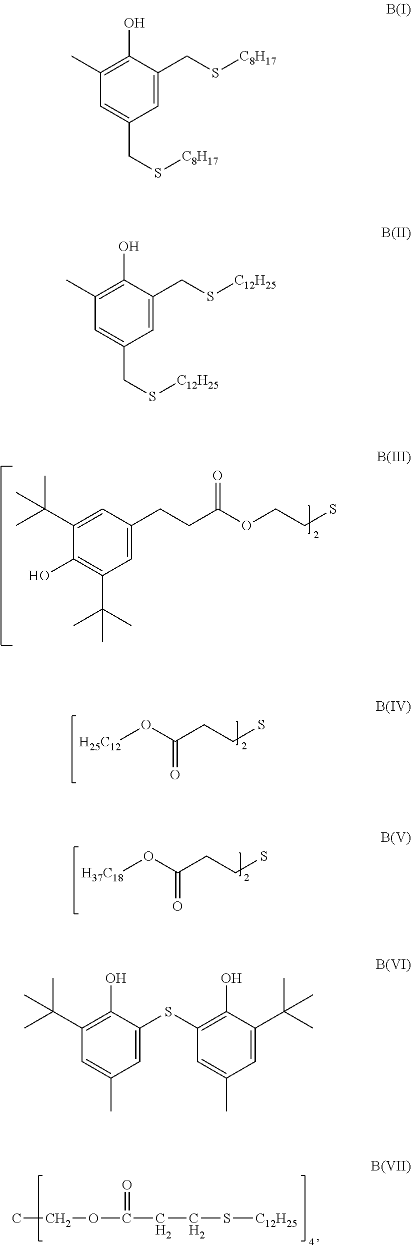

and mixtures thereof,
c. at least one component (C) selected from the group consisting of

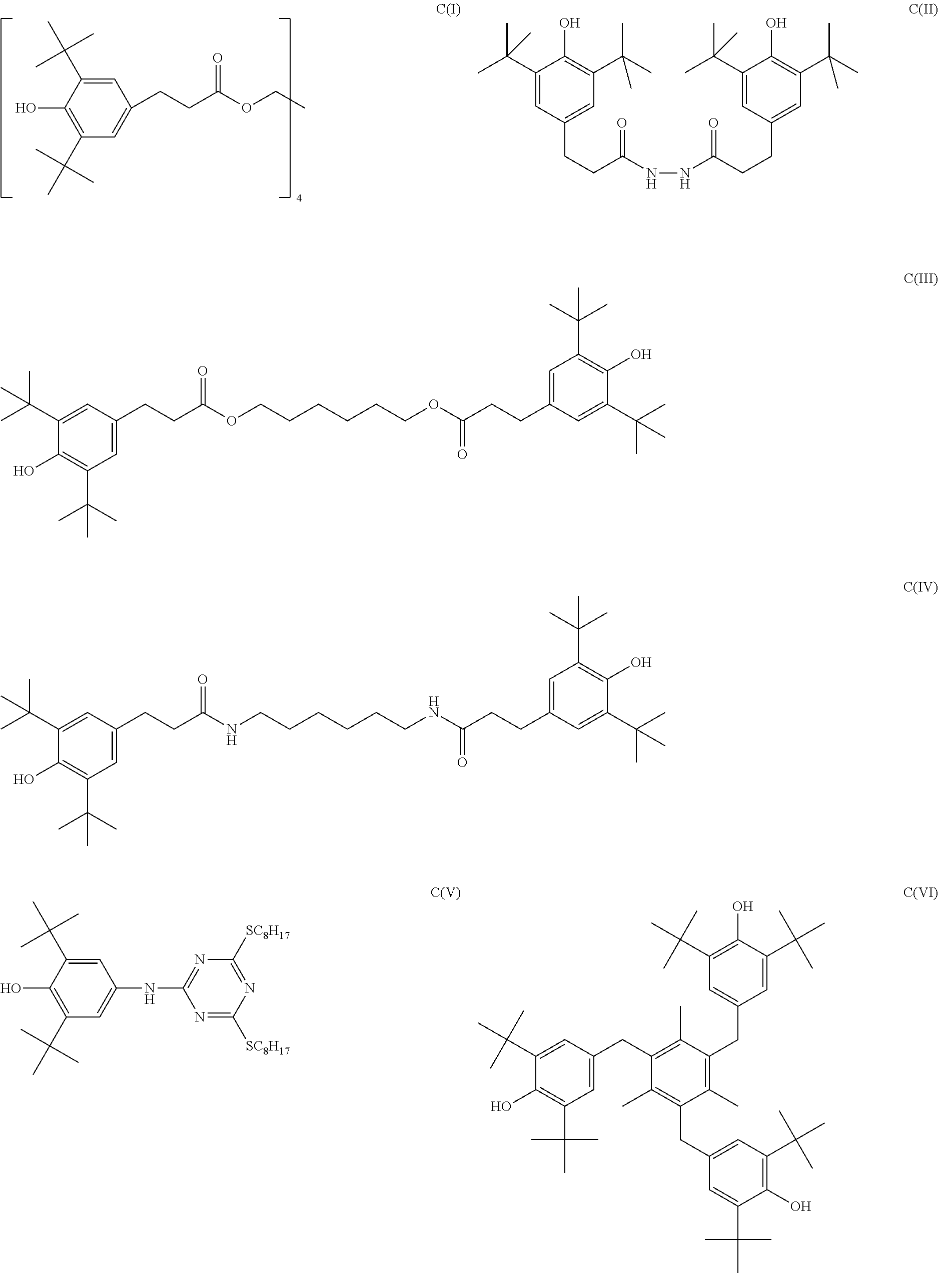

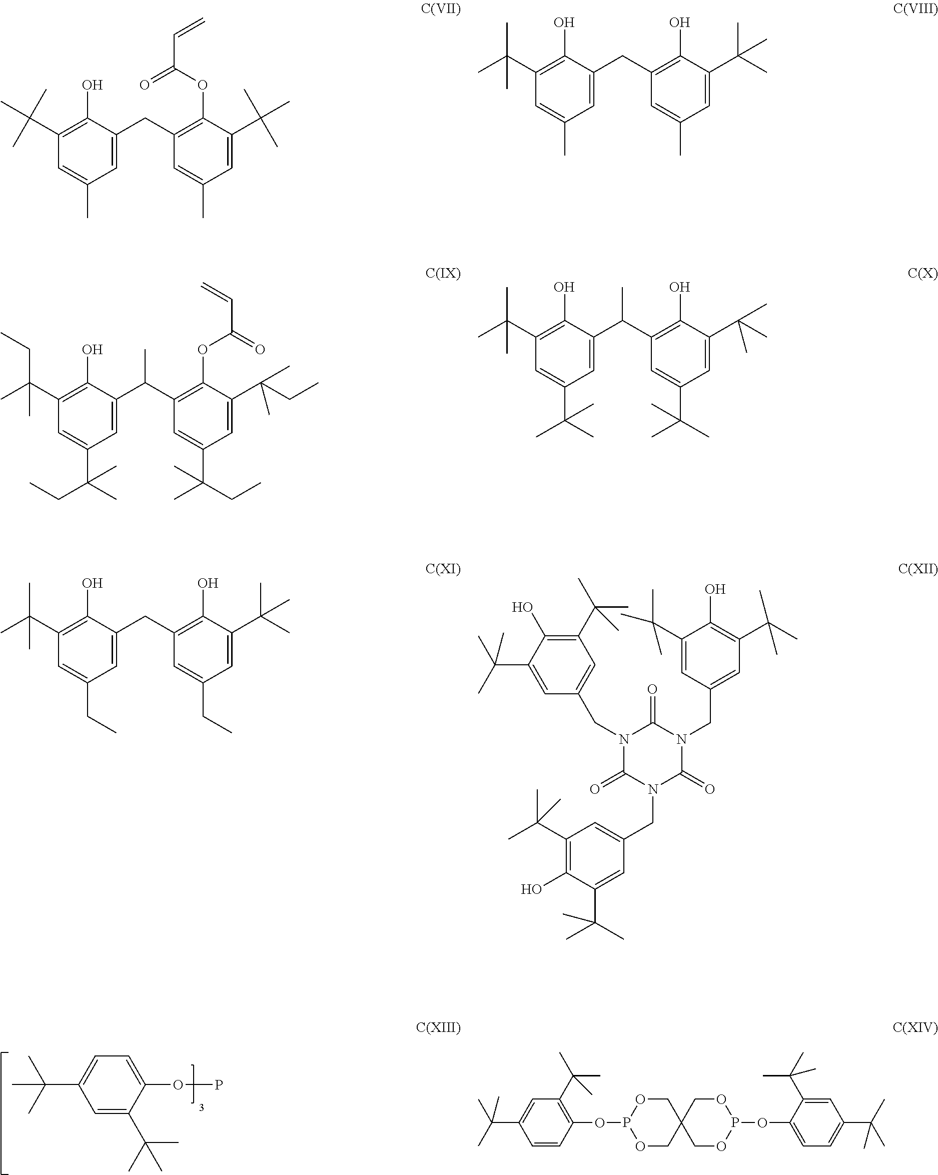

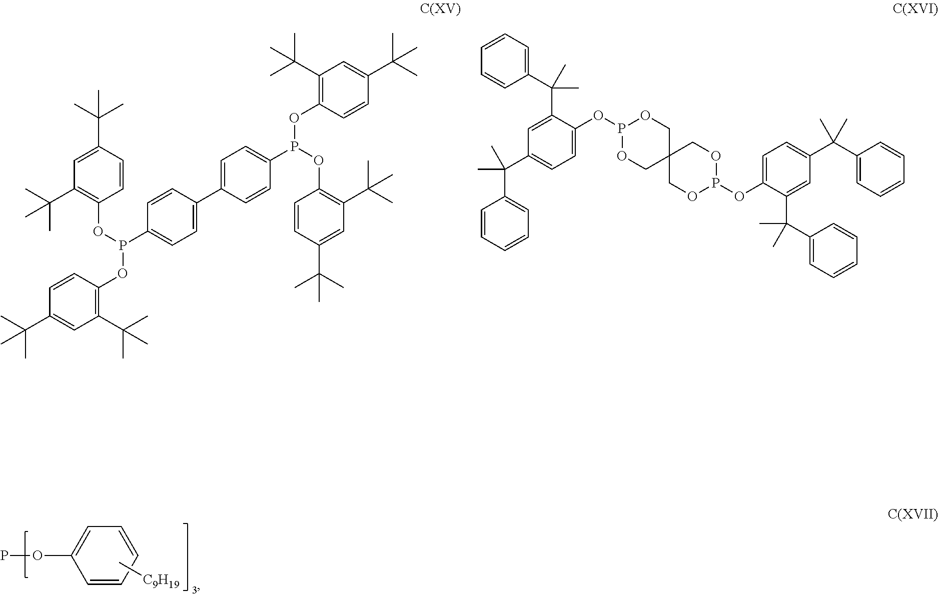

and mixtures thereof,
wherein the at least one stabilizer (B) is at least partly absorbed on the microfibrillar cellulose (A) and wherein the absorbed stabilizer (B) is at least partly coated with component (C).

Even more preferably, the presently claimed invention is directed to a composition (S) comprising
a. microfibrillar cellulose (A);
b. at least one stabilizer (B) selected form the group consisting of

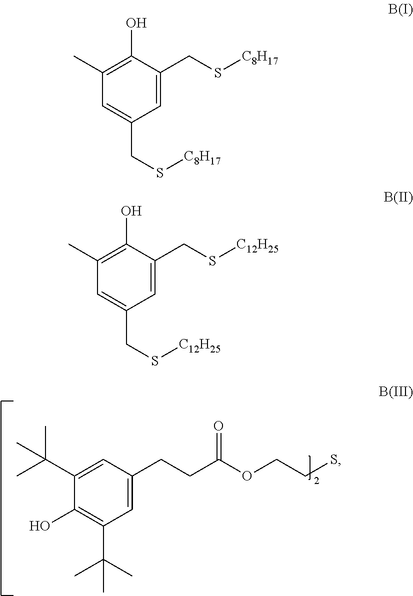

and mixtures thereof,
c. at least one component (C) selected from the group consisting of

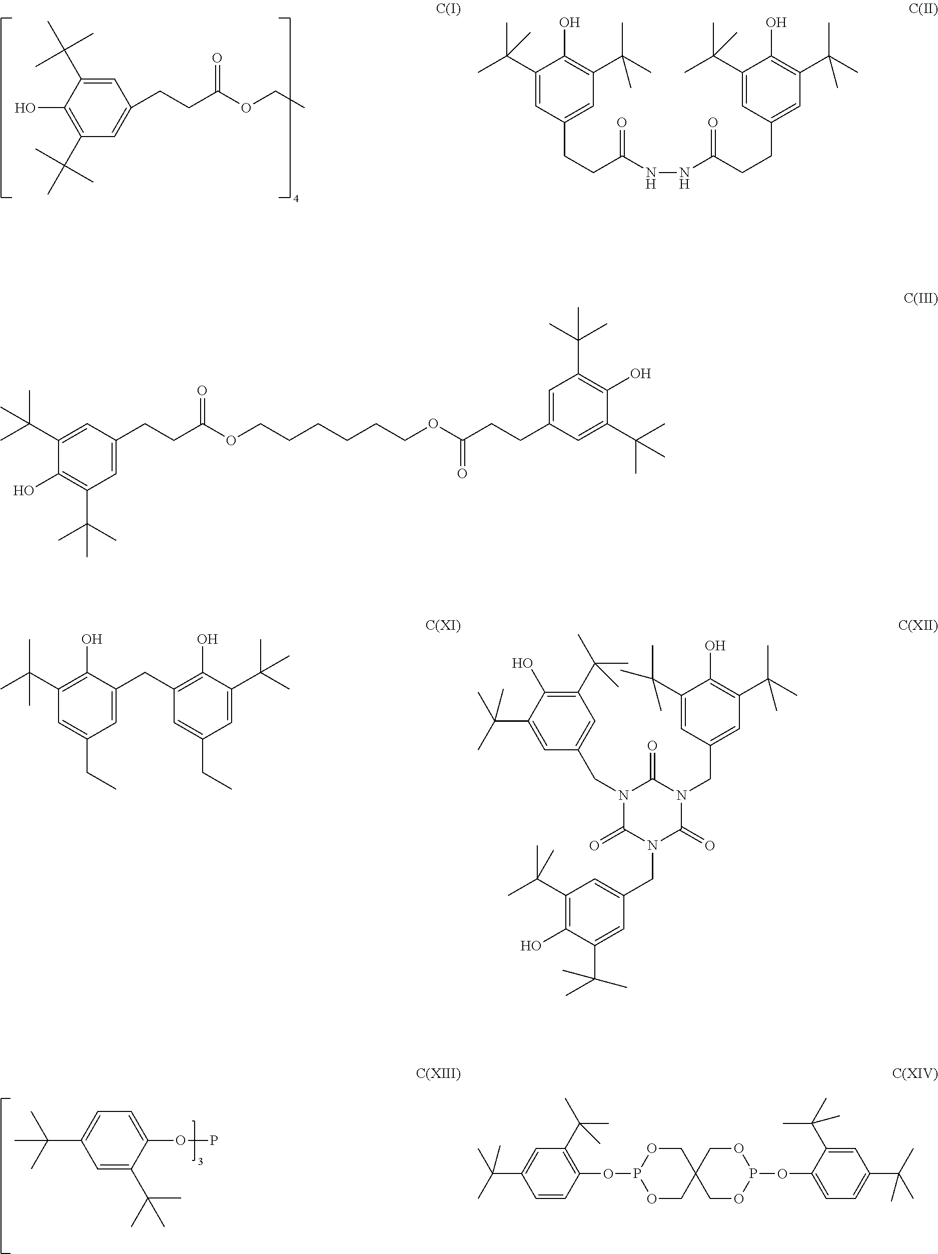

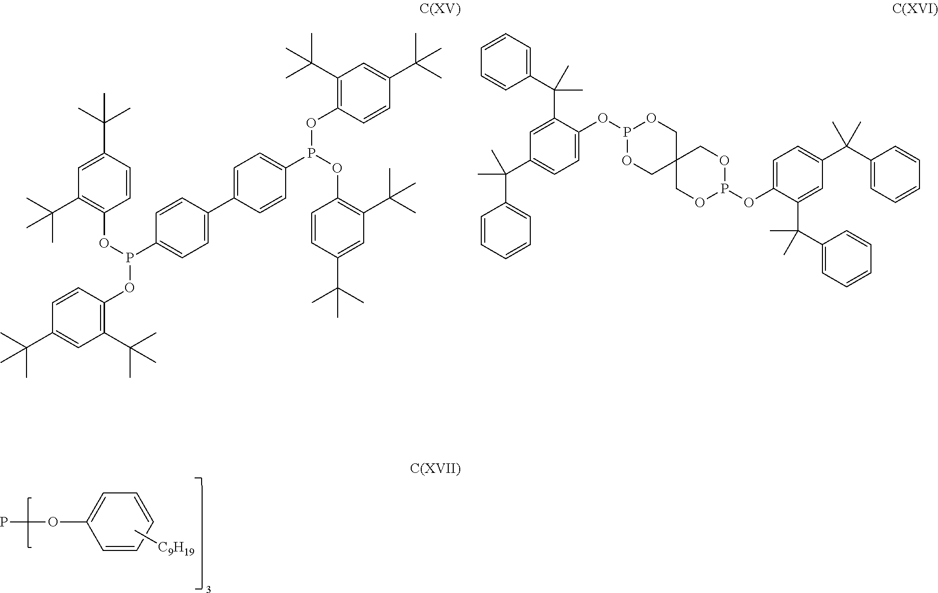

and mixtures thereof,
wherein the at least one stabilizer (B) is at least partly absorbed on the microfibrillar cellulose (A) and wherein the absorbed stabilizer (B) is at least partly coated with component (C).

Most preferably, the presently claimed invention is directed to a composition (S) comprising
a. microfibrillar cellulose (A);
b. at least one stabilizer (B) selected form the group consisting of

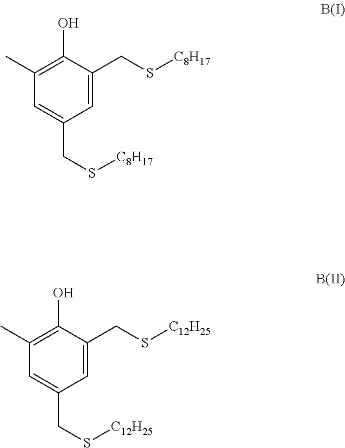

and mixtures thereof,
c. at least one component (C) selected from the group consisting of

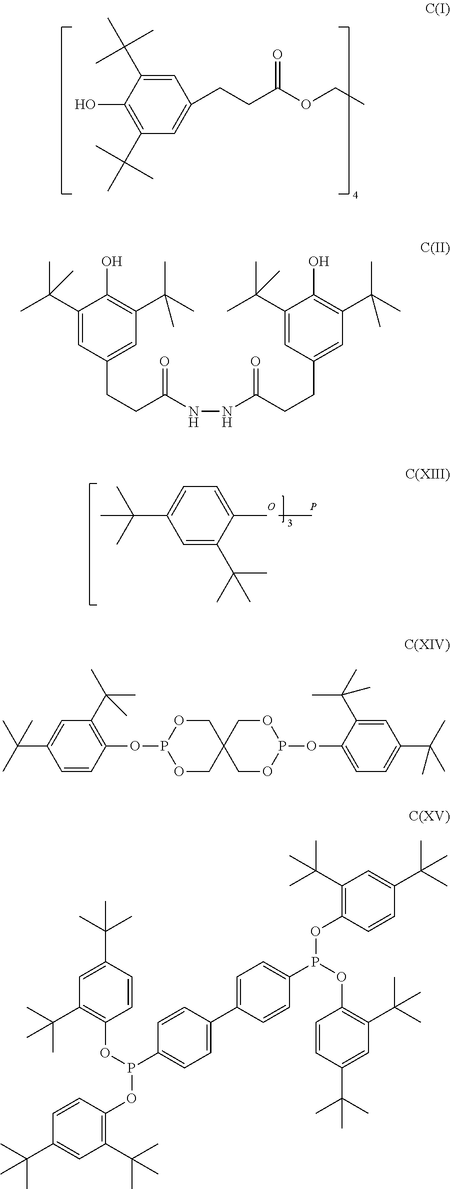

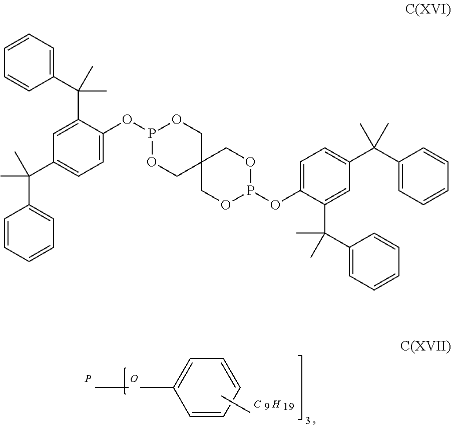

and mixtures thereof,
wherein the at least one stabilizer (B) is at least partly absorbed on the microfibrillar cellulose (A) and wherein the absorbed stabilizer (B) is at least partly coated with component (C).

In particular the presently claimed invention is directed to a composition (S) comprising
a. microfibrillar celluose (A);
b. at least one stabilizer (B) selected form the group consisting of

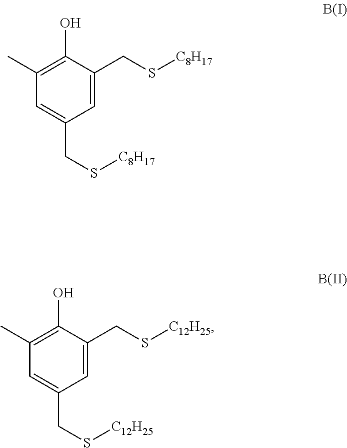

and mixture thereof,
c. at least one component (C) selected from the group consisting of

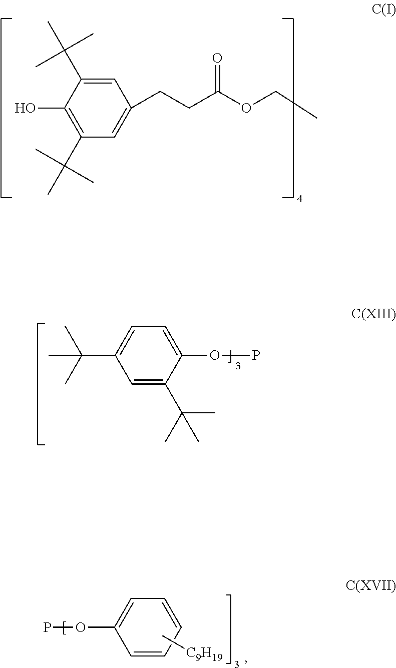

and mixtures thereof,
wherein the at least one stabilizer (B) is at least partly absorbed on the microfibrillar cellulose (A) and wherein the absorbed stabilizer (B) is at least partly coated with component (C).

The stabilizer (B) is at least partly absorbed on the microfibrillar cellulose (A). Preferably, 1 to 100 weight-% of the stabilizer (B) present in the composition (S) are absorbed on the microfibrillar cellulose (A). More preferably, 20 to 100 weight-%, even more preferably 50 to 100 weight-%, most preferably 70 to 100 weight-%, and in particular 90 to 100 weight-%, of the stabilizer (B) present in the composition (S) is absorbed on the microfibrillar cellulose (A).

The absorbed stabilizer (B) is at least partly coated with component (C). Preferably, 1 to 100% of the surface of the absorbed stabilizer (B) is coated with component (C). More preferably, 20 to 100% of the surface of the absorbed stabilizer (B) is coated with component (C). Even ore preferably 40 to 100% of the surface of the absorbed stabilizer (B) is coated with component (C). Most preferably, 60 to 100% of the surface of the absorbed stabilizer (B) is coated with component (C), and in particular preferably, 80 to 100% of the surface of the absorbed stabilizer (B) is coated with component (C).

Within the context of the presently claimed invention, the microfibrillar cellulose is defined as the microfibrils having network structure. In this network structure of the microfibrils there forms void space. Therefore, the stabilizer (B) is at least partly absorbed on the microfibrillar cellulose (A) means that the stabilizer (B) fills the void space in the microfibrillar cellulose network.

In another preferred embodiment, the microfibrillar cellulose according to presently claimed invention can be chemically unmodified and/or chemically modified.

In another preferred embodiment, the microfibrillar cellulose according to presently claimed invention is chemically unmodified cellulose.

In another preferred embodiment, the chemically modified microfibrillar cellulose includes cationically, anionically or nonionically modified celluloses such as methyl cellulose, carboxymethylcellulose (CMC), hydroxyethyl cellulose, methylhydroxycellulose, methylhydroxyethylcellulose or methylhydroxypropylcellulose etc.

In another preferred embodiment, the fiber in the microfibrillar cellulose according to presently claimed invention has an average length in the range of 10 to 1000 μm, more preferably the microfibrillar cellulose has an average length in the range of 10 to 500 μm, even more preferably the microfibrillar cellulose has an average length in the range of 10 to 300 μm, most preferably the microfibrillar cellulose has an average length in the range of 15 to 100 μm and in particular the microfibrillar cellulose has an average length in the range of 15 to 60 μm.

In another preferred embodiment, the fiber in the microfibrillar cellulose according to presently claimed invention has an average aspect ratio in the range of 1:1 to 1:6, more preferably the microfibrillar cellulose has an average aspect ratio in the range of 1:1 to 1:5, even more preferably the preferably the microfibrillar cellulose has an average aspect ratio in the range of 1:2 to 1:5, most preferably the microfibrillar cellulose has an average aspect ratio in the range of 1:2 to 1:4.

In another preferred embodiment, the at least one stabilizer (B) according to presently claimed invention is a thioether compound.

In another preferred embodiment, the stabilizer (B) according to presently claimed invention is a thioether compound having a melting point of less than 100° C., more preferably the stabilizer (B) is a thioether compound having a melting point of less than 80° C., even more preferably the stabilizer (B) is a thioether compound having a melting point of less than 50° C., most preferably the stabilizer (B) is a thioether compound having a melting point of less than 40° C., and in particular the stabilizer (B) is a thioether compound liquid at room temperature and atmospheric pressure. The melting point in each case is at atmospheric pressure.

In another preferred embodiment, the at least one stabilizer (B) is selected form the group consisting of

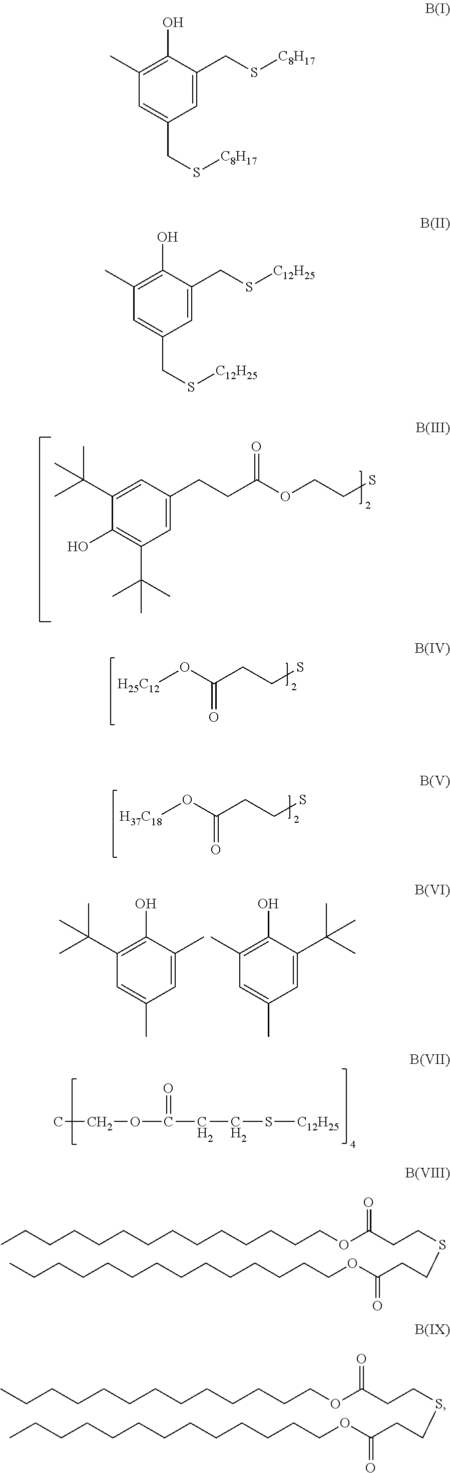

and mixtures thereof.

More preferably the stabilizer (B) is selected from the group consisting of

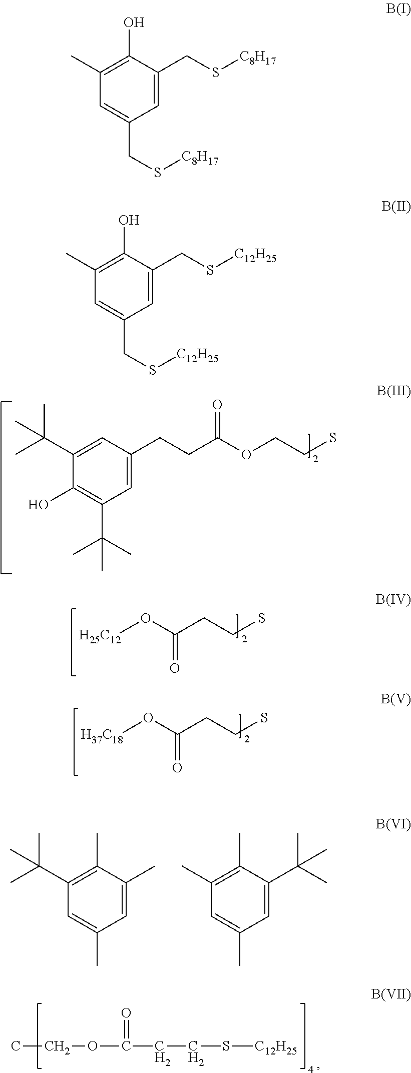

and mixtures thereof.

Even more preferably the stabilizer (B) is selected form the group consisting of

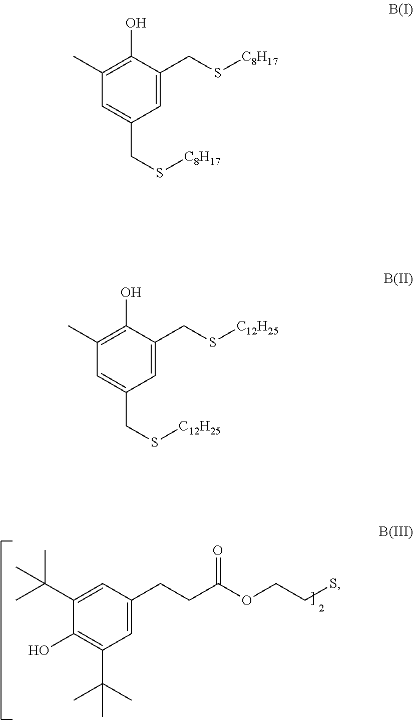

and mixtures thereof.

Most preferably the stabilizer (B) is selected form the group consisting of

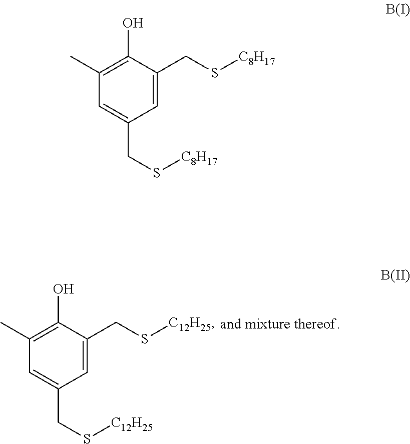

In particular the stabilizer (B) is

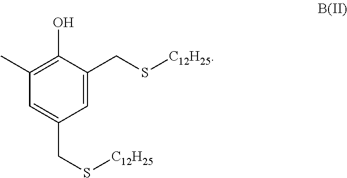

In another preferred embodiment, the weight ratio of the total amount of stabilizer (B) to the microfibrillar cellulose (A) is in the range of 1:10 to 10:1, more preferably the weight ratio is in the range of 1:7 to 7:1, even more preferably the weight ratio is in the range of 1:5 to 5:1, most preferably the weight ratio is in the range of 1:2 to 2:1, and in particular the weight ratio is 1.0:1.0.

In another preferred embodiment, the at least one component (C) according to presently claimed invention is selected from the group consisting of

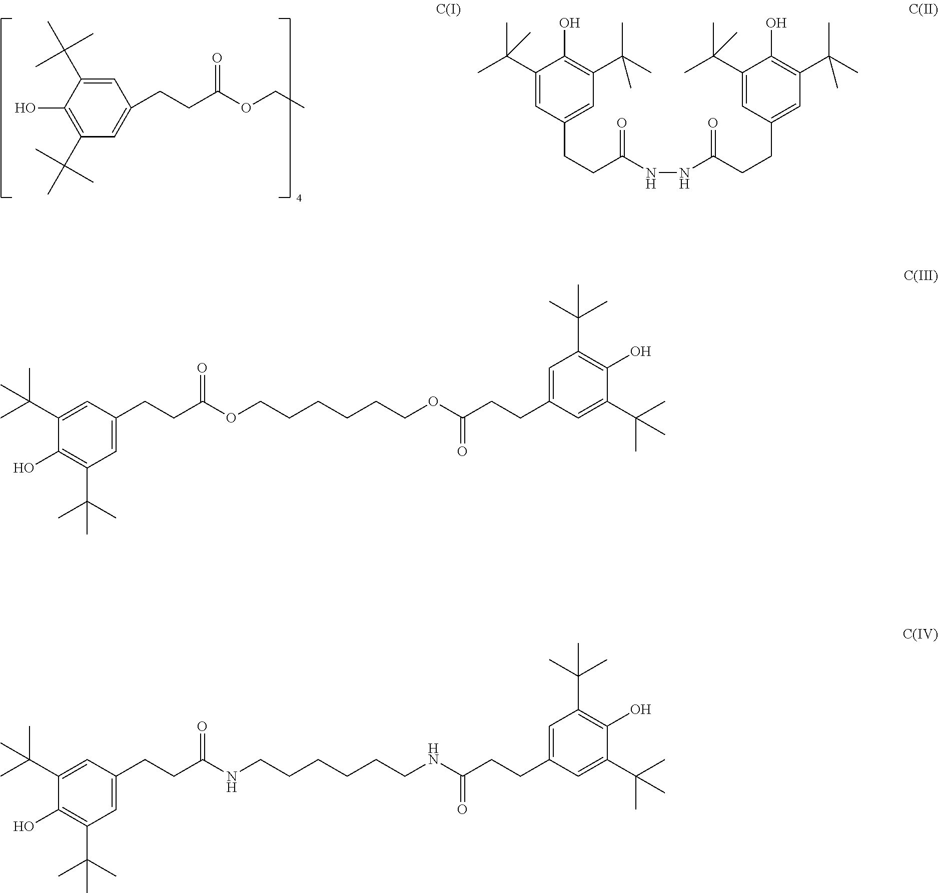

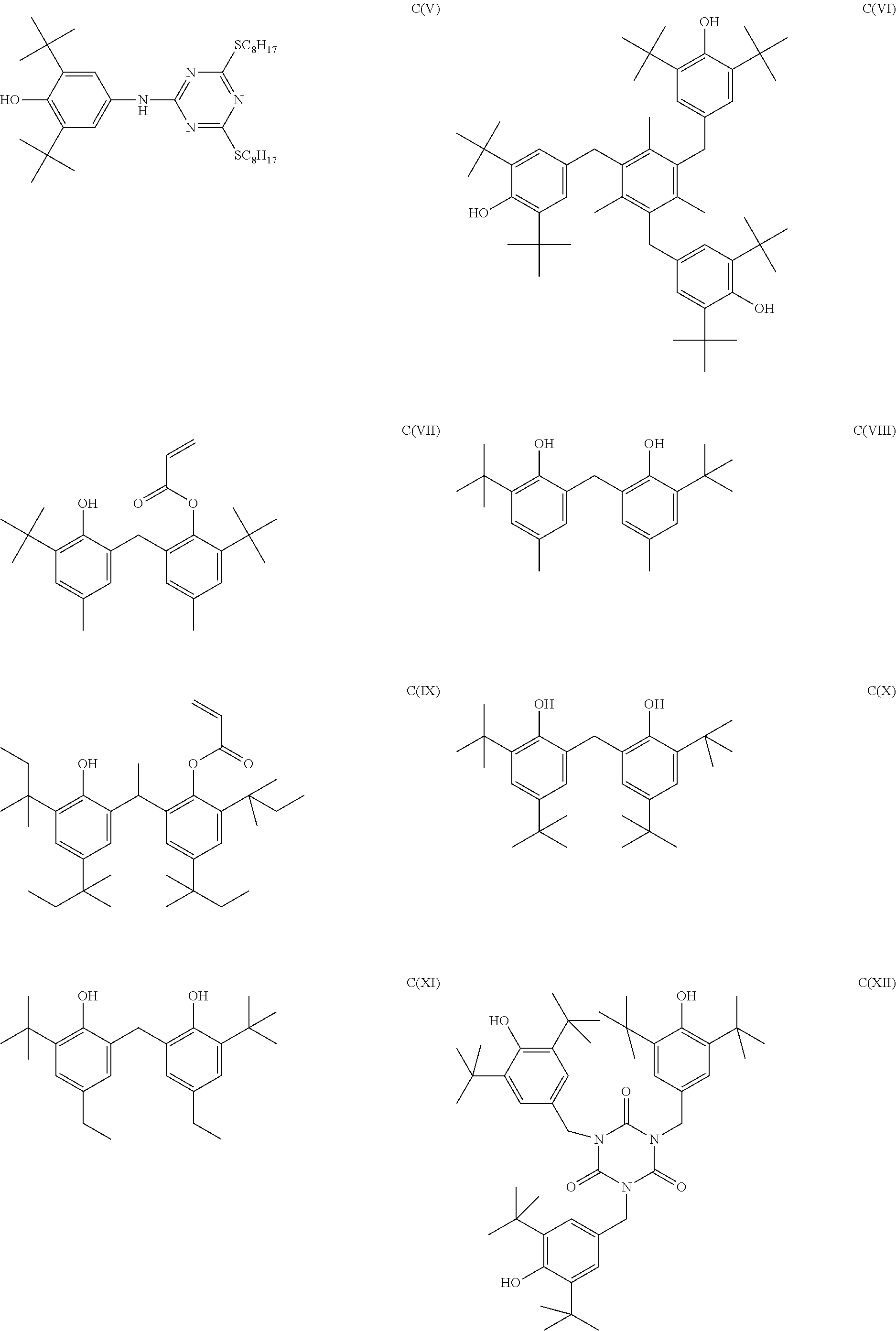

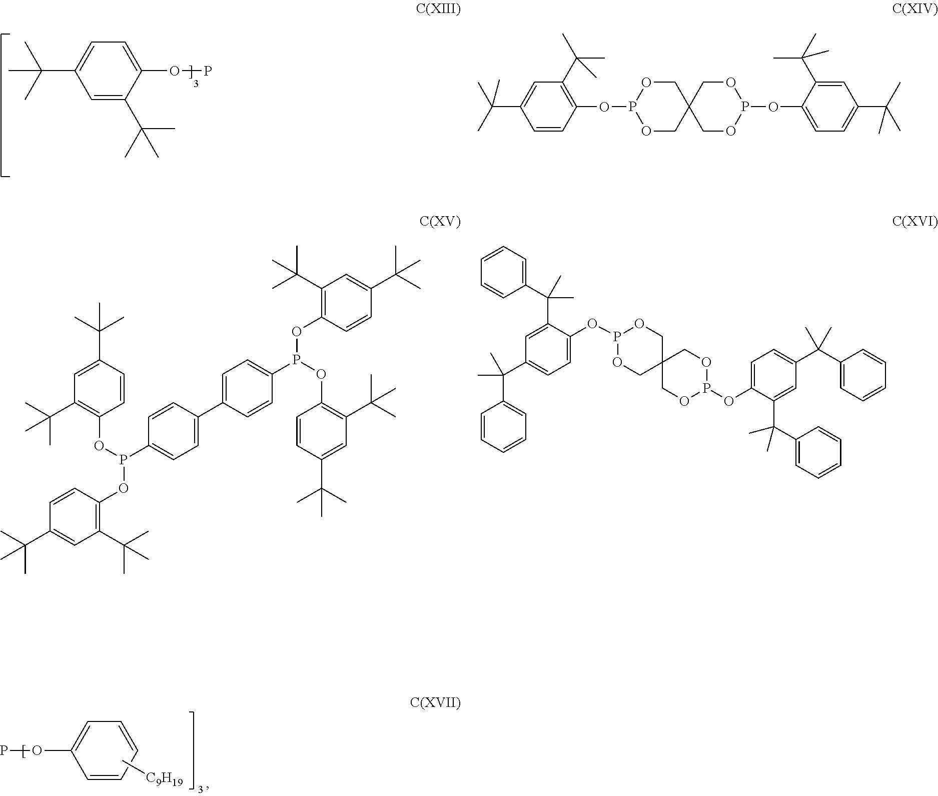

and mixtures thereof.

More preferably the at least one component (C) is selected from the group consisting of

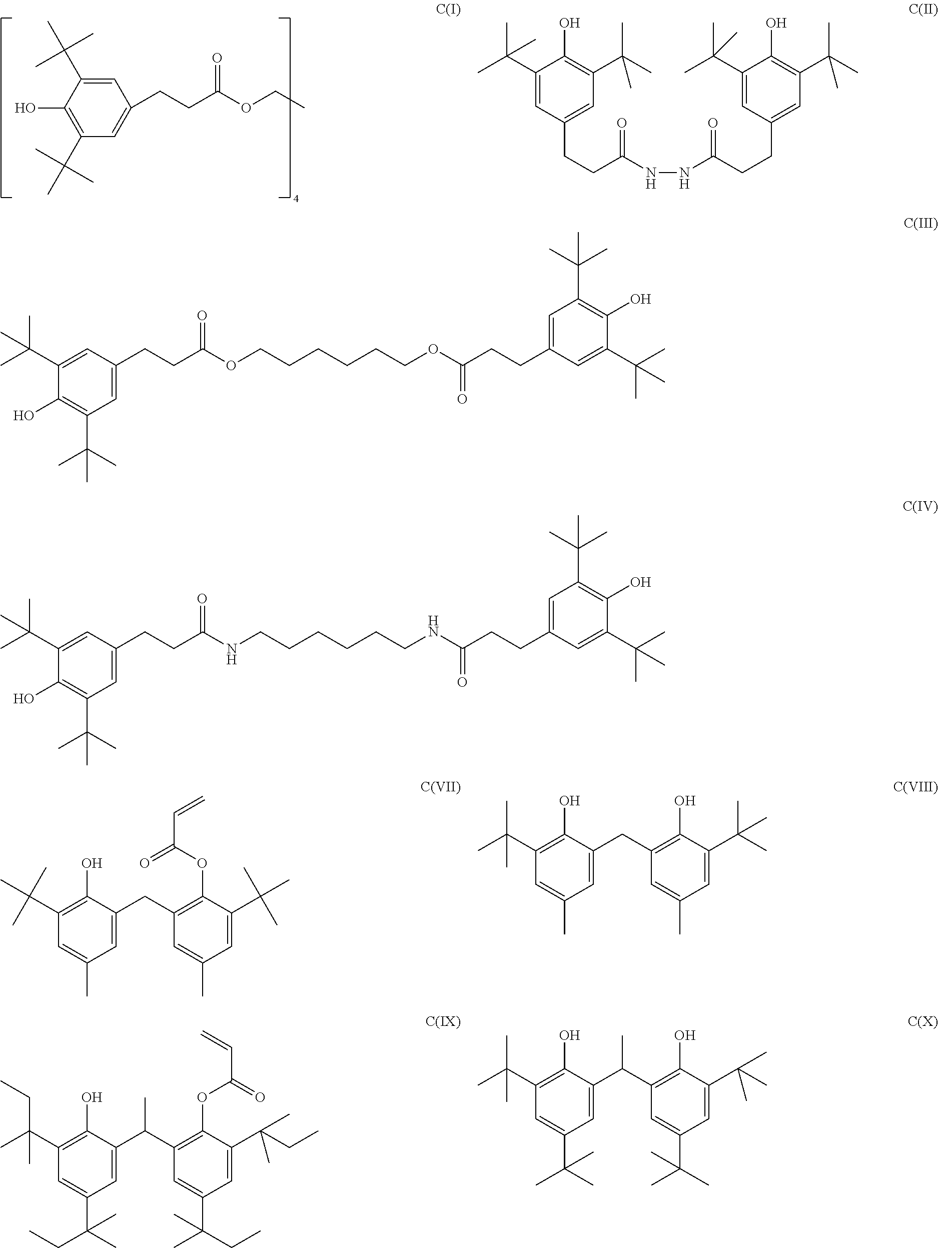

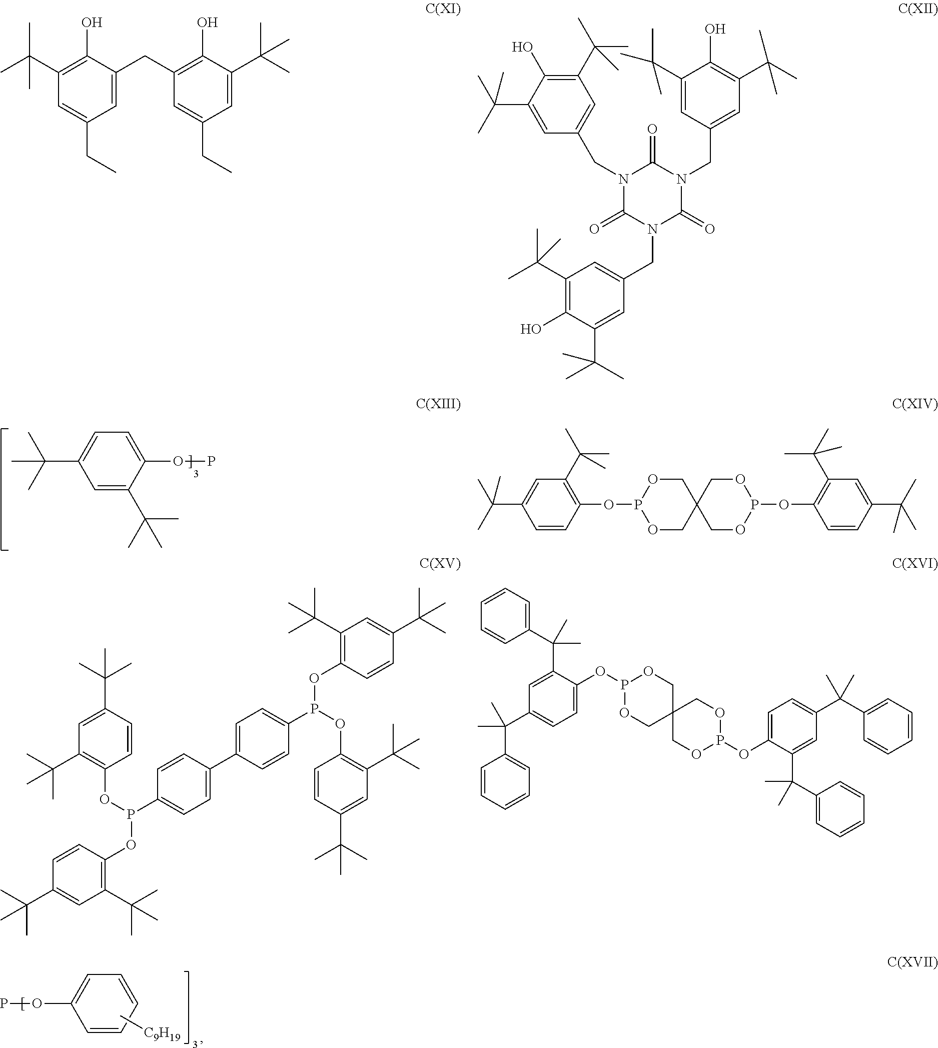

and mixtures thereof.

Even more preferably the at least one component (C) is selected from the group consisting of

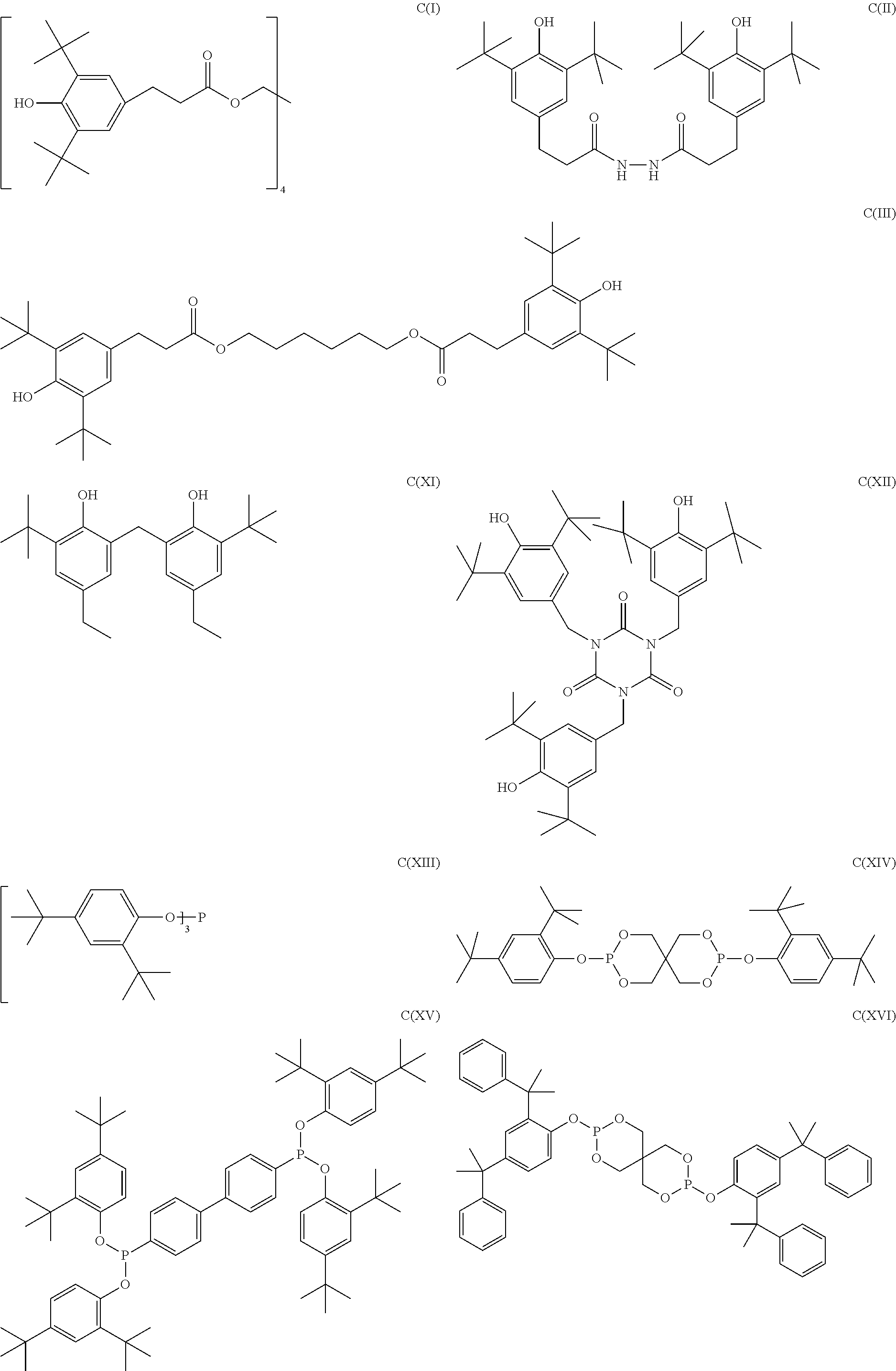

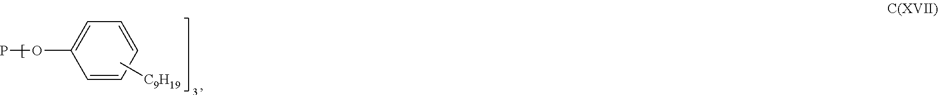

and mixtures thereof.

Most preferably the at least one component (C) is selected from the group consisting of

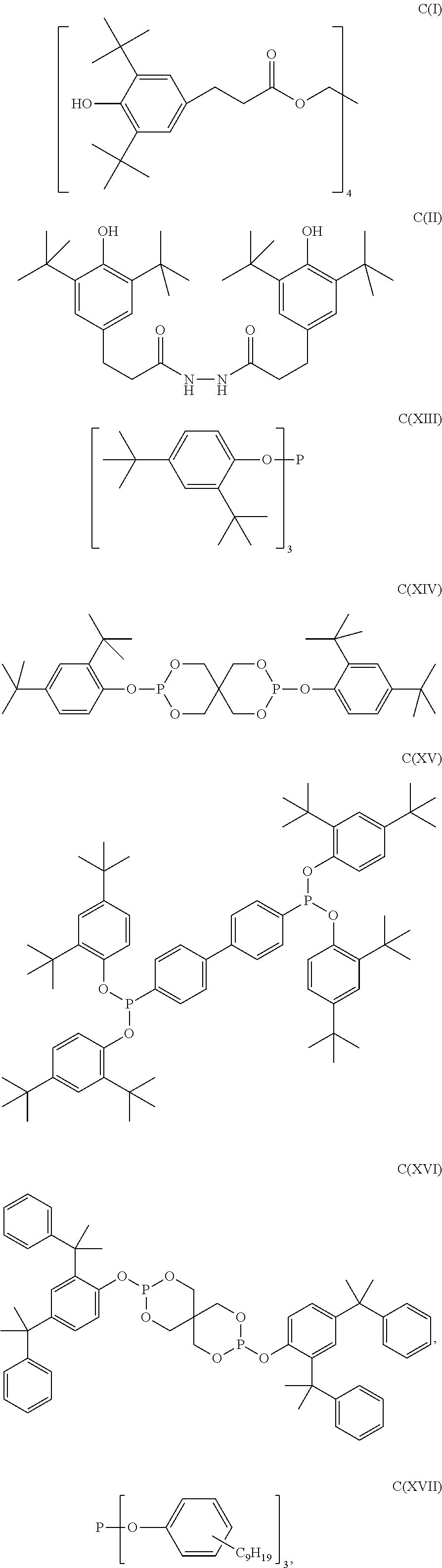

and mixtures thereof.

In particular, according to presently claimed invention the at least one component (C) is selected from the group consisting of

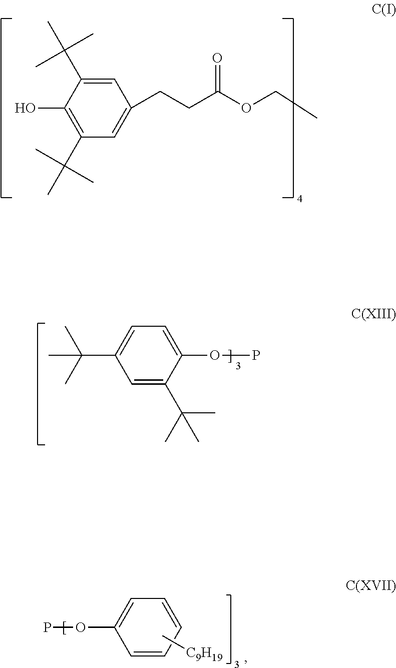

and mixtures thereof.

In another preferred embodiment, the at least one component (C) is selected from the group consisting of C(I), C(XIII) and mixtures thereof.

In another preferred embodiment, the composition (S) according to presently claimed invention comprises at least two components (C) selected from the group consisting of C(I) to C(XVII), and mixtures thereof.

In another preferred embodiment, the weight ratio of the total amount of component (C) to the microfibrillar cellulose (A) is in the range of 1:10 to 10:1, more preferably the weight ratio is in the range of 1:7 to 7:1, even more preferably the weight ratio is in the range of 1:5 to 5:1, most preferably the weight ratio is in the range of 1:3 to 3:1, and in particular the weight ratio is 1.0:2.0.

In another preferred embodiment, the weight ratio of the total amount of stabilizer (B) to the total amount of component (C) is in the range of 1:10 to 10:1, more preferably the weight ratio is in the range of 1:7 to 7:1, even more preferably the weight ratio is in the range of 1:5 to 5:1, most preferably the weight ratio is in the range of 1:3 to 3:1, and in particular the weight ratio is 1.0:2.0.

In another preferred embodiment, the microfibrillar cellulose (A) is present in a total amount in the range of 10 to 40 wt. % based on overall weight of the composition, more preferably in a total amount in the range of 15 to 30 wt. % based on overall weight of the composition, even more preferably in a total amount in the range of 15 to 30 wt. % based on overall weight of the composition, and most preferably t in a total amount in the range of 20 to 30 wt. % based on overall weight of the composition.

In another preferred embodiment, the stabilizer (B) is present in a total amount in the range of 10 to 40 wt. % based on overall weight of the composition, more preferably in a total amount in the range of 15 to 30 wt. % based on overall weight of the composition, even more preferably in a total amount in the range of 15 to 30 wt. % based on overall weight of the composition, and most preferably in a total amount in the range of 20 to 30 wt. % based on overall weight of the composition.

In another preferred embodiment, the component (C) is present in a total amount in the range of 20 to 80 wt. % based on overall weight of the composition, more preferably t in a total amount in the range of 30 to 70 wt. % based on overall weight of the composition, even more preferably t in a total amount in the range of 35 to 65 wt. % based on overall weight of the composition, most preferably in a total amount in the range of 40 to 60 wt. % based on overall weight of the composition, and in particular in a total amount in the range of 45 to 55 wt. % based on overall weight of the composition.

In another preferred embodiment, the composition (S) has a primary anti-oxidant functionality in the range of 1-10 mol %, more preferably the composition has a primary anti-oxidant functionality in the range of 1-8 mol %, even more preferably the composition has a primary anti-oxidant functionality in the range of 1-6 mol %, most preferably the composition has a primary anti-oxidant functionality in the range of 2-5 mol %, and in particular the composition has a primary anti-oxidant functionality in the range of 3-4 mol %.

In another preferred embodiment, the composition (S) has a secondary anti-oxidant functionality in the range of 1-10 mol %, more preferably the composition has a secondary anti-oxidant functionality in the range of 1-8 mol %, even more preferably the composition has a secondary anti-oxidant functionality in the range of 2-6 mol %, most preferably the composition has a secondary anti-oxidant functionality in the range of 2-5 mol %, and in particular the composition has a secondary anti-oxidant functionality in the range of 2-3 mol %.

In another preferred embodiment, the composition (S) has 1-10 mol % of primary anti-oxidant functionality to 1-10 mol % secondary anti-oxidant functionality, more preferably the composition has 1-8 mol % of primary anti-oxidant functionality to 1-8 mol % secondary anti-oxidant functionality, even more preferably the composition has 1-6 mol % of primary anti-oxidant functionality to 2-6 mol % secondary anti-oxidant functionality, most preferably the composition has 1-4 mol % of primary anti-oxidant functionality to 2-4 mol % secondary anti-oxidant functionality, and in particular the composition has 3-4 mol % of primary anti-oxidant functionality to 2-3 mol % secondary anti-oxidant functionality.

Within the context of the presently claimed invention primary antioxidant functionality primarily means phenolic OH functionality.

Within the context of the presently claimed invention secondary antioxidant primarily means phosphite and/or thioether functionalities.

In another preferred embodiment, the composition (S) according to presently claimed invention further comprises at least one component (D) selected from the group consisting of

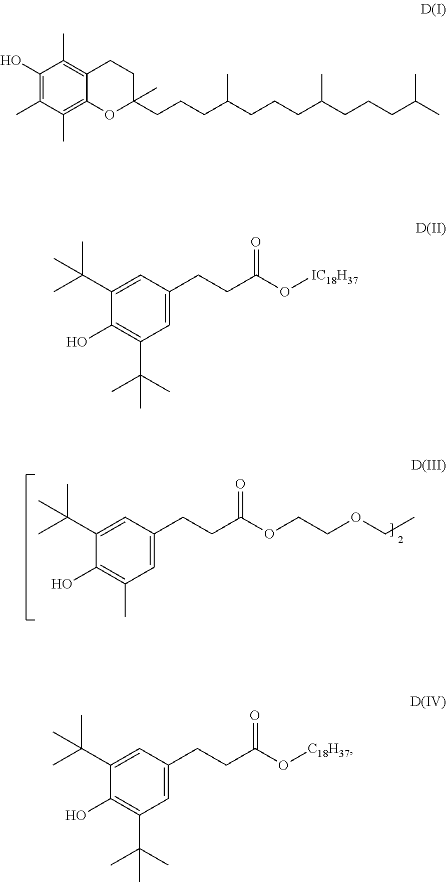

and mixtures thereof.

In another preferred embodiment, the presently claimed invention is directed to a composition (S) comprising
a. microfibrillar cellulose (A);
b. at least one stabilizer (B) selected form the group consisting of

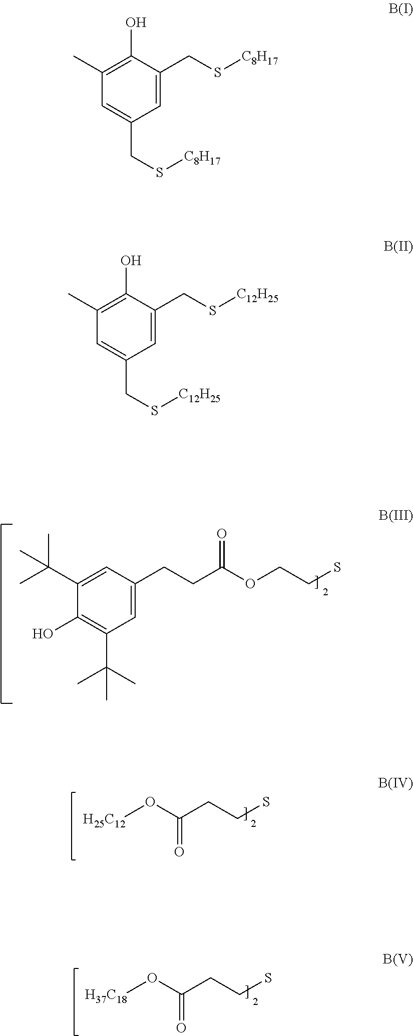

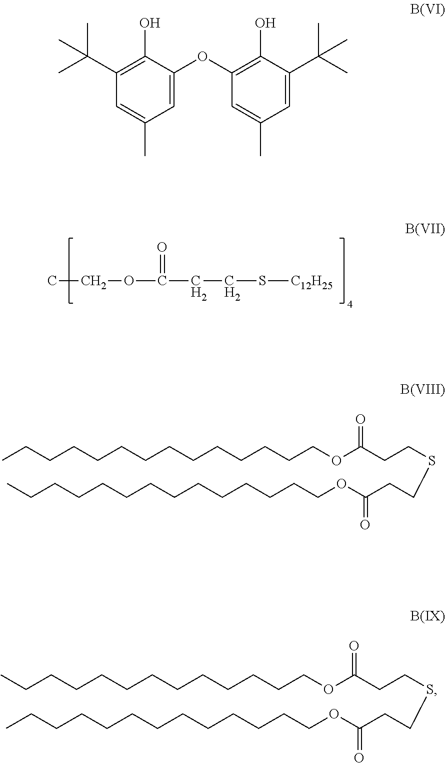

and mixtures thereof,
c. at least one component (C) selected from the group consisting of

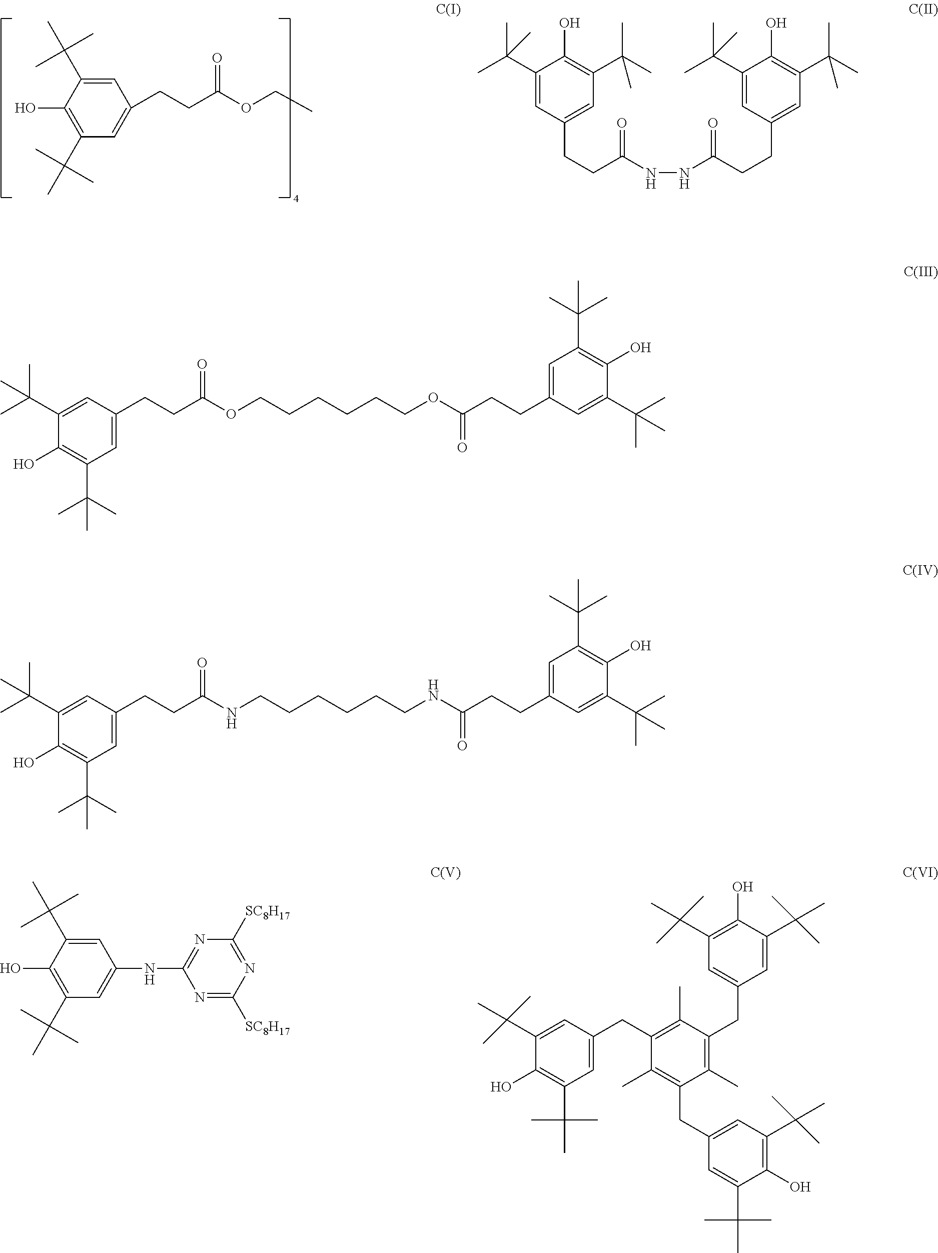

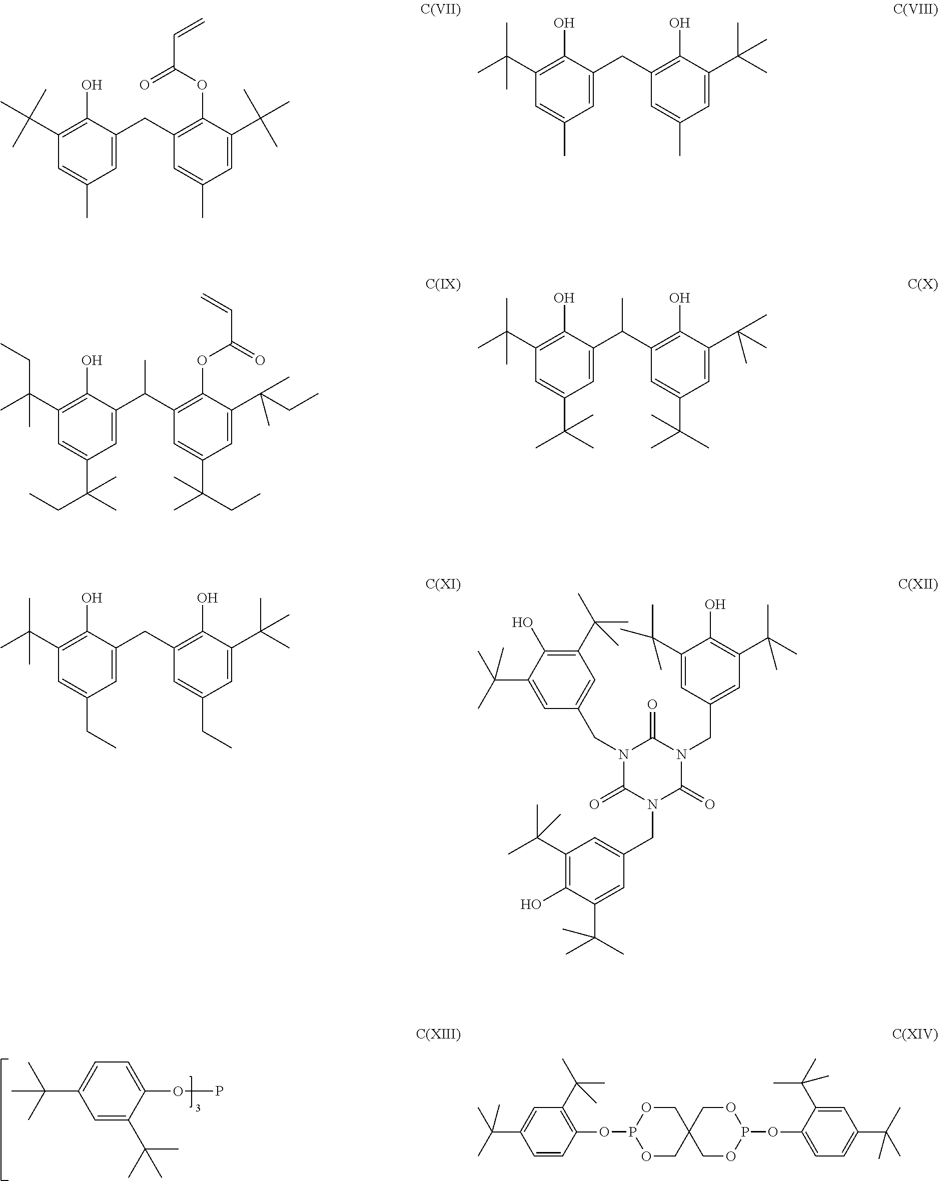

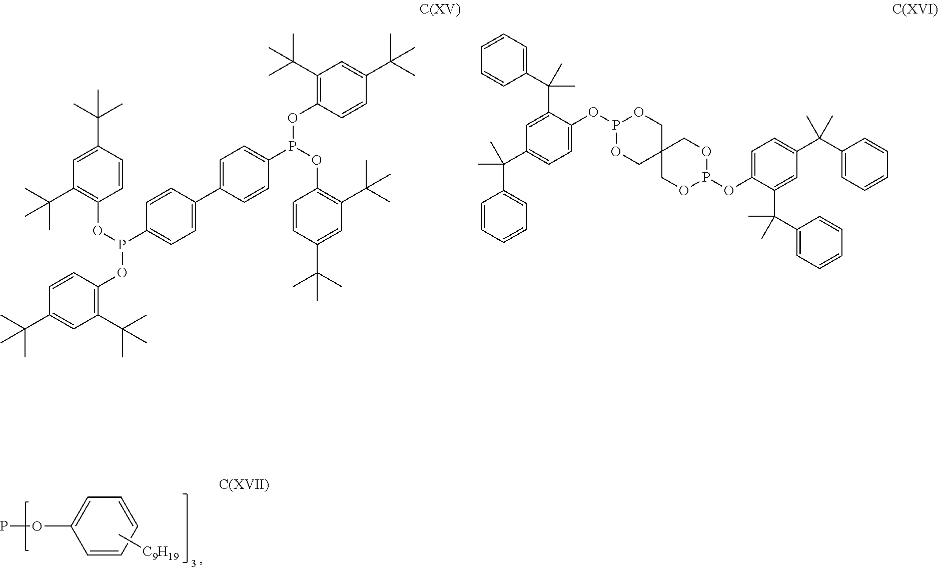

and mixtures thereof, and
d. at least one component (D) selected from the group consisting of

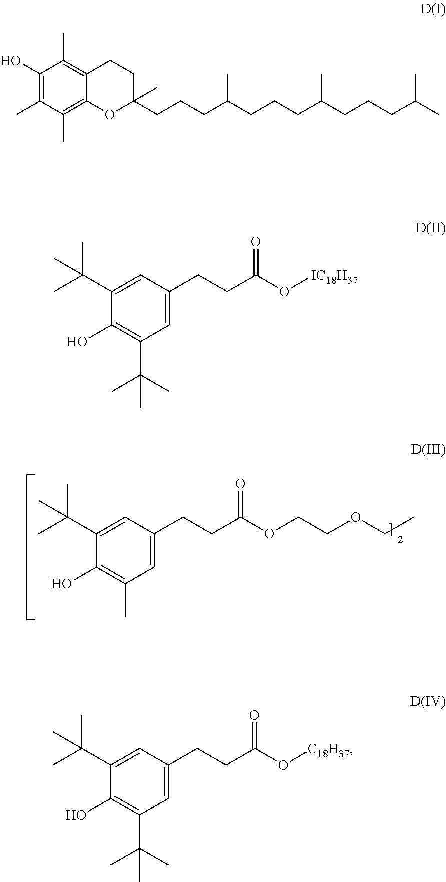

and mixtures thereof,
wherein the at least one stabilizer (B) is at least partly absorbed on the microfibrillar cellulose (A) and the absorbed stabilizer (B) is at least partly coated with component (C).

More preferably, the presently claimed invention is directed to a composition (S) comprising
a. microfibrillar cellulose (A);
b. at least one stabilizer (B) selected form the group consisting of

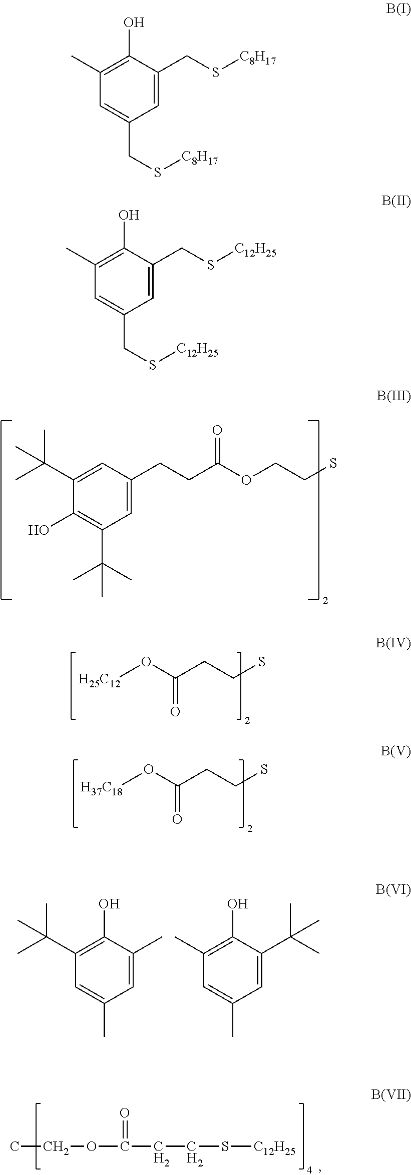

and mixtures thereof,
c. at least one component (C) selected from the group consisting of

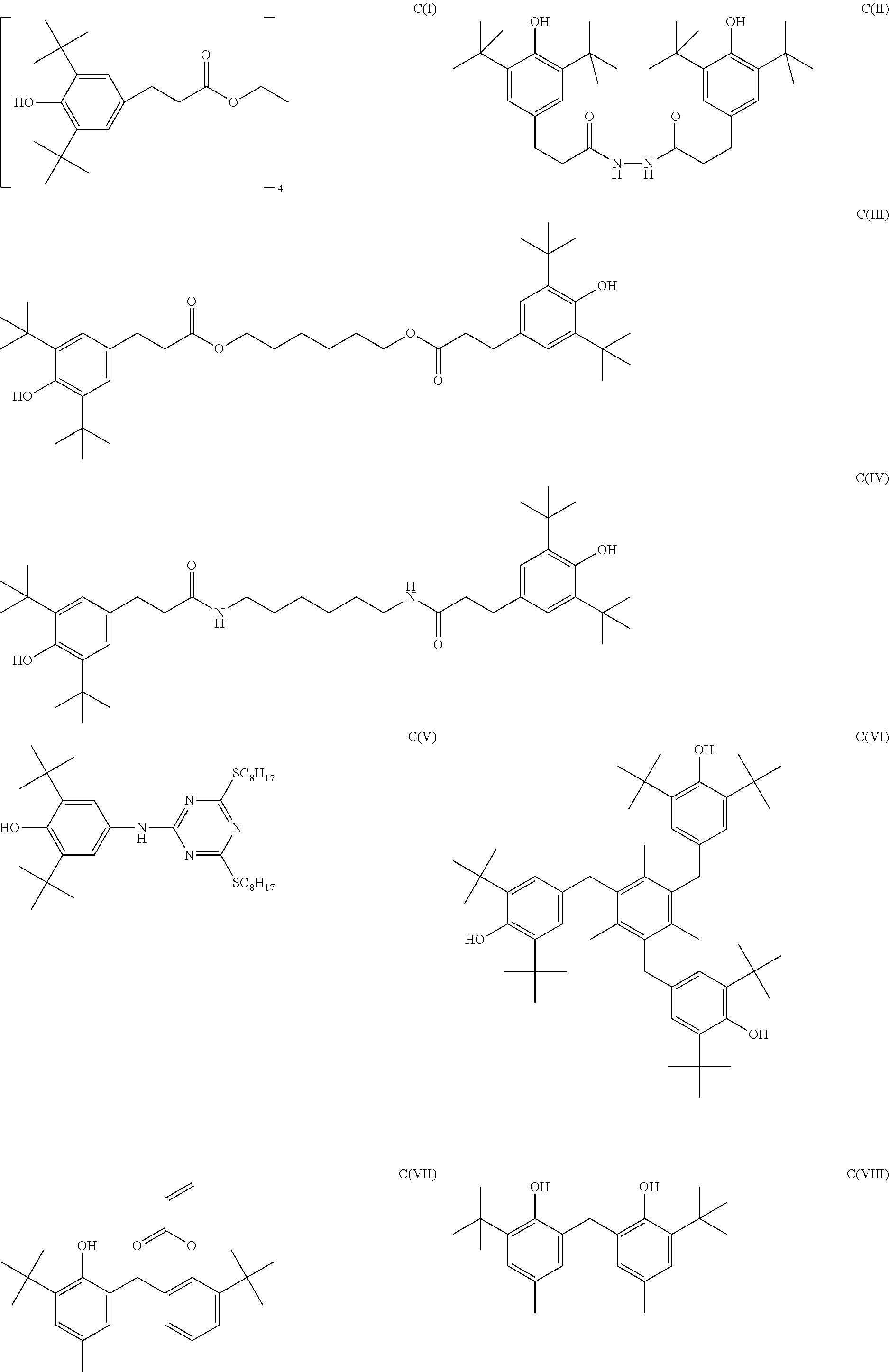

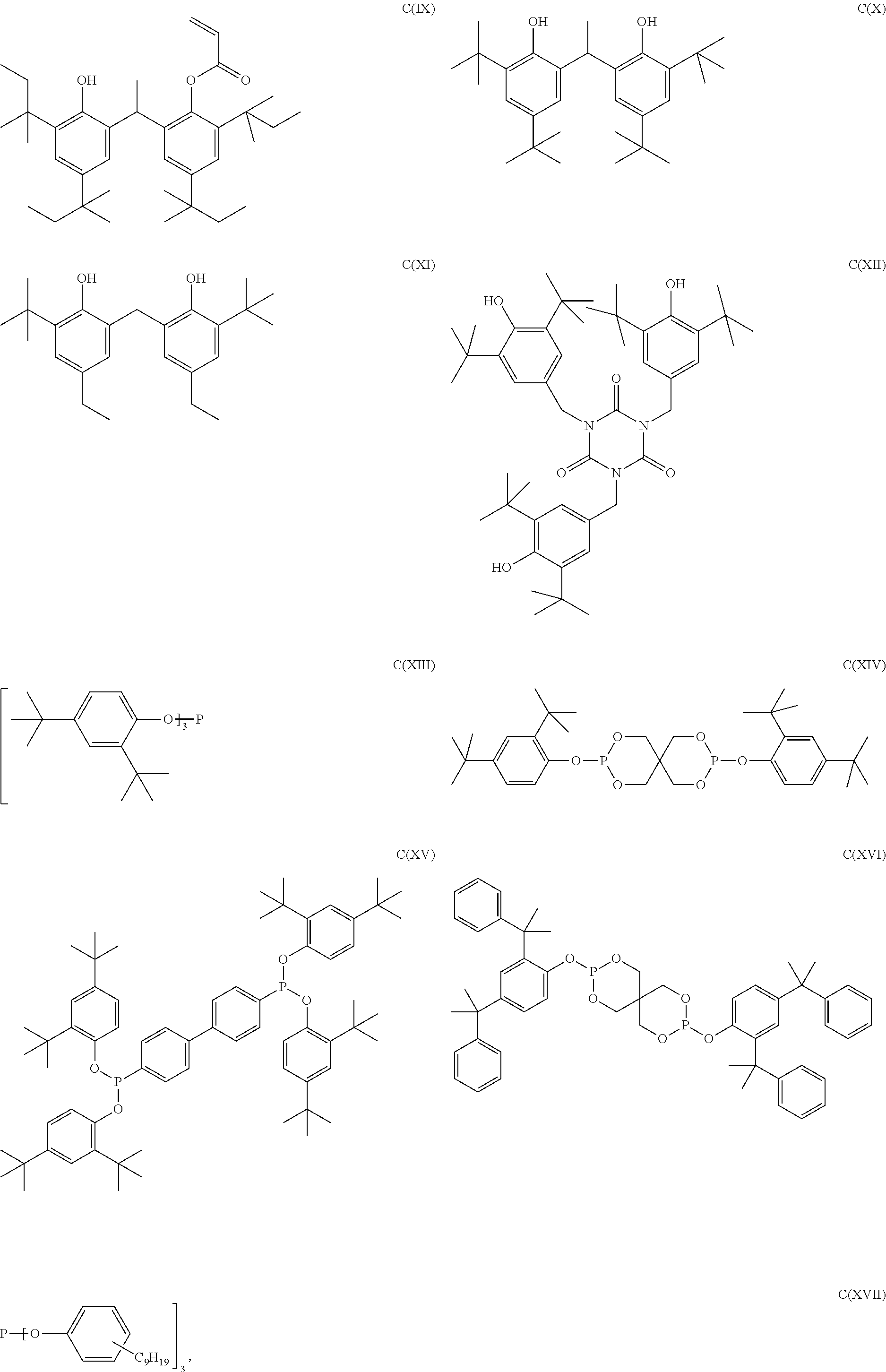

and mixtures thereof, and
d. at least one component (D) selected from the group consisting of

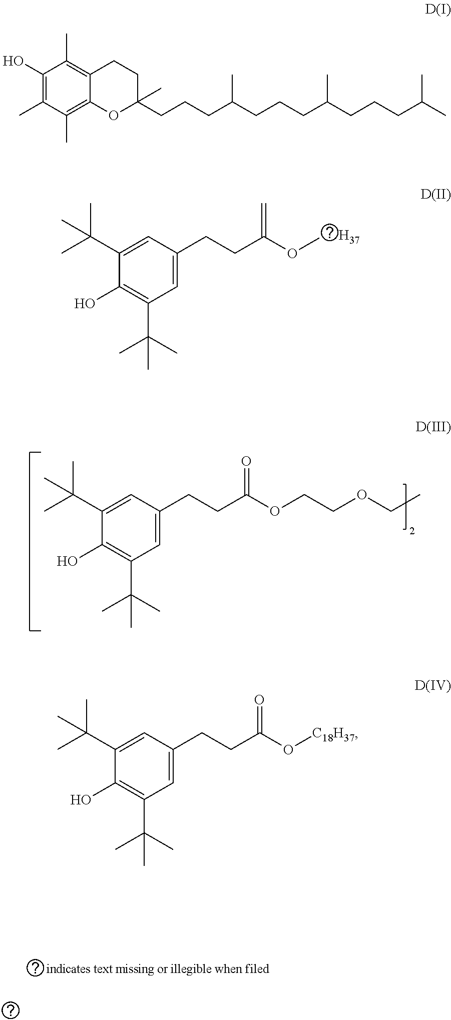

and mixtures thereof,
wherein the at least one stabilizer (B) is at least partly absorbed on the microfibrillar cellulose (A) and wherein the absorbed stabilizer (B) is at least partly coated with component (C).

Even more preferably, the presently claimed invention is directed to a composition (S) comprising
a. microfibrillar cellulose (A);
b. at least one stabilizer (B) selected form the group consisting of

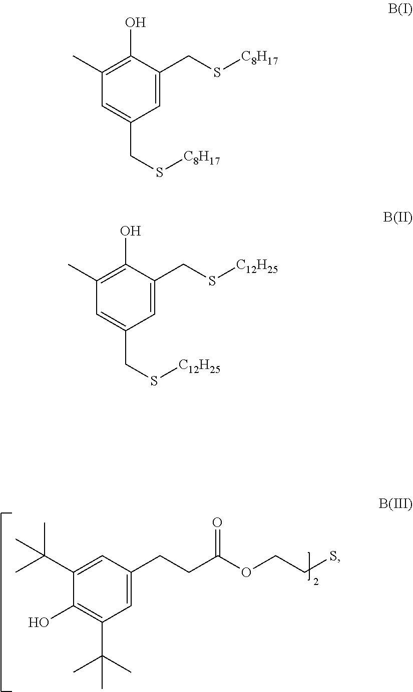

and mixtures thereof,
c. at least one component (C) selected from the group consisting of

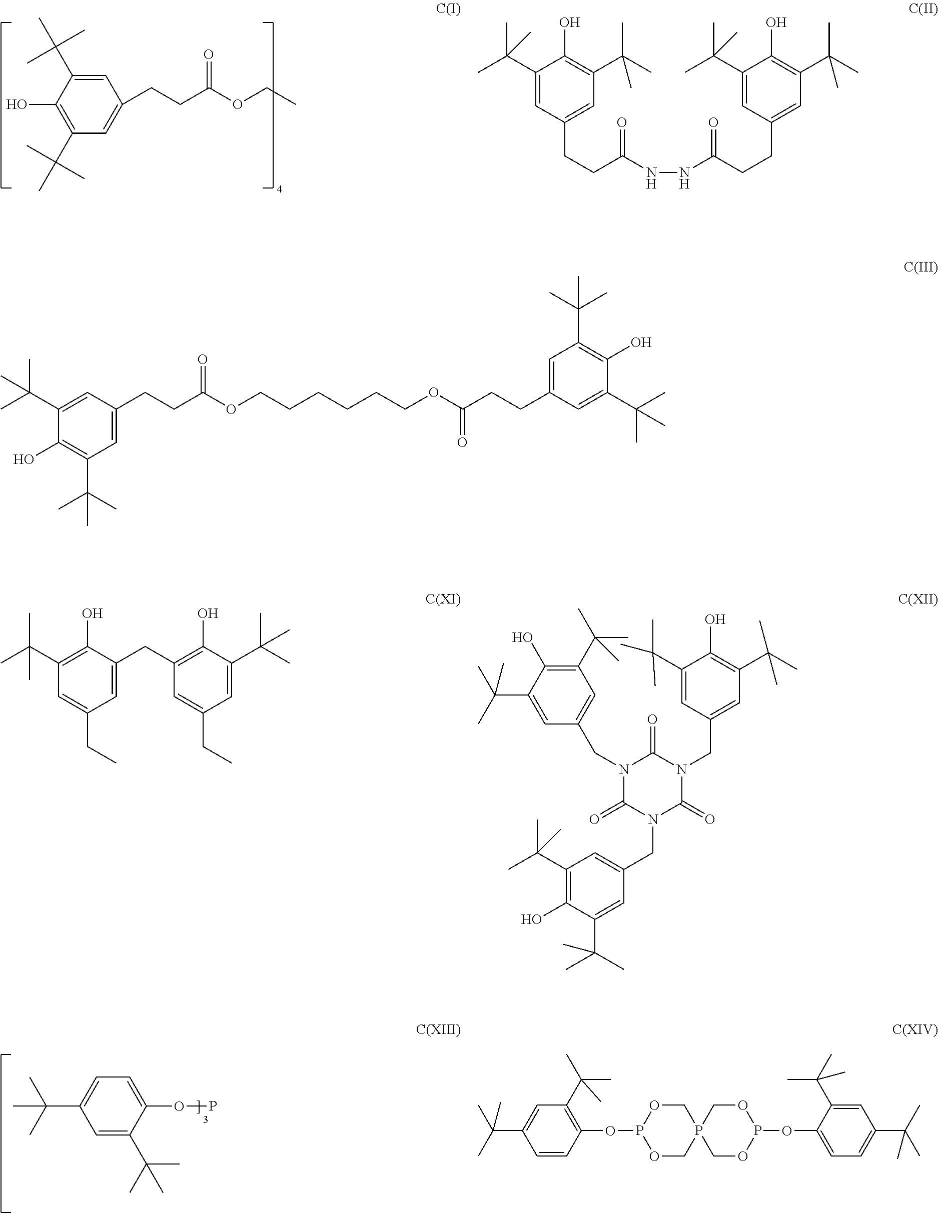

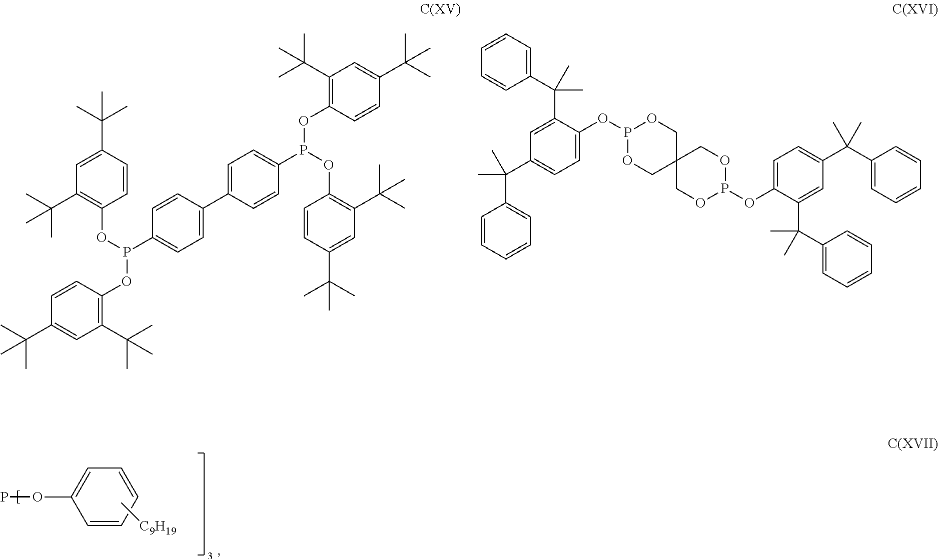

and mixtures thereof, and
d. at least one component (D) selected from the group consisting of

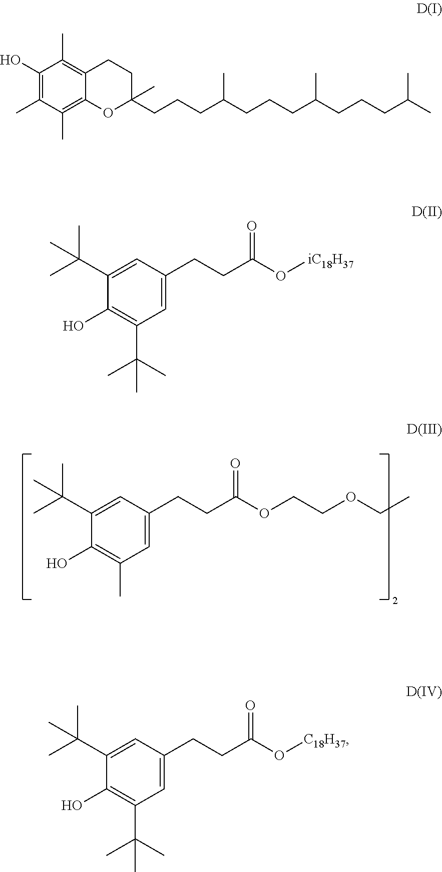

and mixtures thereof,
   wherein the at least one stabilizer (B) is at least partly absorbed on the microfibrillar cellulose (A) and wherein the absorbed stabilizer (B) is at least partly coated with component (C).

Most preferably, the presently claimed invention is directed to a composition (S) comprising
a. microfibrillar celluose (A);
b. at least one stabilizer (B) selected form the group consisting of

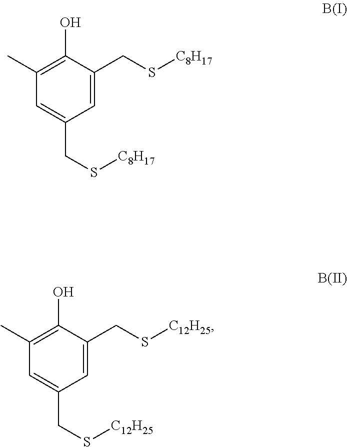

and mixture thereof,
c. at least one component (C) selected from the group consisting of

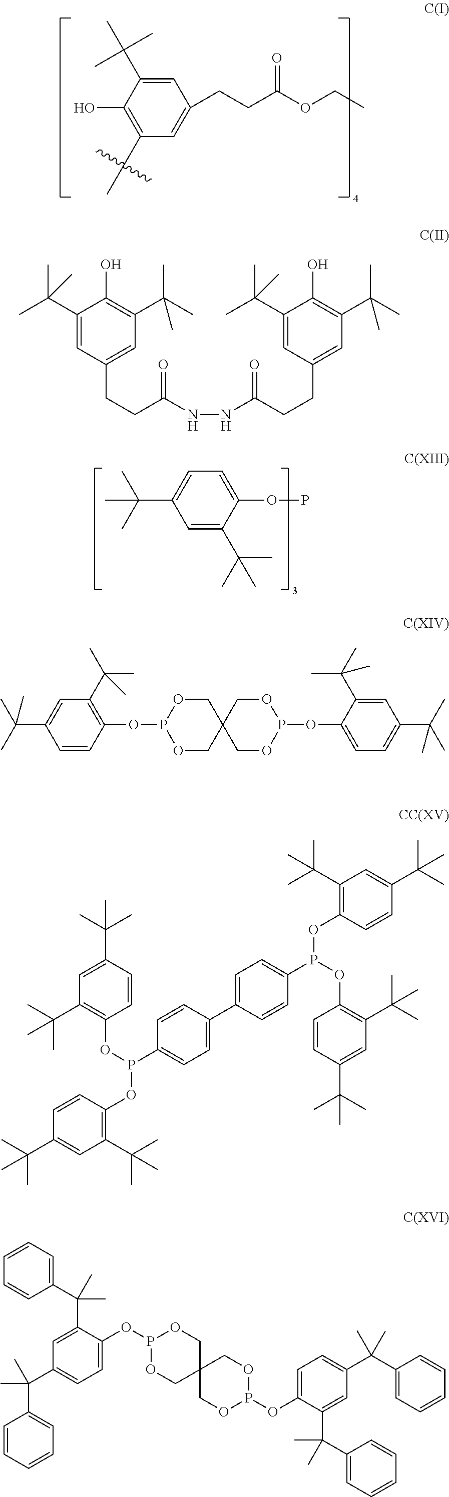

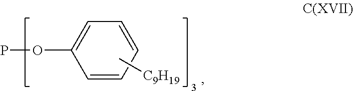

and mixtures thereof,
d. at least one component (D) selected from the group consisting of

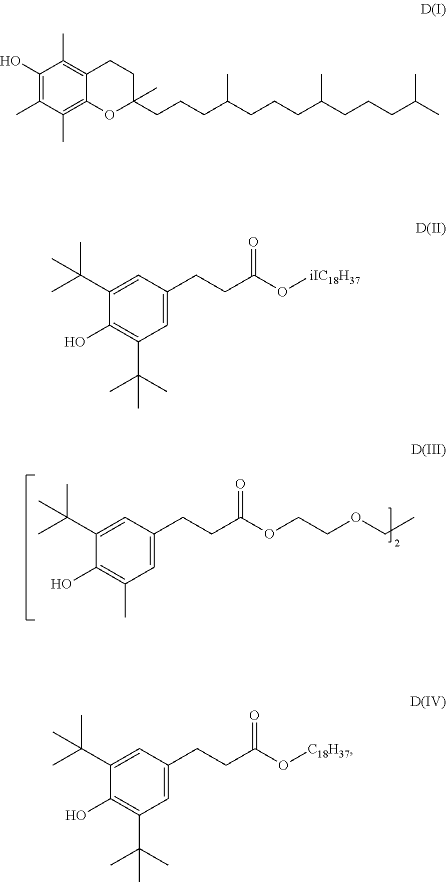

and mixtures thereof,
wherein the at least one stabilizer (B) is at least partly absorbed on the microfibrillar celluose (A) and wherein the absorbed stabilizer (B) is at least partly coated with component (C).

In particular the presently claimed invention is directed to a composition (S) comprising
a. microfibrillar celluose (A);
b. at least one stabilizer (B) selected from the group consisting of

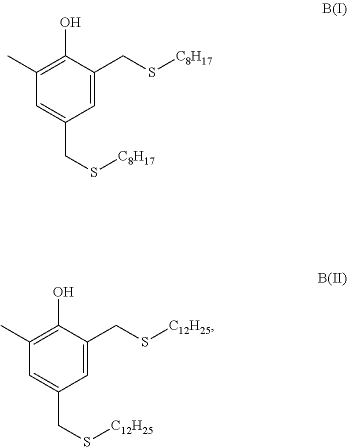

and mixture thereof,
c. at least one component (C) selected from the group consisting of

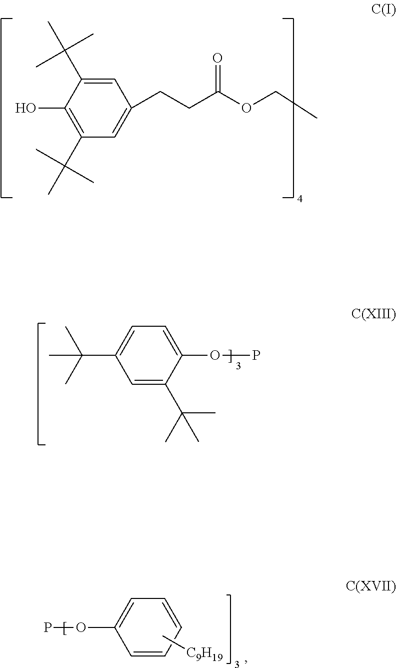

and mixtures thereof, and
d. at least one component (D) selected from the group consisting of

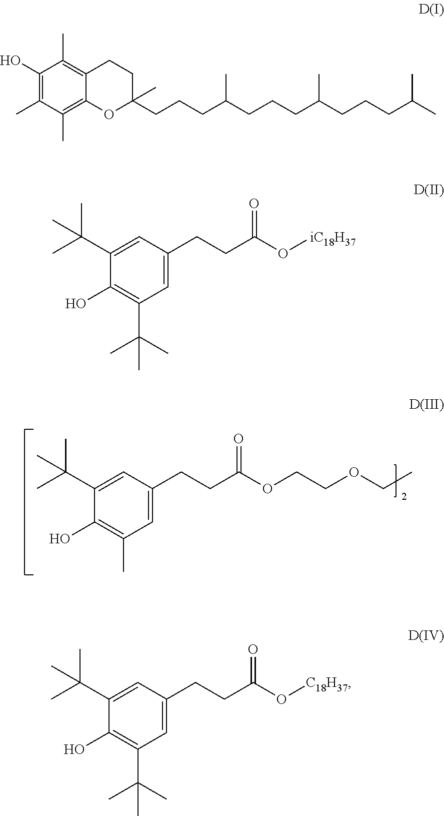

and mixtures thereof,
wherein the at least one stabilizer (B) is at least partly absorbed on the microfibrillar cellulose (A) and wherein the absorbed stabilizer (B) is at least partly coated with component (C).

In another preferred embodiment, component (D) is present in the composition (S) in a total amount in the range of 0 to 60 wt. % based on weight of the stabilizer (B), more preferably component (D) is present in the composition in a total amount in the range of 0 to 50 wt. % based on weight of the stabilizer (B), component (D) is present in the composition in a total amount in the range of 0 to 40 wt. % based on weight of the stabilizer (B), most preferably component (D) is present in the composition in a total amount in the range of 0 to 30 wt. % based on weight of the stabilizer (B), and in particular component (D) is present in the composition in a total amount in the range of 0 to 20 wt. % based on weight of the stabilizer (B).

In another preferred embodiment, component (D) is present in the composition (S) in a total amount in the range of 1 to 60 wt. % based on weight of the stabilizer (B), more preferably component (D) is present in the composition in a total amount in the range of 1 to 50 wt. % based on weight of the stabilizer (B), component (D) is present in the composition in a total amount in the range of 1 to 40 wt. % based on weight of the stabilizer (B), most preferably component (D) is present in the composition in a total amount in the range of 1 to 30 wt. % based on weight of the stabilizer (B), and in particular component (D) is present in the composition in a total amount in the range of 1 to 20 wt. % based on weight of the stabilizer (B).

In another preferred embodiment, the composition (S) according to presently claimed invention further comprises at least one component selected from the group consisting of (E), (F), and mixture thereof, wherein (E) is selected from the group consisting of

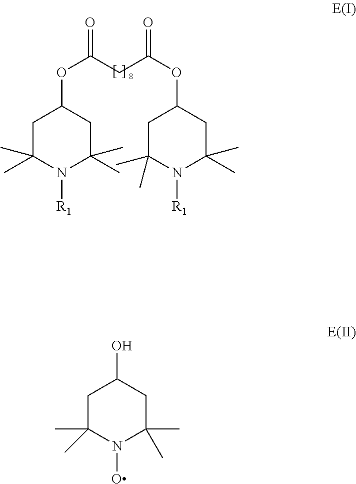

wherein R₁ is independently selected from the group consisting of H, CH₃ and OC₈H₁₇;

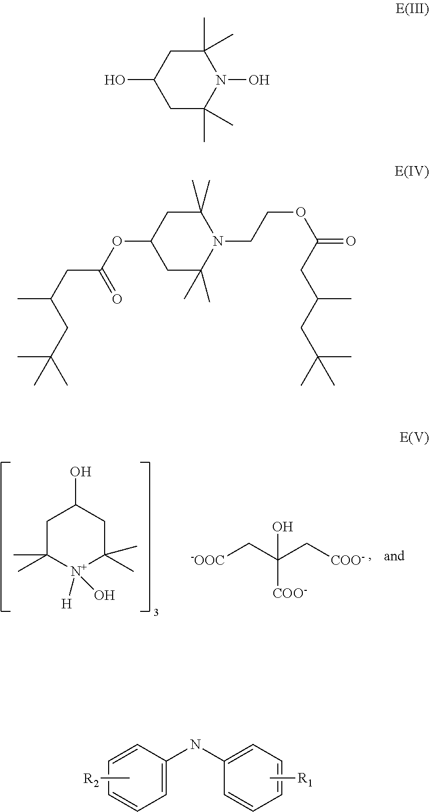

R1 and R2 independently selected form H, or C1-C20 alkyl,

E(VI),
and mixtures thereof, and (F) is a polyalkyleneimine polymer (F).

In another preferred embodiment, the presently claimed invention is directed to a composition (S) comprising
a. microfibrillar cellulose (A);
b. at least one stabilizer (B) selected form the group consisting of

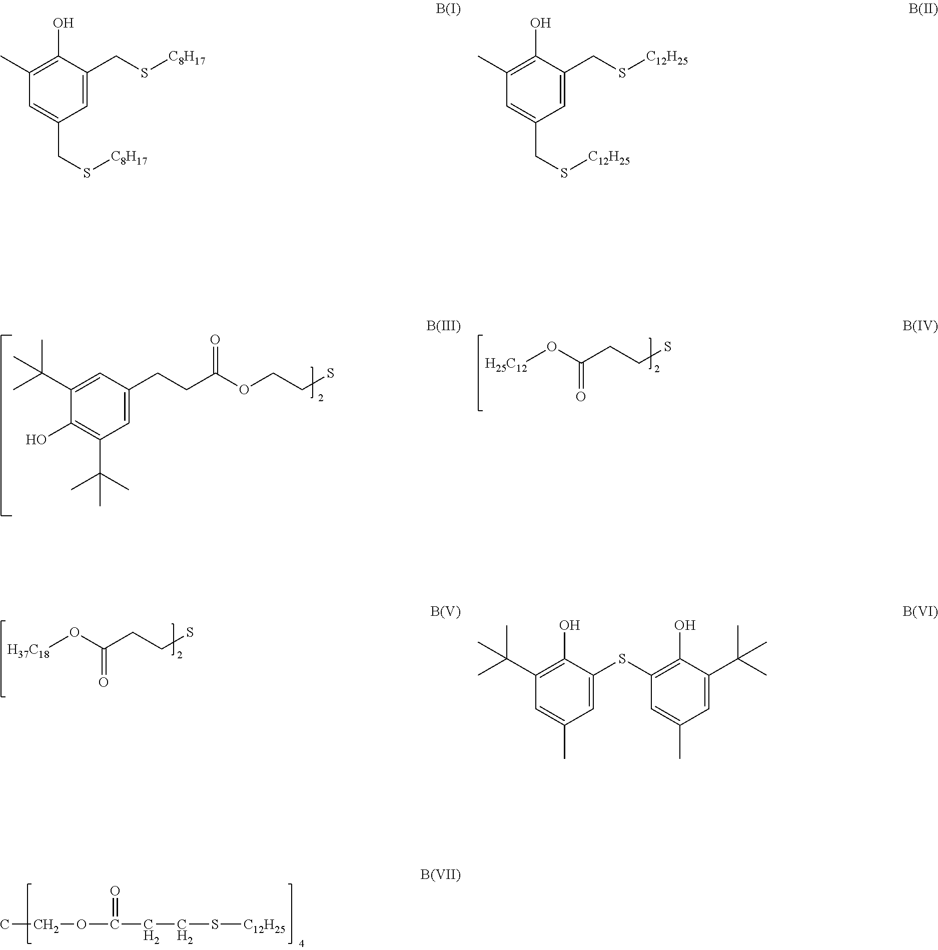

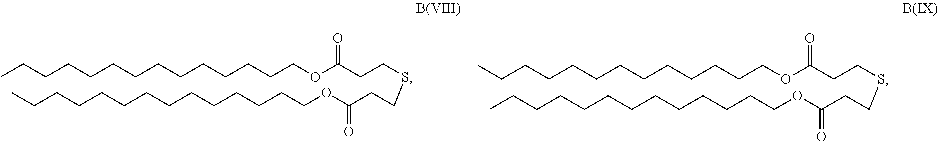 [SMILES: CCCCCCCCCCCCCCOC(=O)CCSCCC(=O)OCCCCCCCCCCCCCC ; CCCCCCCCCCCCCOC(=O)CCSCCC(=O)OCCCCCCCCCCCCC]

and mixtures thereof,
c. at least one component (C) selected from the group consisting of

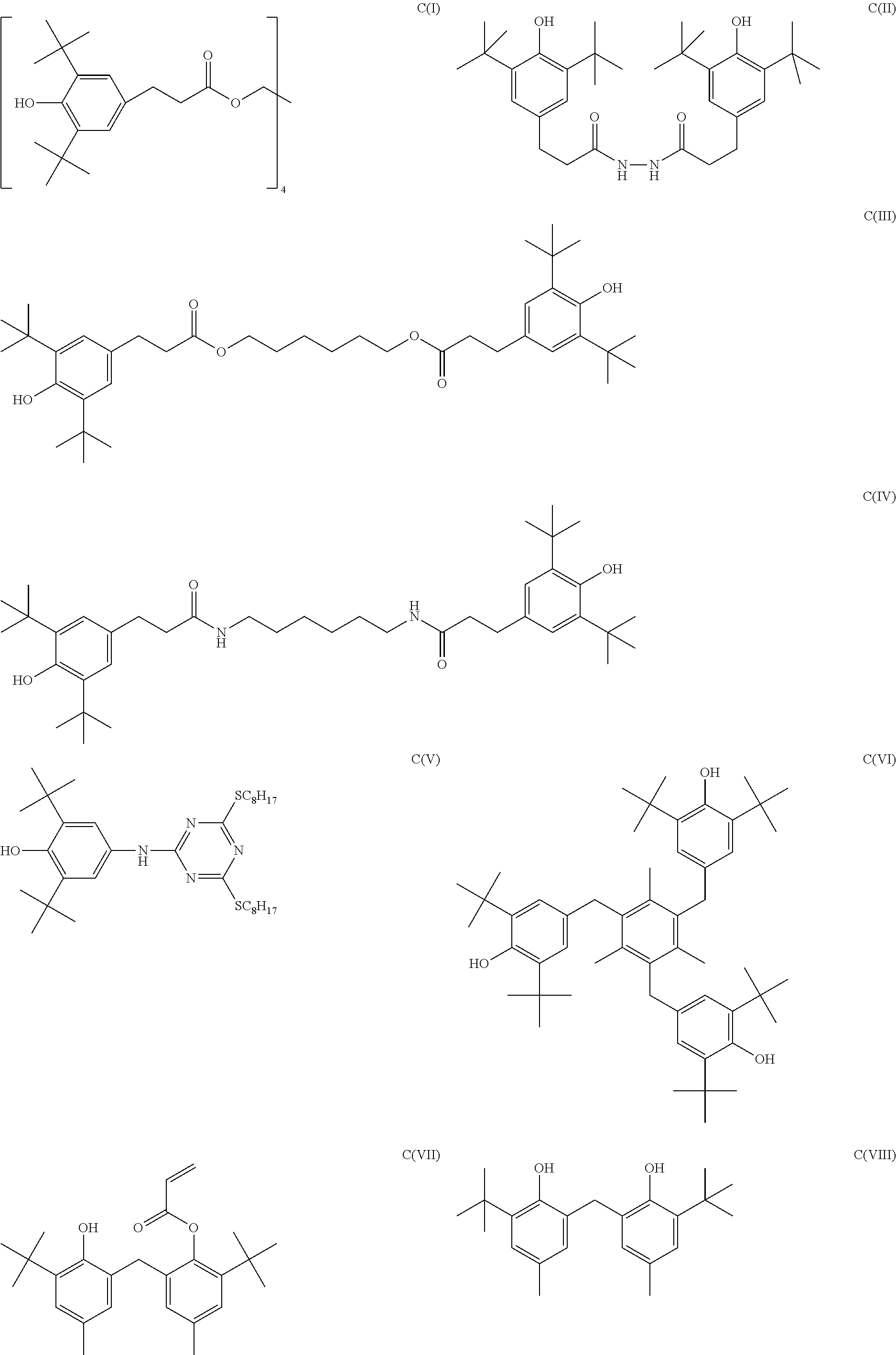

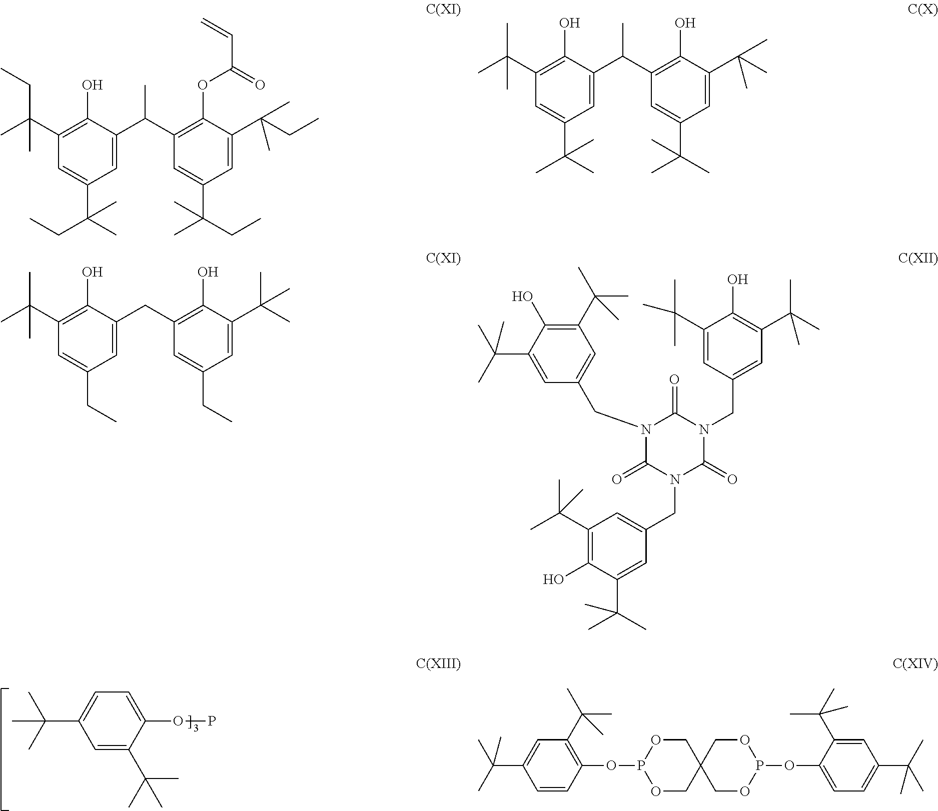

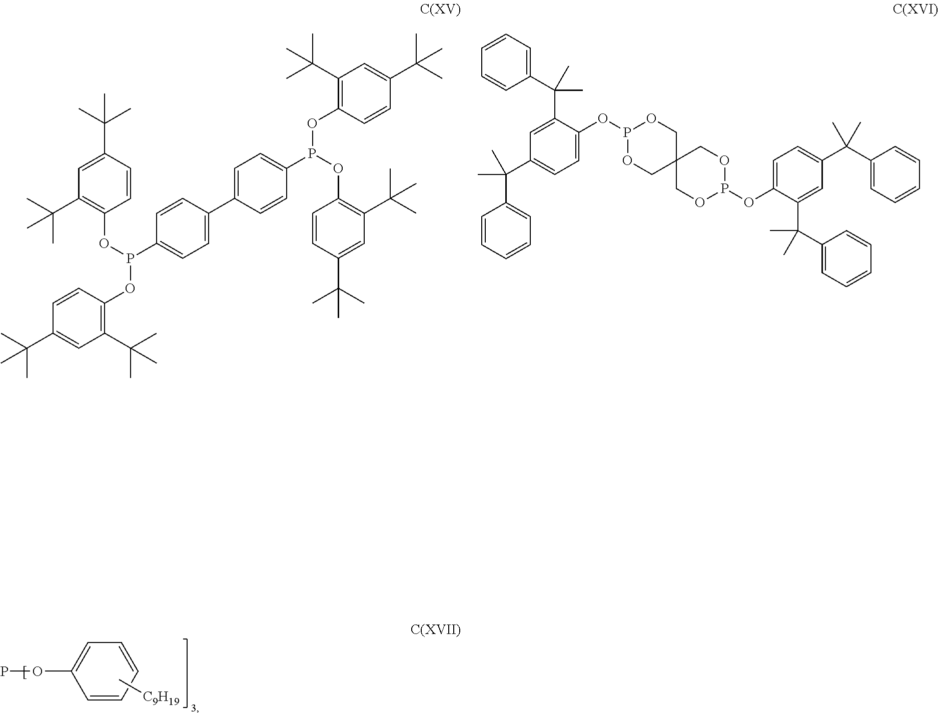

and mixtures thereof, and
   the composition further comprises at least one component selected from the group consisting of (D), (E), (F), and mixtures thereof,
wherein (D) is selected from the group consisting of

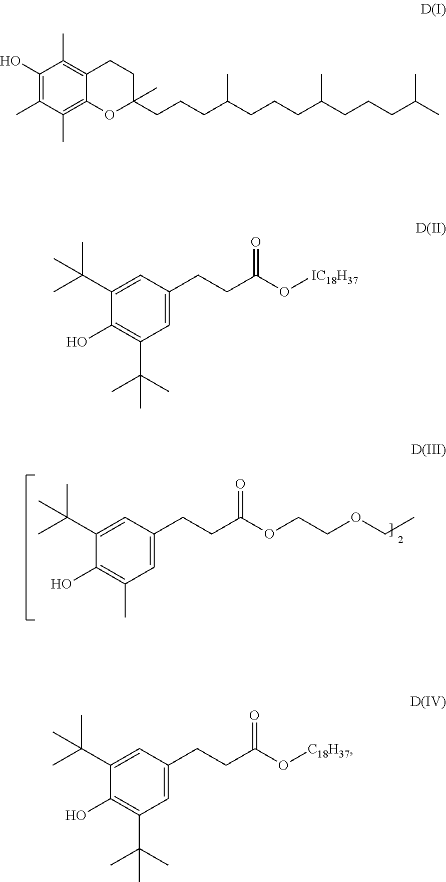

and mixtures thereof
   wherein (E) is selected from the group consisting of

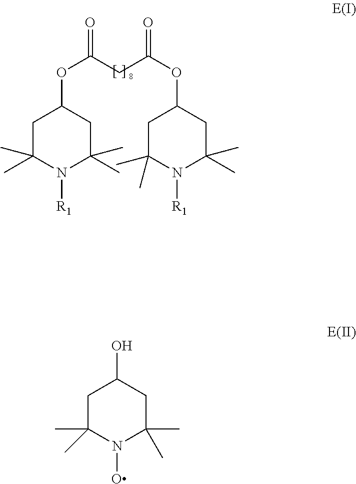

wherein R₁ is independently selected from the group consisting of H, CH₃ and OC₈H₁₇;

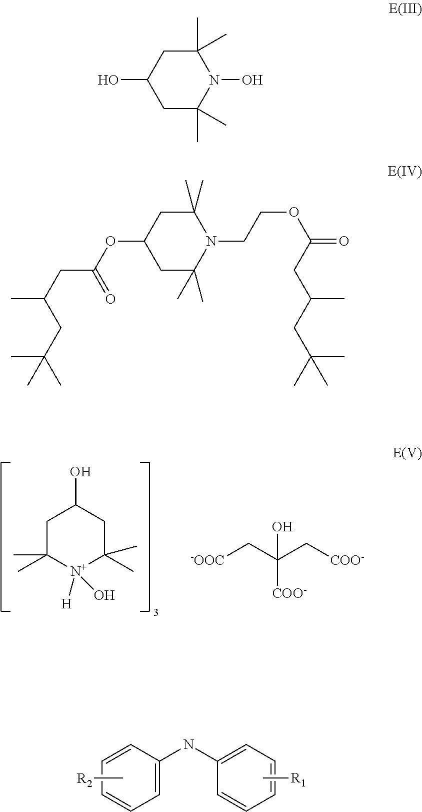

R1 and R2 independently selected form H, or C1-C20 alkyl,

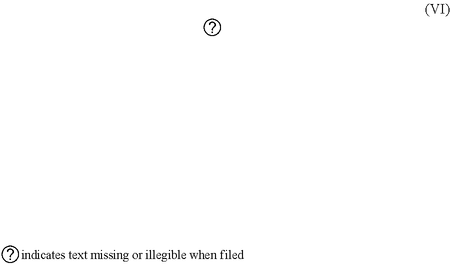

and mixtures thereof, and (F) is a polyalkyleneimine polymer (F).
   wherein the at least one stabilizer (B) is at least partly absorbed on the microfibrillar celluose (A) and the absorbed stabilizer (B) is at least partly coated with component (C).

More preferably, the presently claimed invention is directed to a composition (S) comprising
a. microfibrillar celluose (A);
b. at least one stabilizer (B) selected form the group consisting of

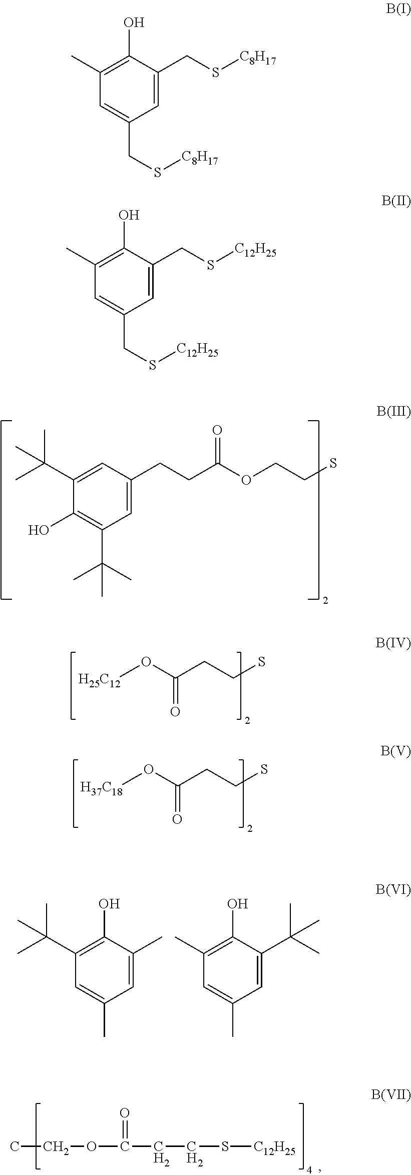

and mixtures thereof,
c. at least one component (C) selected from the group consisting of

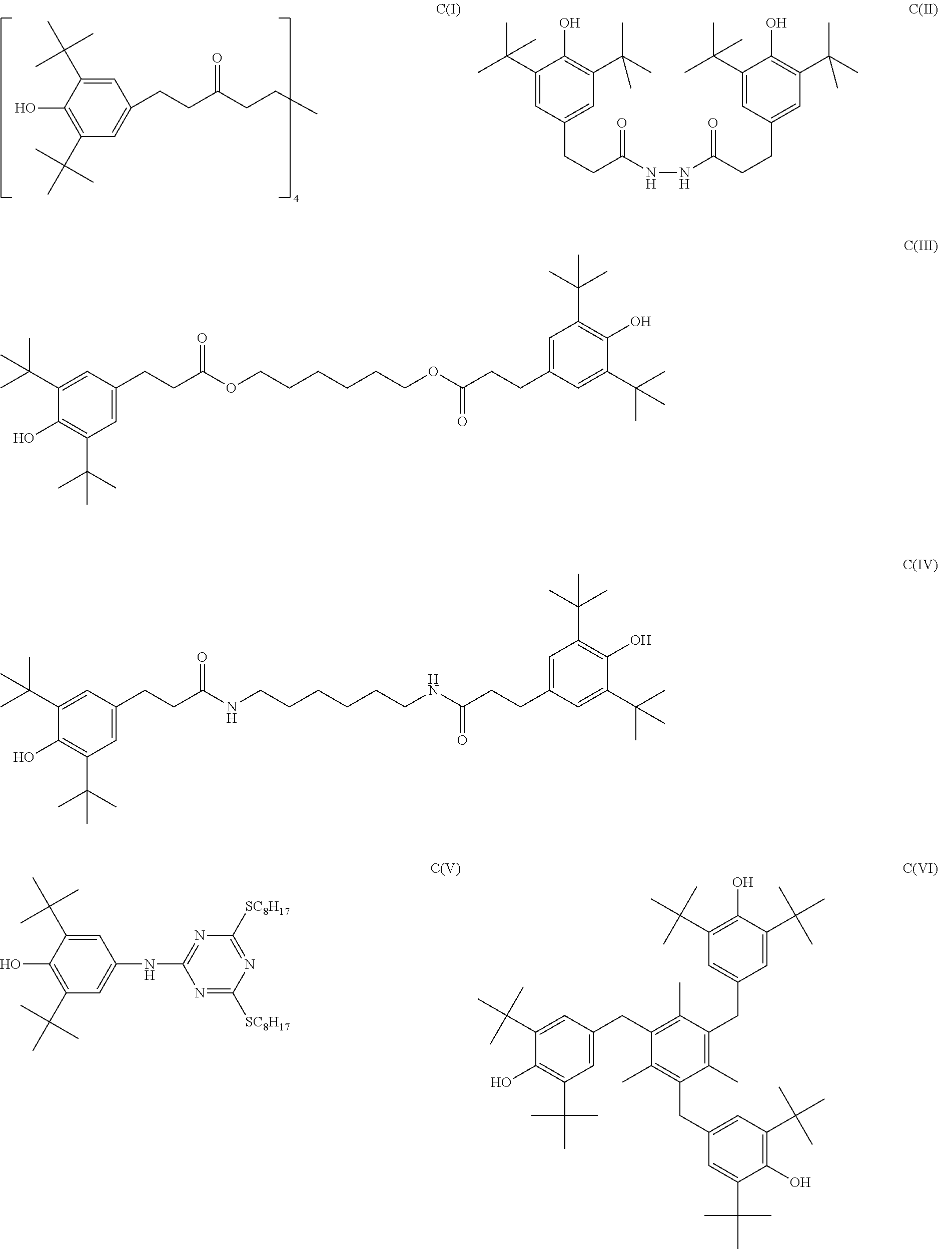

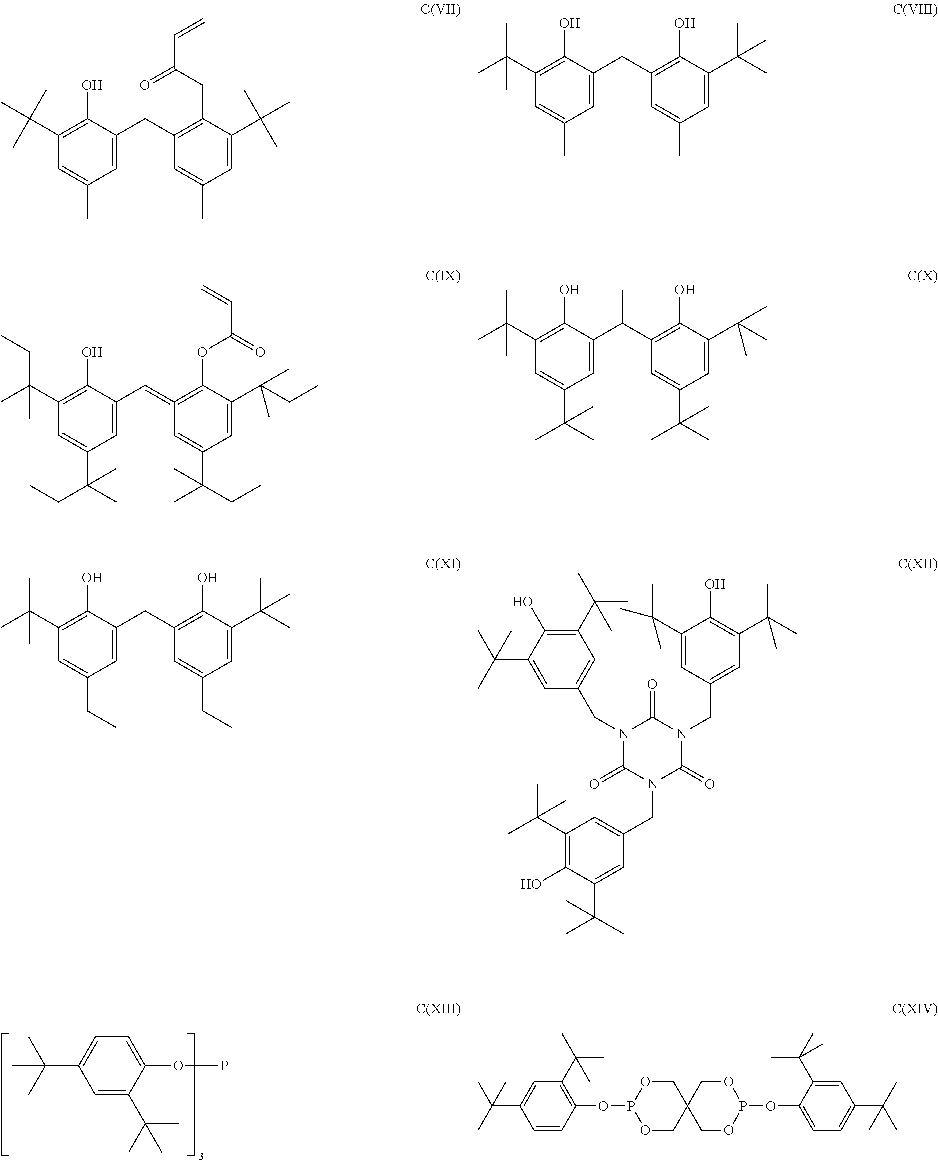

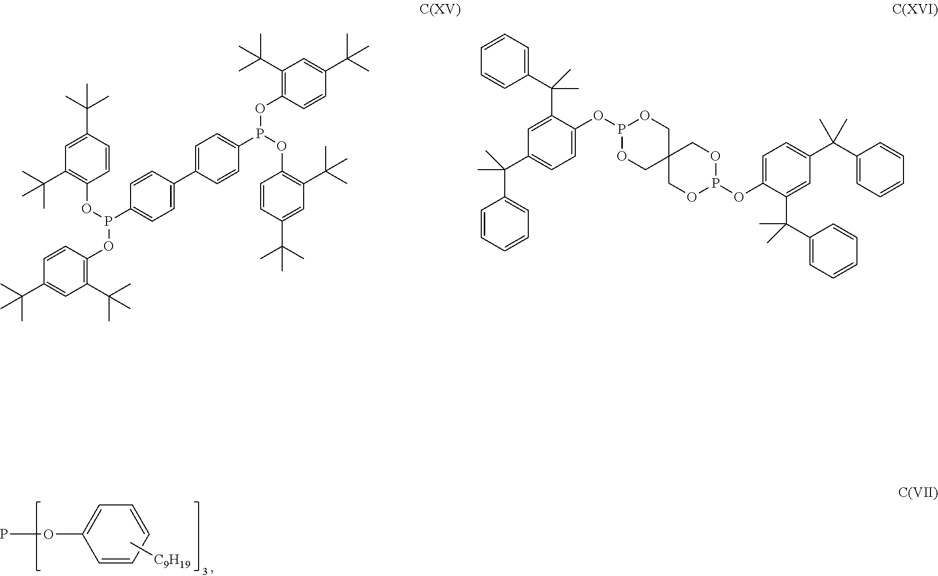

and mixtures thereof,
   the composition further comprises at least one component selected from the group consisting of (D), (E), (F), and mixtures thereof,
wherein (D) is selected from the group consisting of

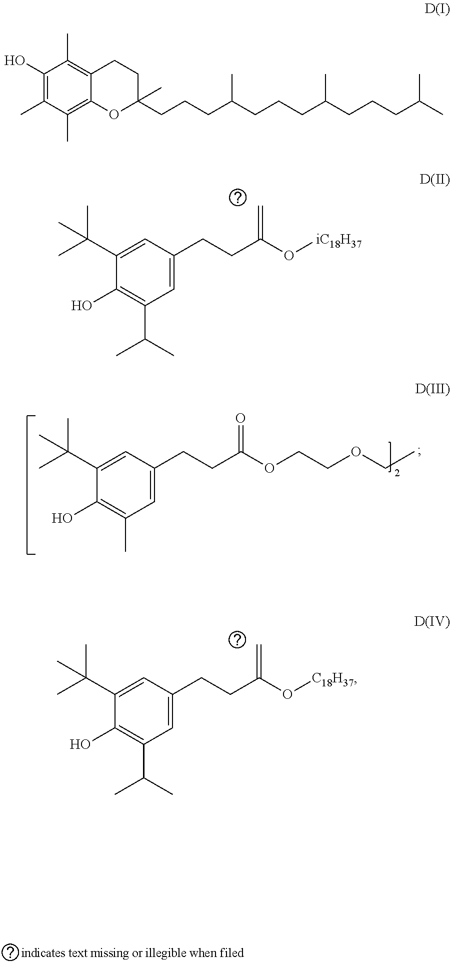

and mixtures thereof,
   wherein (E) is selected from the group consisting of

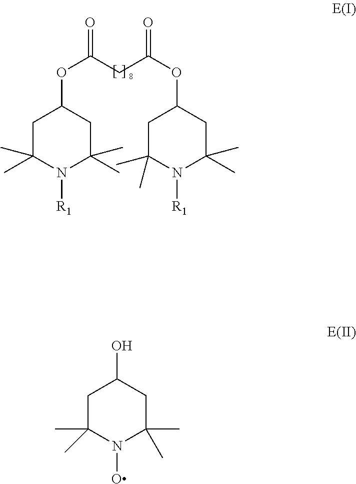

wherein R₁ is independently selected from the group consisting of H, CH₃ and OC₈H₁₇;

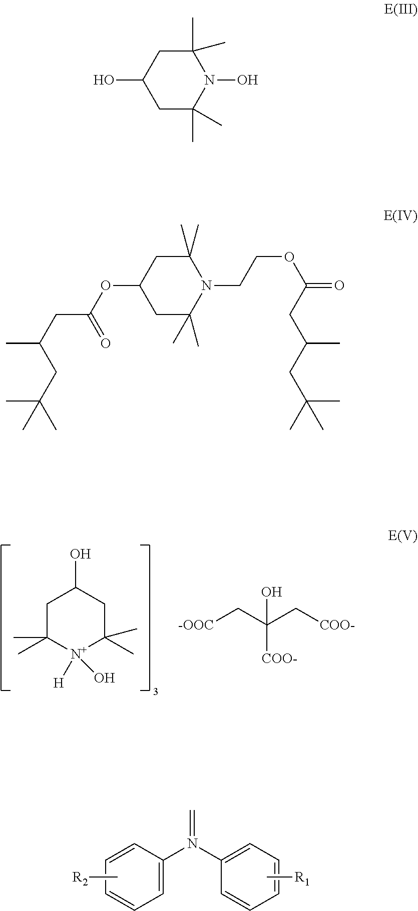

R1 and R2 independently selected form H, or C1-C20 alkyl,

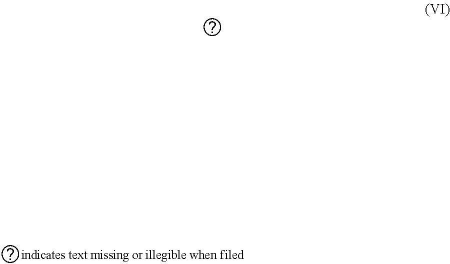

and mixture thereof, and (F) is a polyalkyleneimine polymer (F),
wherein the at least one stabilizer (B) is absorbed on the microfibrillar cellulose (A) and wherein the absorbed stabilizer (B) is at least partly coated with component (C).

Even more preferably, the presently claimed invention is directed to a composition (S) comprising
a. microfibrillar cellulose (A);
b. at least one stabilizer (B) selected form the group consisting of

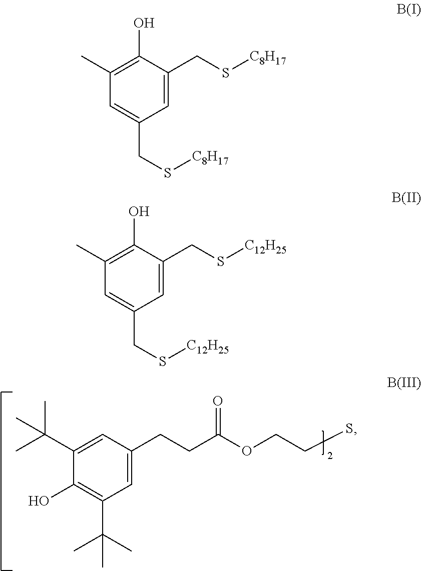

and mixture thereof,
c. at least one component (C) selected from the group consisting of

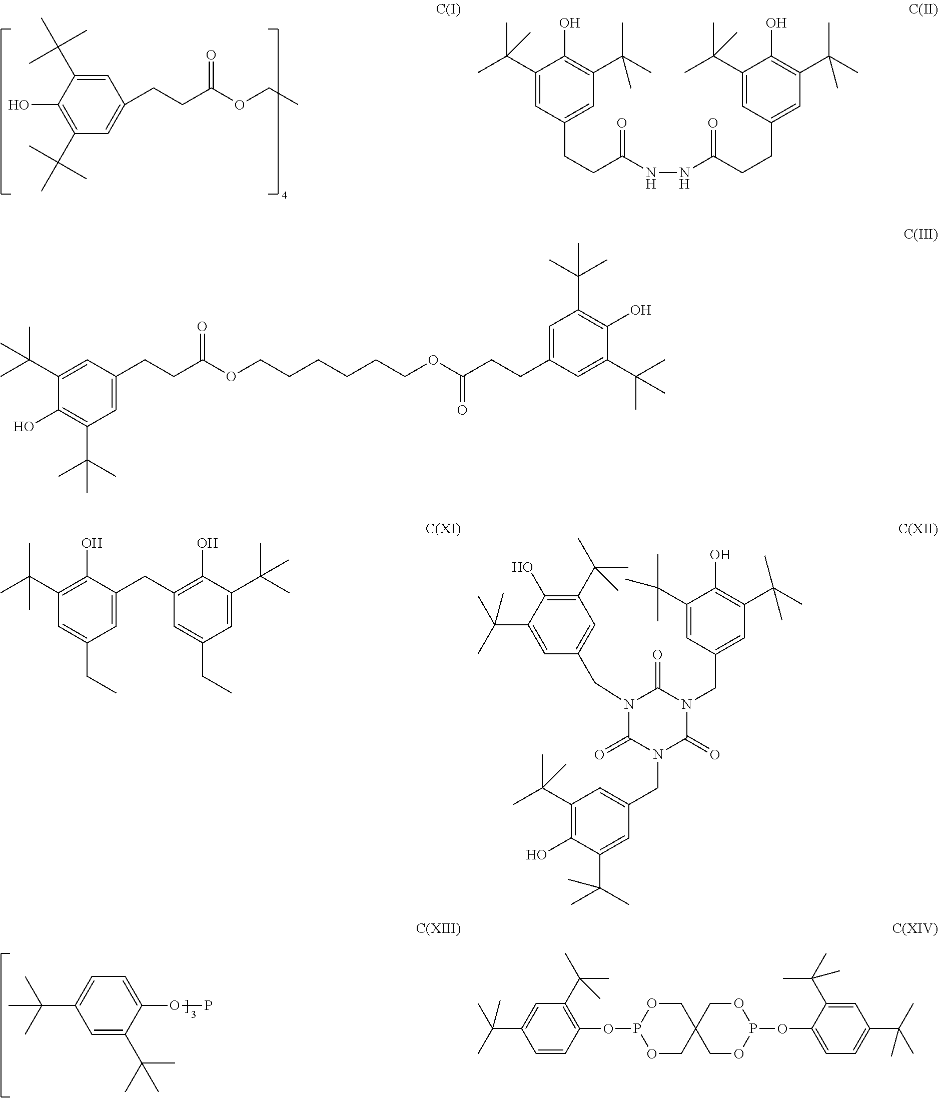

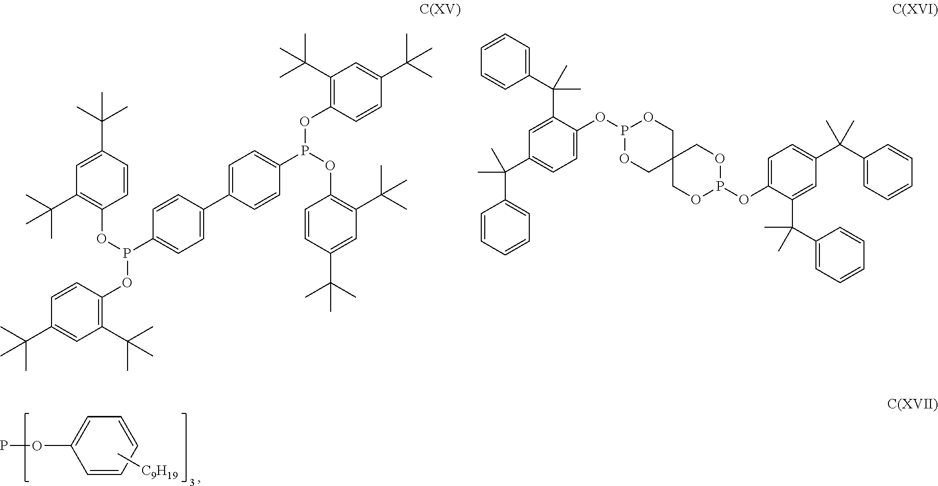

and mixture thereof, and
   the composition further comprises at least one component selected from the group consisting of (D), (E), (F), and mixtures thereof,
   wherein (D) is selected from the group consisting of

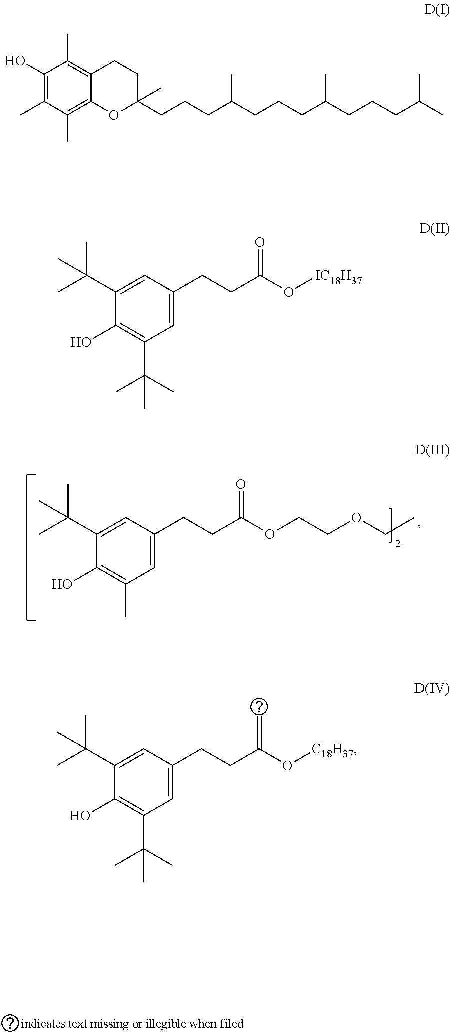

and mixture thereof,
   wherein (E) is selected from the group consisting of

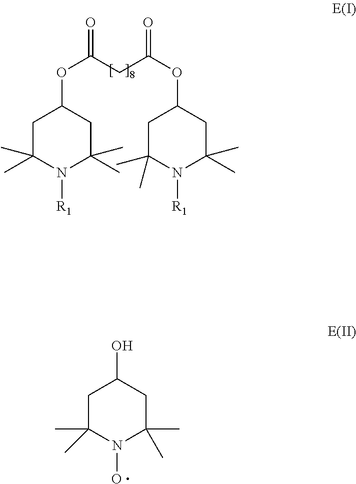

wherein R₁ is independently selected from the group consisting of H, CH₃ and OC₈H₁₇;

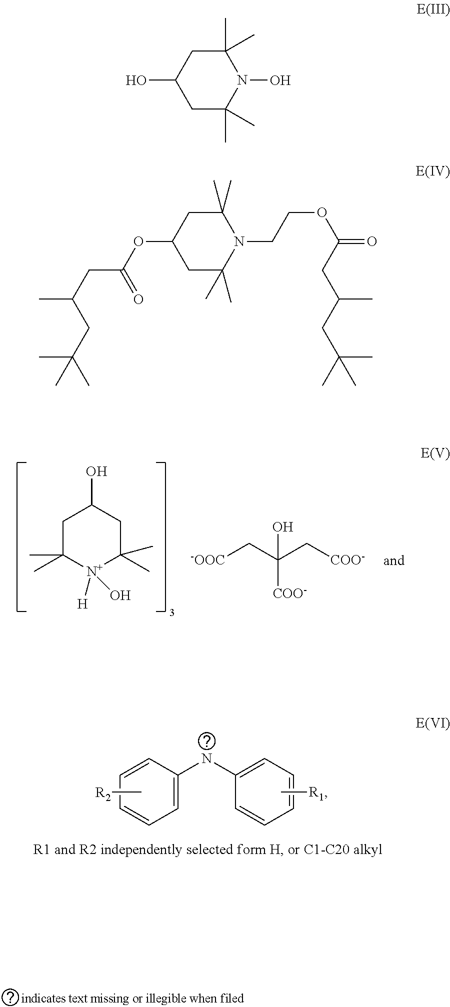

and mixture thereof, and (F) is a polyalkyleneimine polymer (F),
wherein the at least one stabilizer (B) is at least partly absorbed on the microfibrillar cellulose (A) and the absorbed stabilizer (B) is at least partly coated with component (C).

Most preferably, the presently claimed invention is directed to a composition (S) comprising
a. microfibrillar cellulose (A);
b. at least one stabilizer (B) selected form the group consisting of

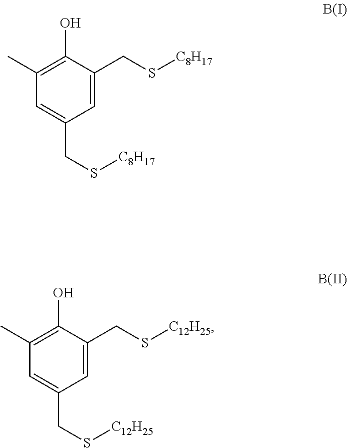

and mixture thereof,
c. at least one component (C) selected from the group consisting of

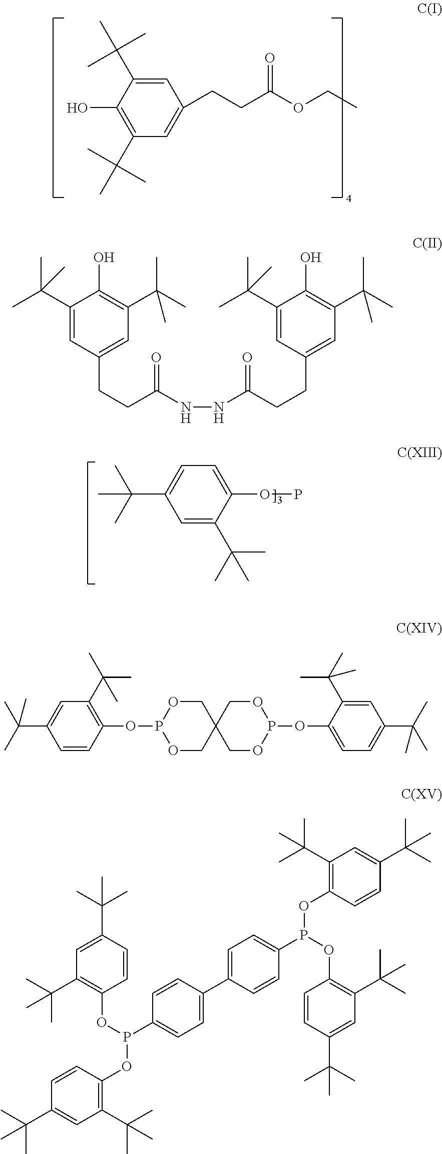

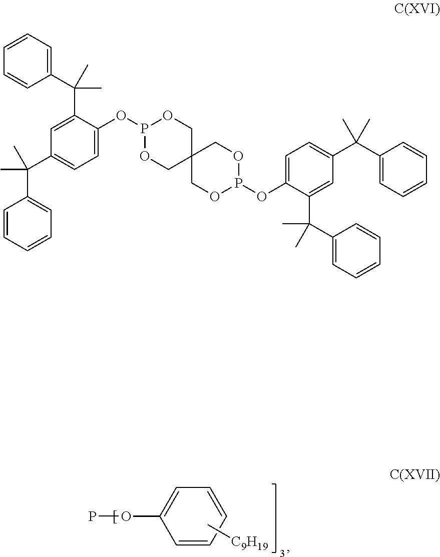

and mixtures thereof, and
   the composition further comprises at least one component selected from the group consisting of (D), (E), (F), and mixtures thereof,
wherein (D) is selected from the group consisting of

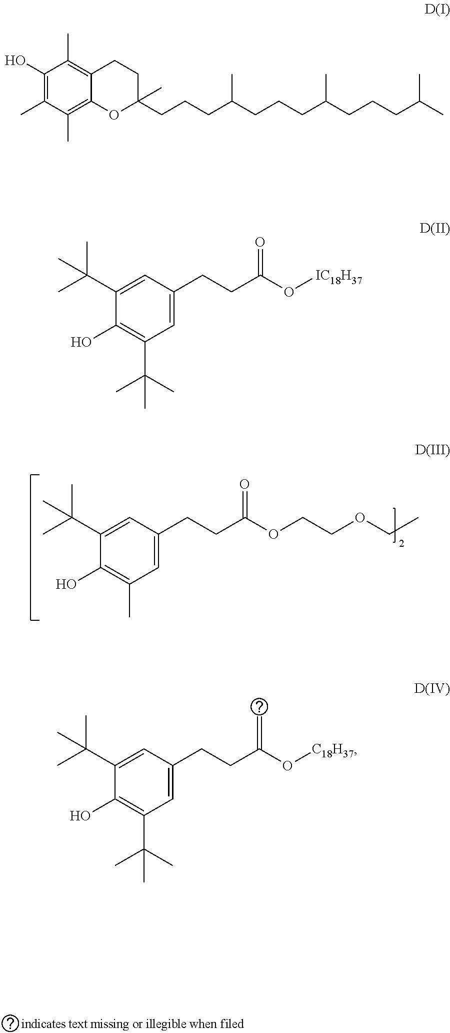

and mixtures thereof,
   wherein (E) is selected from the group consisting of

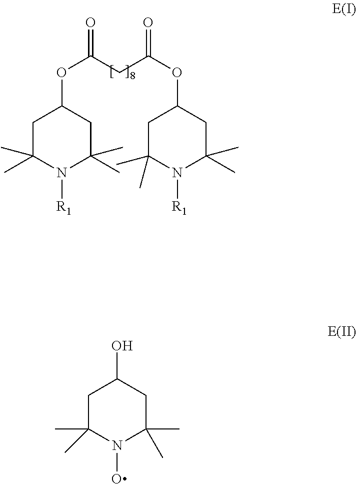

wherein R₁ is independently selected from the group consisting of H, CH₃ and OC₈H₁₇;

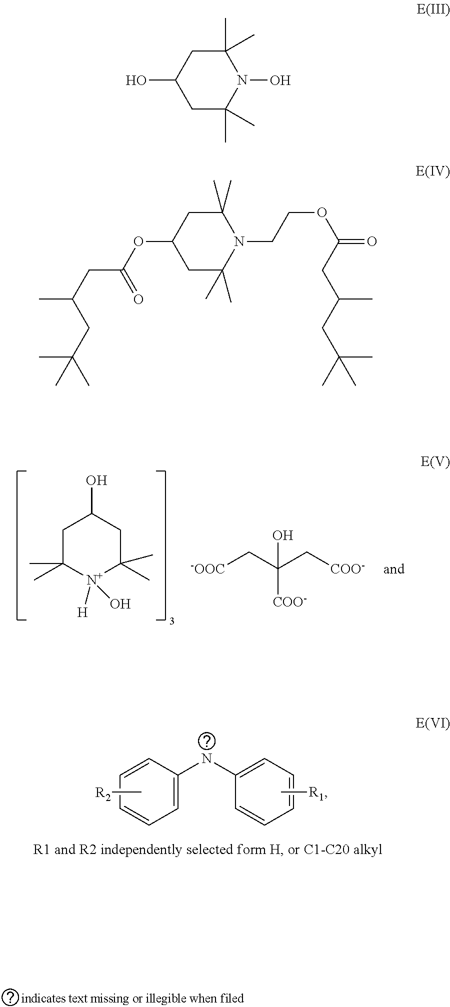

R1 and R2 independently selected form H, or C1-C20 alkyl,
and mixtures thereof, and (F) is a polyalkyleneimine polymer (F),
wherein the at least one stabilizer (B) is at least partly absorbed on the microfibrillar celluose (A) and wherein the absorbed stabilizer (B) is at least partly coated with component (C).

In particular the presently claimed invention is directed to a composition (S) comprising
a. microfibrillar cellulose (A);
b. at least one stabilizer (B) selected form the group consisting of

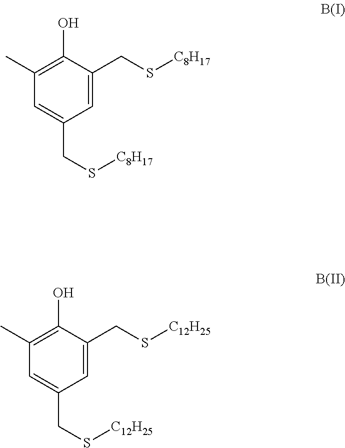

and mixture thereof,
c. at least one component (C) selected from the group consisting of

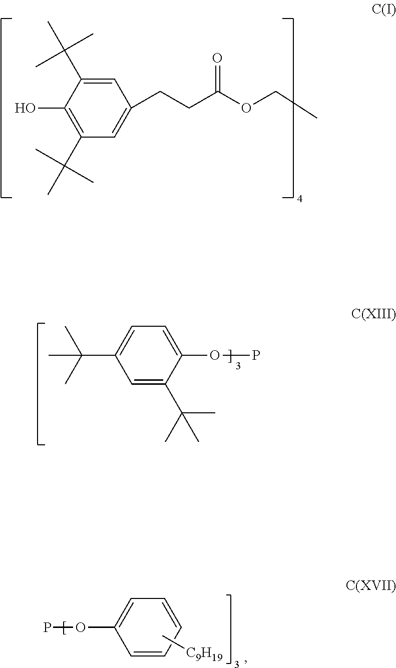

and mixtures thereof, and
   the composition further comprises at least one component selected from the group consisting of (D), (E), (F), and mixtures thereof,
wherein (D) is selected from the group consisting of

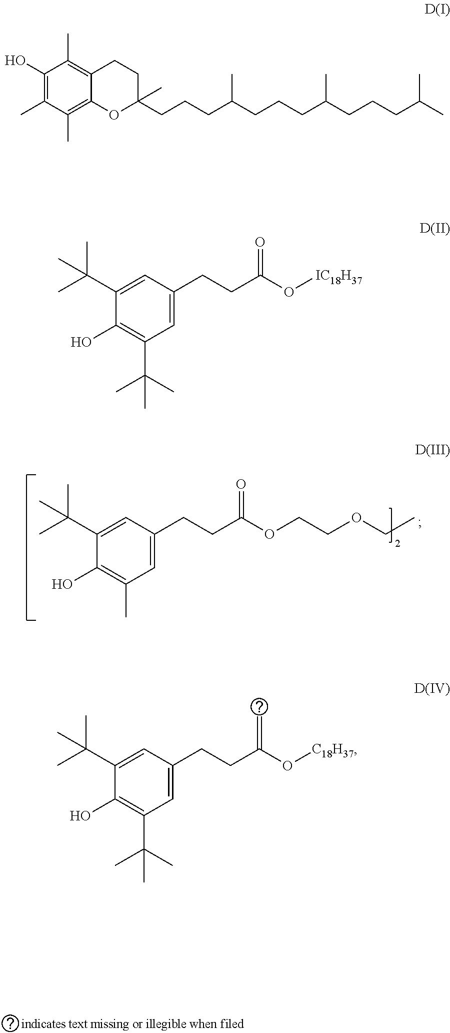

and mixtures thereof, wherein (E) is selected from the group consisting of

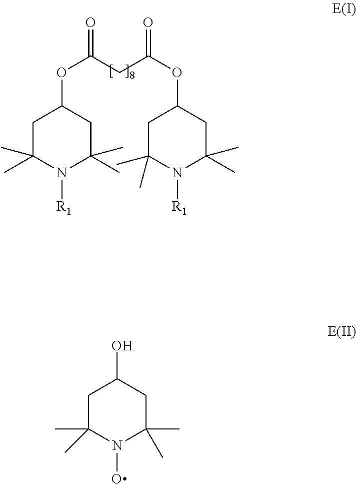

wherein R₁ is independently selected from the group consisting of H, CH₃ and OC₈H₁₇;

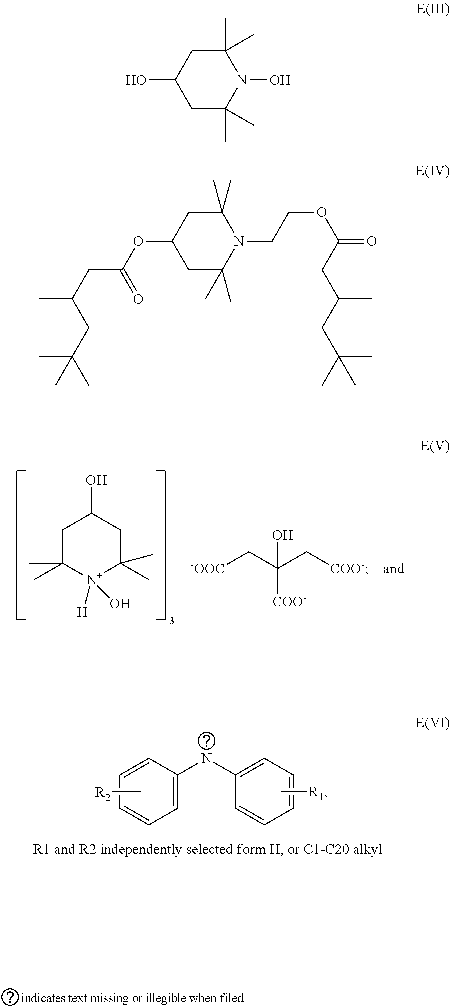

R1 and R2 independently selected form H, or C1-C20 alkyl,
and mixtures thereof, and (F) is a polyalkyleneimine polymer (F),
wherein the at least one stabilizer (B) is at least partly absorbed on the microfibrillar cellulose (A) and wherein the absorbed stabilizer (B) is at least partly coated with component (C).

In another preferred embodiment, the polyalkylenimine polymer (F) is polyalkoxylated polyalkylenimine (Fa).

In another preferred embodiment, the polyalkoxylated polyalkyenimine is polyethoxylated polyalkylenimine (Fa1) or polypropoxylated polyalkylenimine (Fa2) or random or block polyethoxy and polypropoxy polyalkylenimine (Fa3).

In another preferred embodiment, the polyalkylenimine polymer (F) is polyethyleneimine polymer.

In another preferred embodiment, the polyalkoxylated polyalkyenimine is polyalkoxylated polyethyleneimine.

In another preferred embodiment, the polyalkoxylated polyethyleneimine is polyethoxylated polyethyleneimine and/or polypropoxylated polyethyleneimine and/or random or block polyethoxy and polypropoxy polyethyleneimine.

In another preferred embodiment the polyalkyleneimine polymer (F) has a structure as below.

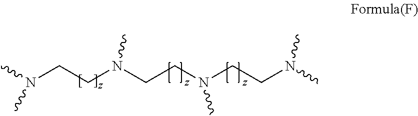

wherein z is an integer is in the range of 1 to 4, more preferably z is an integer is in the range of 1 to 3, most preferably z is an integer is in the range of 1 to 2 and in particular z is an integer 1.

In another preferred embodiment, the alkoxylated polyalkyleneimine (Fa) is a compound of formula (Fa)

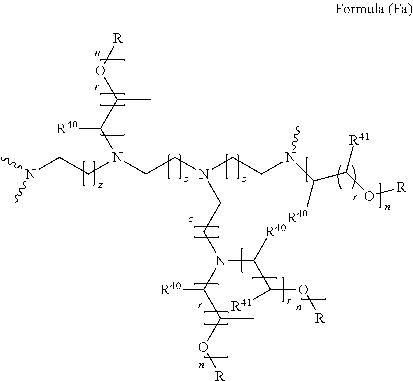

wherein R, R⁴⁰ and R⁴¹ are independently of each other selected from the group consisting of hydrogen, methyl, ethyl, propyl, isopropyl, butyl, isobutyl and t-butyl; and n is an integer in the range of 1 to 100, r is an integer in the range of 1 to 4, z is an integer is in the range of 1 to 4; more preferably, R and R⁴⁰ are independently of each other selected from the group consisting of hydrogen, methyl, ethyl, propyl and isopropyl; and n is an integer in the range of 1 to 50, r is an integer in the range of 1 to 3, z is an integer is in the range of 1 to 3; even more preferably R and R⁴⁰ are independently of each other selected from the group consisting of hydrogen, methyl and ethyl; and n is an integer in the range of 5 to 30, r is an integer in the range of 1 to 2, z is an integer is in the range of 1 to 2; most preferably R and R⁴⁰ are independently of each other selected from the group consisting of hydrogen and methyl; and n is an integer in the range of 5 to 20, r is an integer in the range of 1 to 2, z is an integer is in the range of 1 to 2; and in particular preferably R and R⁴⁰ are independently of each other selected from the group consisting of hydrogen; and n is an integer in the range of 5 to 15, r is 1, z is 1.

In another preferred embodiment, the alkoxylated polyalkyleneimine (Fa) is a compound of formula (Fa1) or a compound of formula (Fa2)

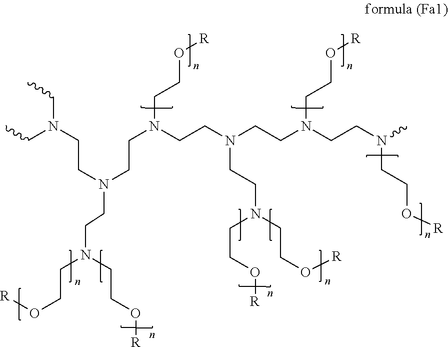

wherein R is selected from the group consisting of hydrogen, methyl, ethyl, propyl, isopropyl, butyl, isobutyl and t-butyl; and n is an integer in the range of 1 to 100; more preferably, R is selected from the group consisting of hydrogen, methyl, ethyl, propyl and isopropyl; and n is an integer in the range of 1 to 50; even more preferably R is selected from the group consisting of hydrogen, methyl and ethyl; and n is an integer in the range of 5 to 30; most preferably R is selected from the group consisting of hydrogen and methyl; and n is an integer in the range of 5 to 20; and in particular preferably R is selected from the group consisting of hydrogen; and n is an integer in the range of 5 to 15;

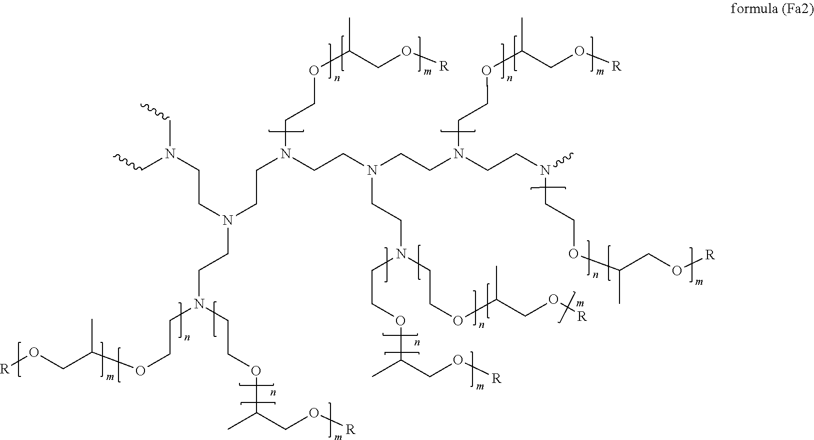

wherein R is selected from the group consisting of hydrogen, methyl, ethyl, propyl, isopropyl, butyl, isobutyl and t-butyl; n is an integer in the range of 1 to 100 and m is an integer in the range of 1 to 100; more preferably, R is selected from the group consisting of hydrogen, methyl, ethyl, propyl and isopropyl; n is an integer in the range of 1 to 50 and m is an integer in the range of 1 to 50; even more preferably R is selected from the group consisting of hydrogen, methyl and ethyl; n is an integer in the range of 5 to 30 and m is an integer in the range of 1 to 30; most preferably R is selected from the group consisting of hydrogen and methyl; n is an integer in the range of 5 to 20 and m is an integer in the range of 1 to 20; and in particular preferably R is selected from the group consisting of hydrogen; n is an integer in the range of 5 to 15 and n is an integer in the range of 1 to 10.

In another preferred embodiment, the alkoxylated polyalkyleneimine (Fa) is a compound of formula (Fa1).

In another preferred embodiment, the polyalkylenimine polymer (F) has weight average molecular weight in the range of 500 to 50000 g/mol as determined according to GPC using THF as solvent, more preferably the polyalkylenimine polymer (F) has weight average molecular weight in the range of 5000 to 40000 g/mol as determined according to GPC using THF as solvent, even more preferably the polyalkylenimine polymer (F) has weight average molecular weight in the range of 10000 to 40000 g/mol as determined according to GPC using THF as solvent, most preferably the polyalkylenimine polymer (F) has weight average molecular weight in the range of 15000 to 40000 g/mol as determined according to GPC using THF as solvent, and in particular the polyalkylenimine polymer (F) has weight average molecular weight in the range of 20000 to 40000 g/mol as determined according to GPC using THF as solvent.

In another preferred embodiment, the polyalkoxy polyalkylenimine polymer (Fa) has weight average molecular weight in the range of 500 to 50000 g/mol as determined according to GPC using THF as solvent, more preferably the polyalkoxy polyalkylenimine polymer (Fa) has weight average molecular weight in the range of 5000 to 40000 g/mol as determined according to GPC using THF as solvent, even more preferably the polyalkoxy polyalkylenimine polymer (Fa) has weight average molecular weight in the range of 10000 to 40000 g/mol as determined according to GPC using THF as solvent, most preferably the polyalkoxy polyalkylenimine polymer (Fa) has weight average molecular weight in the range of 15000 to 40000 g/mol as determined according to GPC using THF as solvent, and in particular the polyalkoxy polyalkylenimine polymer (Fa) has weight average molecular weight in the range of 20000 to 40000 g/mol as determined according to GPC using THF as solvent.

In another preferred embodiment, the polyalkoxy polyethyleneimine polymer has weight average molecular weight in the range of 500 to 50000 g/mol as determined according to GPC using THF as solvent, more preferably the polyalkoxy polyethyleneimine polymer has weight average molecular weight in the range of 5000 to 40000 g/mol as determined according to GPC using THF as solvent, even more preferably the polyalkoxy polyethyleneimine polymer has weight average molecular weight in the range of 10000 to 40000 g/mol as determined according to GPC using THF as solvent, most preferably the polyalkoxy polyethyleneimine polymer has weight average molecular weight in the range of 15000 to 40000 g/mol as determined according to GPC using THF as solvent, and in particular the polyalkoxy polyethyleneimine polymer has weight average molecular weight in the range of 20000 to 40000 g/mol as determined according to GPC using THF as solvent.

In another preferred embodiment, the polyethoxy polyethyleneimine polymer (Fa1) and polyethoxy polypropoxy polyethyleneimine polymer (Fa2) has weight average molecular weight in the range of 500 to 50000 g/mol as determined according to GPC using THF as solvent, more preferably the polyethoxy polyethyleneimine polymer (Fa1) and polyethoxy polypropoxy polyethyleneimine polymer (Fa2) has weight average molecular weight in the range of 5000 to 40000 g/mol as determined according to GPC using THF as solvent, even more preferably the polyethoxy polyethyleneimine polymer (Fa1) and polyethoxy polypropoxy polyethyleneimine polymer (Fa2) has weight average molecular weight in the range of 10000 to 40000 g/mol as determined according to GPC using THF as solvent, most preferably the polyethoxy polyethyleneimine polymer (Fa1) and polyethoxy polypropoxy polyethyleneimine polymer (Fa2) has weight average molecular weight in the range of 15000 to 40000 g/mol as determined according to GPC using THF as solvent, and in particular the polyethoxy polyethyleneimine polymer (Fa1) and polyethoxy polypropoxy polyethyleneimine polymer (Fa2) has weight average molecular weight in the range of 20000 to 40000 g/mol as determined according to GPC using THF as solvent.

In another preferred embodiment, the polyalkyleneimine polymer (F) is a branched polyalkyleneimine.

In another preferred embodiment, the component (E) is present in a total amount in the range of 0 to 10 wt. % based on overall weight of the composition, more preferably the component (E) is present in a total amount in the range of 1 to 9 wt. % based on overall weight of the composition, even more preferably the component (E) is present in a total amount in the range of 2 to 9 wt. % based on overall weight of the composition, and most preferably the component (E) is present in a total amount in the range of 2 to 8 wt. % based on overall weight of the composition.

In another preferred embodiment, the polyalkyleneimine polymer (F) is present in a total amount in the range of 0 to 10 wt. % based on overall weight of the composition, more preferably the polyalkyleneimine polymer (F) is present in a total amount in the range of 1 to 9 wt. % based on overall weight of the composition, even more preferably the polyalkyleneimine polymer (F) is present in a total amount in the range of 2 to 9 wt. % based on overall weight of the composition, and most preferably the polyalkyleneimine polymer (F) is present in a total amount in the range of 2 to 8 wt. % based on overall weight of the composition.

In another preferred embodiment, the polyethyleneimine polymer is present in an amount in the range of 0 to 10 wt. % based on overall weight of the composition, more preferably the polyethyleneimine polymer is present in an amount in the range of 1 to 9 wt. % based on overall weight of the composition, even more preferably the polyethyleneimine polymer is present in an amount in the range of 2 to 9 wt. % based on overall weight of the composition, and most preferably the polyethyleneimine polymer is present in an amount in the range of 2 to 8 wt. % based on overall weight of the composition.

In another preferred embodiment, the polyalkoxy polyethyleneimine polymer is present in an amount in the range of 0 to 10 wt. % based on overall weight of the composition, more preferably the polyalkoxy polyethyleneimine polymer is present in an amount in the range of 1 to 9 wt. % based on overall weight of the composition, even more preferably the polyalkoxy polyethyleneimine polymer is present in an amount in the range of 2 to 9 wt. % based on overall weight of the composition, and most preferably the polyalkoxy polyethyleneimine polymer is present in an amount in the range of 2 to 8 wt. % based on overall weight of the composition.

In another preferred embodiment, the polyethoxy polyethyleneimine polymer is present in an amount in the range of 0 to 10 wt. % based on overall weight of the composition, more preferably the polyethoxy polyethyleneimine polymer is present in an amount in the range of 1 to 9 wt. % based on overall weight of the composition, even more preferably the polyethoxy polyethyleneimine polymer is present in an amount in the range of 2 to 9 wt. % based on overall weight of the composition, and most preferably the polyethoxy polyethyleneimine polymer is present in an amount in the range of 2 to 8 wt. % based on overall weight of the composition.

In another preferred embodiment, at least 50% of the composition has a particle size in the range of 100 to 5000 μm as determined according to ASTM D4513-11, more preferably at least 60% of the composition has a particle size in the range of 100 to 5000 μm as determined according to ASTM D4513-11, even more preferably at least 70% of the composition has a particle size in the range of 100 to 5000 μm as determined according to ASTM D4513-11, and most preferably at least 80% of the composition has a particle size in the range of 100 to 5000 μm as determined according to ASTM D4513-11.

In another preferred embodiment, at least 30% of the composition has a particle size in the range of 500 to 2000 μm as determined according to ASTM D4513-11, more preferably at least 40% of the composition has a particle size in the range of 500 to 2000 μm as determined according to ASTM D4513-11, even more preferably, at least 50% of the composition has a particle size in the range of 500 to 2000 μm as determined according to ASTM D4513-11, and most preferably at least 60% of the composition has a particle size in the range of 500 to 2000 μm as determined according to ASTM D4513-11.

In another embodiment, the presently claimed invention directed to a process for the preparation of a stabilizer composition (S) comprising the steps of:
a. providing the microfibrillar cellulose (A);
b. providing at least one component (C) to obtain a mixture of component (A) and at least one component (C); and
c. dispensing at least one stabilizer (B) to the mixture obtained in step b. to obtain a ternary mixture,
e. mixing the ternary mixture obtained in step c. to obtain a homogenous composition, wherein component (A), stabilizer (B) and component (C) are as defined as above.

In another preferred embodiment, the process for the preparation of a stabilizer composition (S) comprising the steps of:
a. providing the microfibrillar cellulose (A);
b. providing at least one component (C) to obtain a mixture of component (A) and at least one component (C); and
c. dispensing at least one stabilizer (B) to the mixture obtained in step b. to obtain a ternary mixture,
e. mixing the ternary mixture obtained in step c. to obtain a homogenous composition, wherein stabilizer (B) is selected from the group consisting of

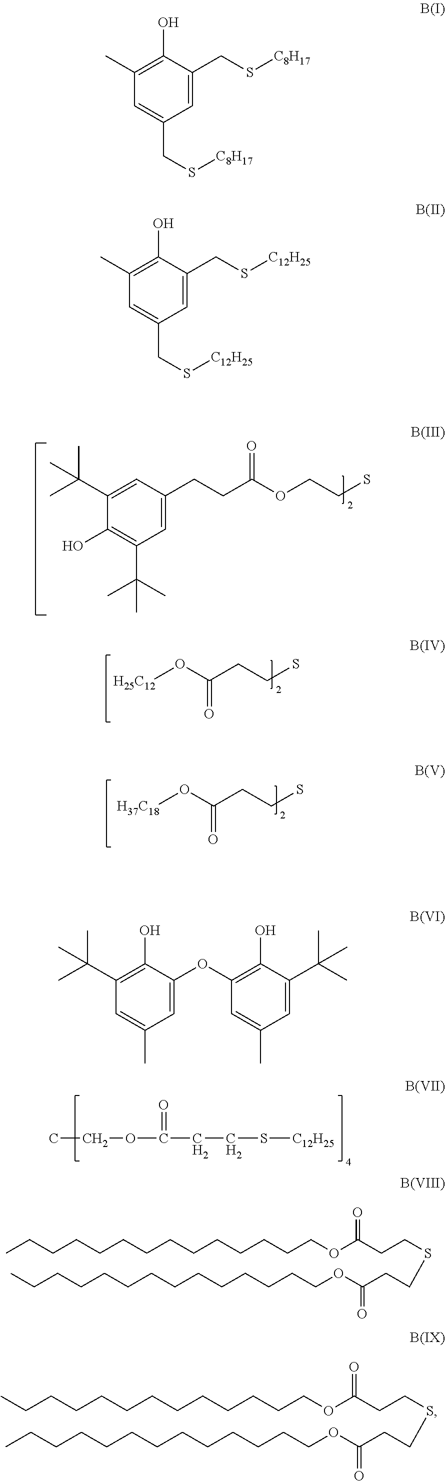

and mixtures thereof, and
and component (C) is selected from the group consisting of

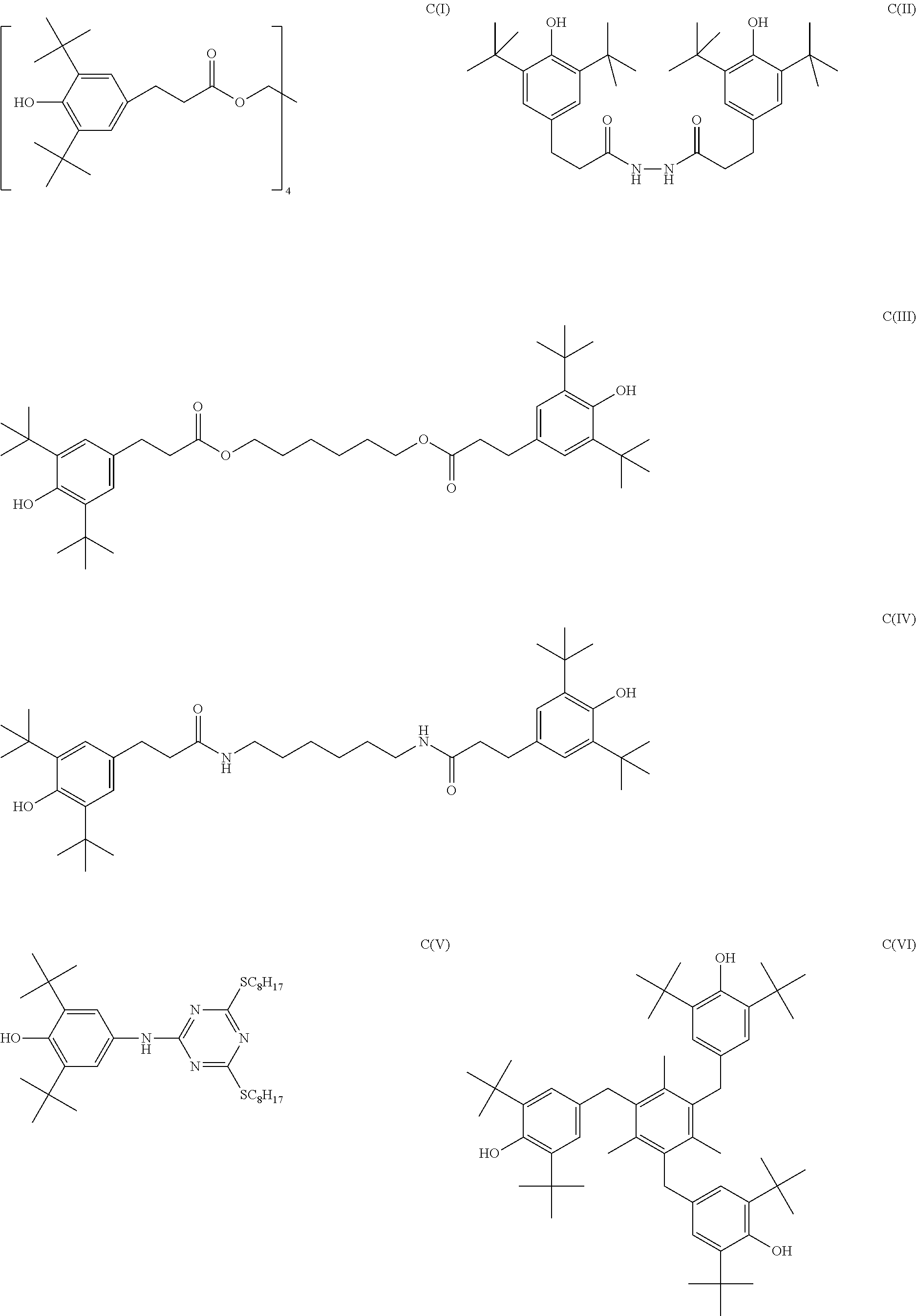

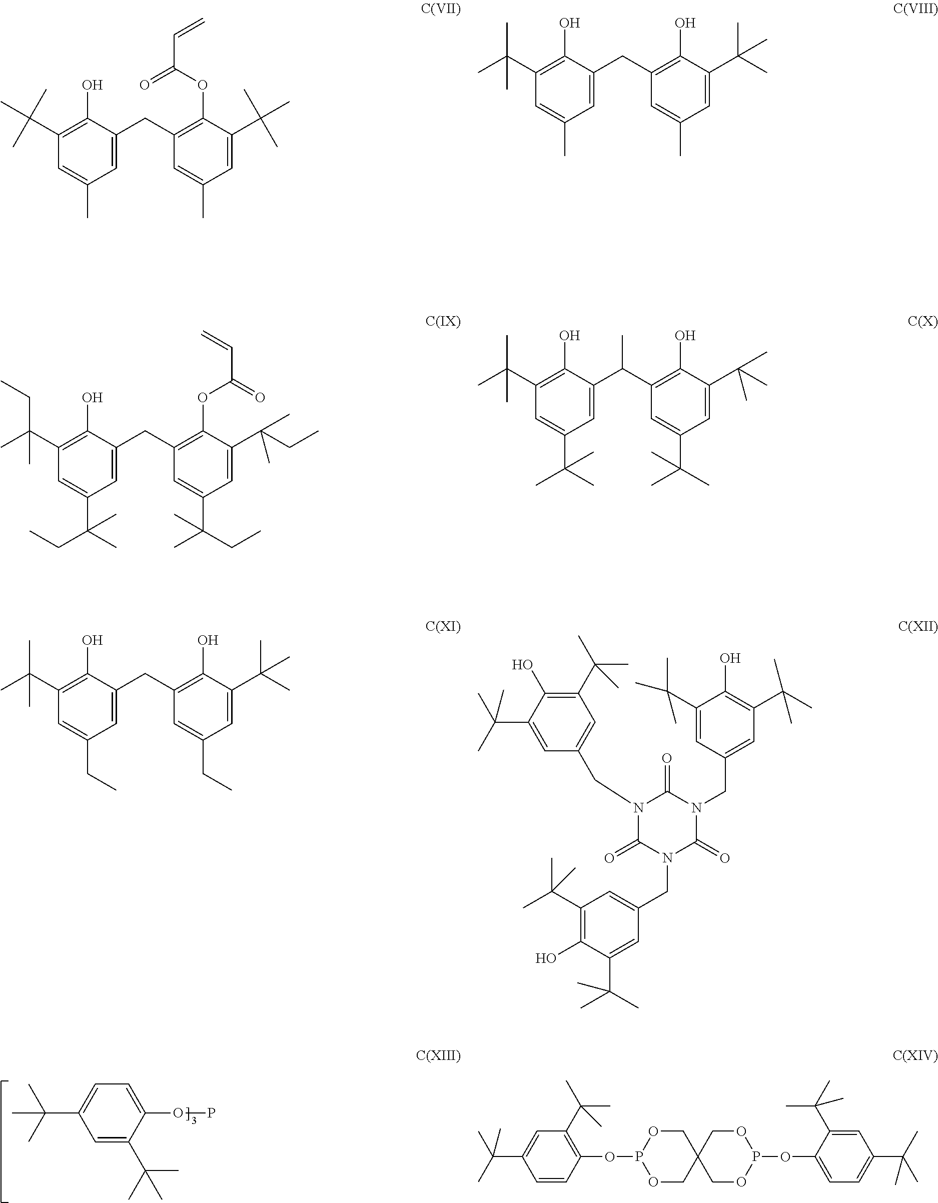

and mixtures thereof.

More preferably the process for the preparation of a stabilizer composition (S) comprising the steps of:
a. providing the microfibrillar cellulose (A);
b. providing at least one component (C) to obtain a mixture of component (A) and at east one component (C); and
c. dispensing at least one stabilizer (B) to the mixture obtained in step b. to obtain a ternary mixture,
e. mixing the ternary mixture obtained in step c. to obtain a homogenous composition, wherein stabilizer (B) is selected from the group consisting of

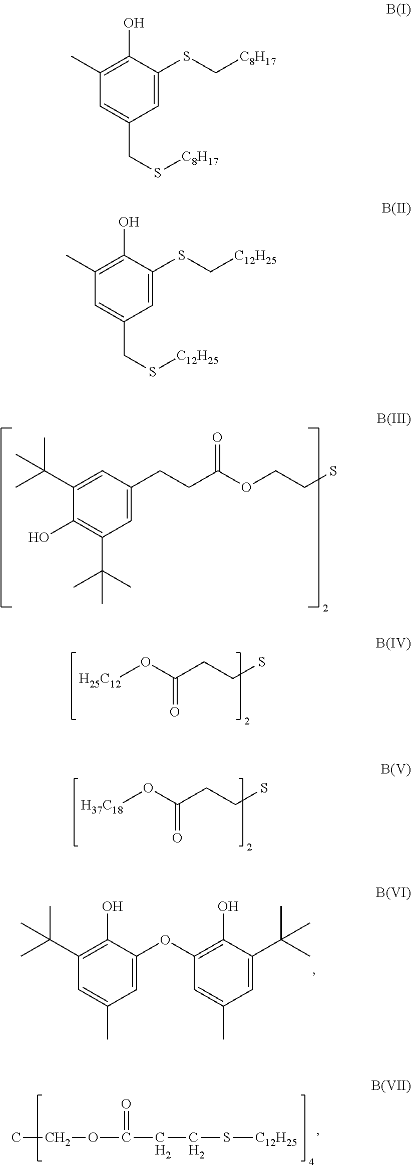

and mixtures thereof,
   and the at least one component (C) selected from the group consisting of

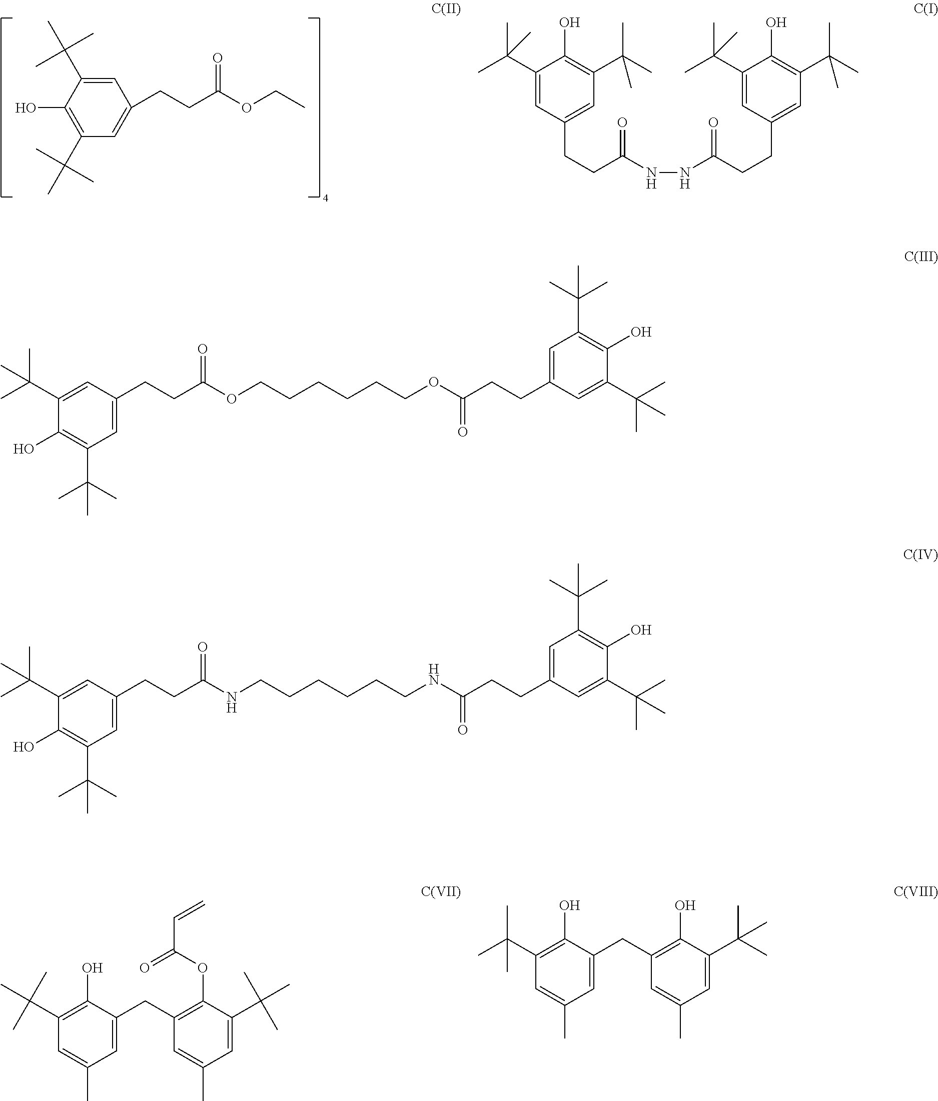

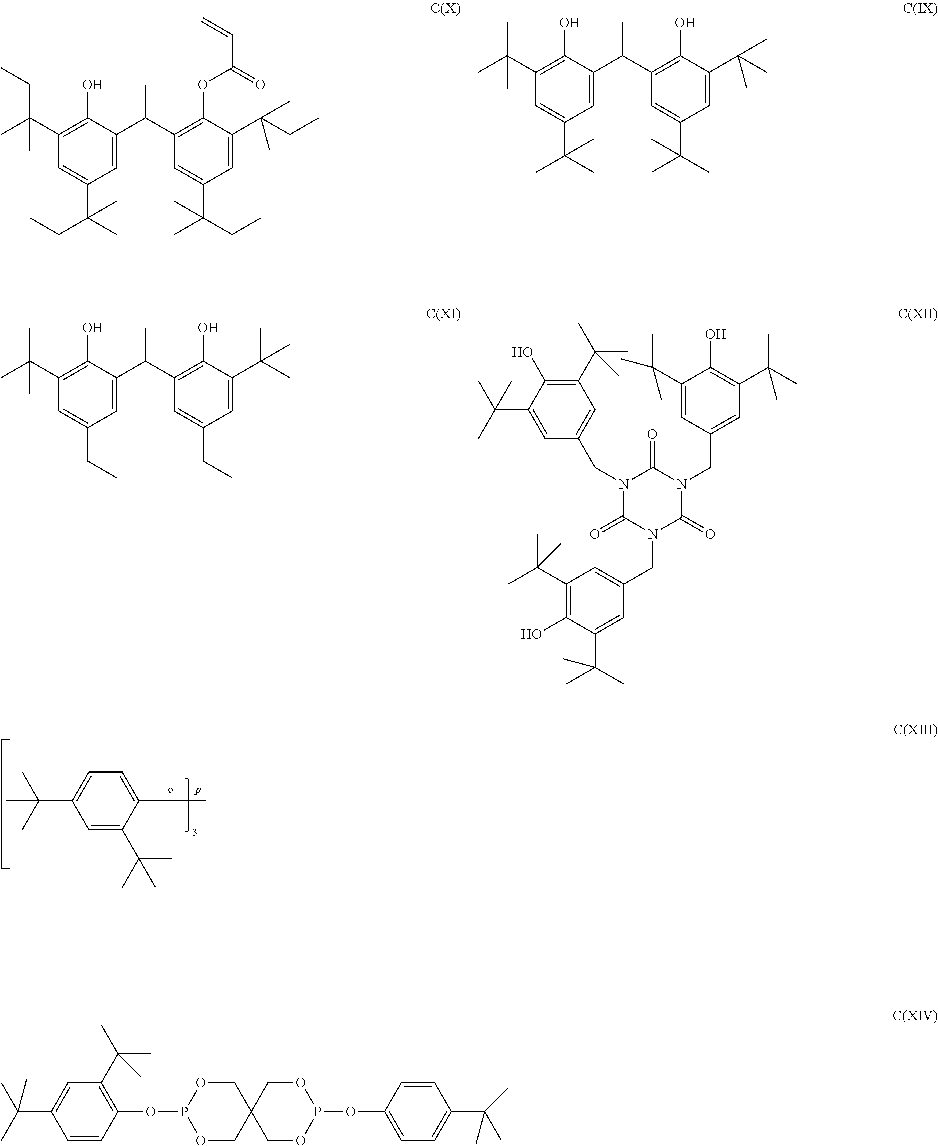

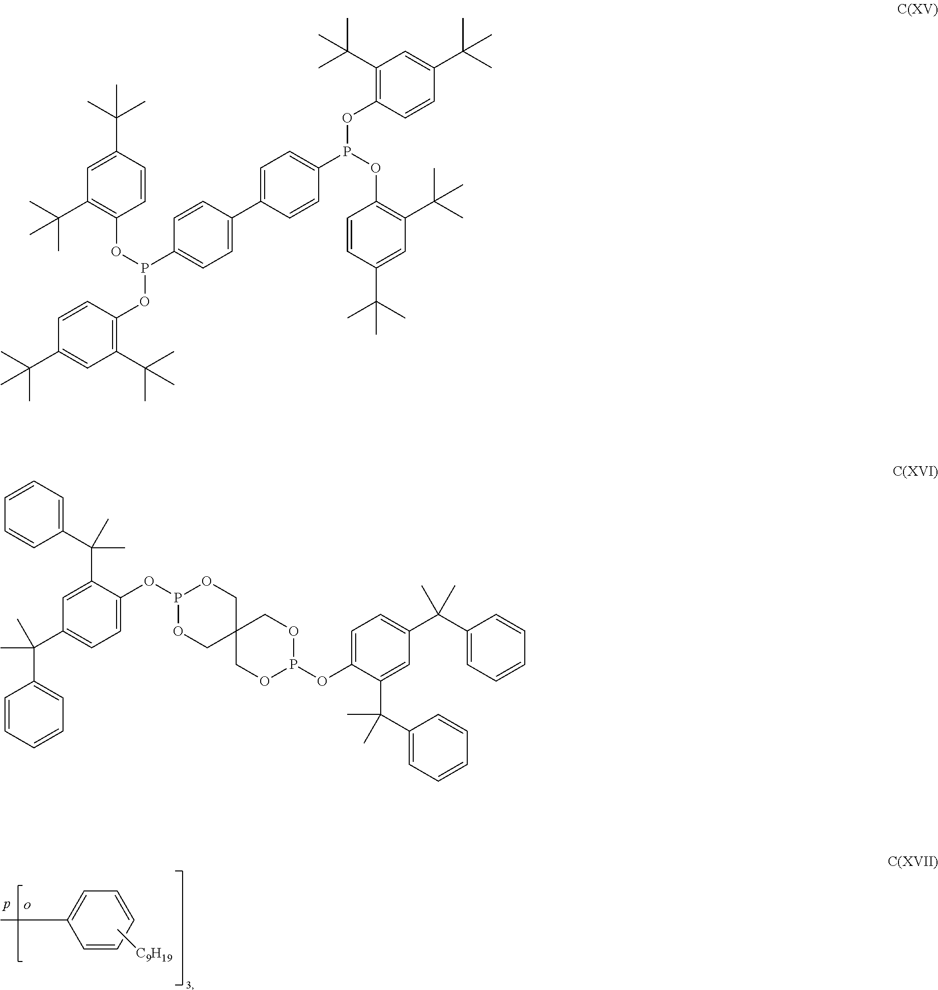

and mixtures thereof.

Even more preferably the process for the preparation of a stabilizer composition (S) comprises the steps of:
a. providing the microfibrillar cellulose (A);
b. providing at least one component (C) to obtain a mixture of component (A) and at least one component (C); and
c. dispensing at least one stabilizer (B) to the mixture obtained in step b. to obtain a ternary mixture,
e. mixing the ternary mixture obtained in step c. to obtain a homogenous composition, wherein stabilizer (B) is selected from the group consisting of

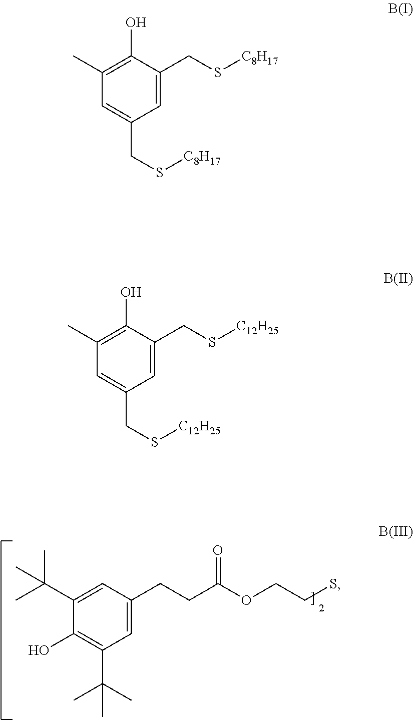

and mixtures thereof,
   and the at least one component (C) selected from the group consisting of

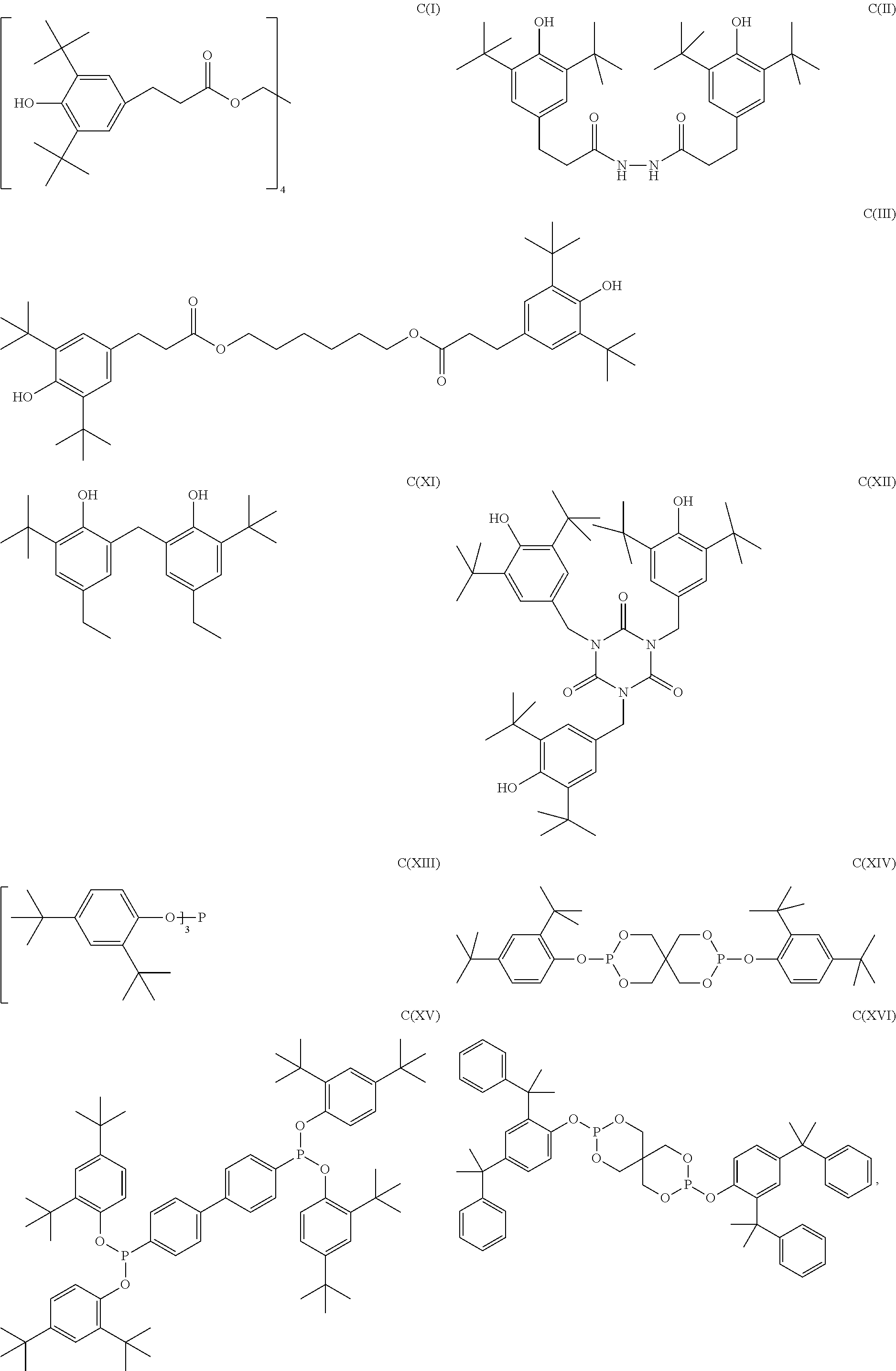

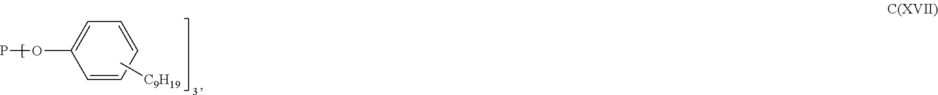

and mixtures thereof.

Most preferably the process for the preparation of a stabilizer composition (S) comprising the steps of:
a. providing the microfibrillar cellulose (A);
b. providing at least one component (C) to obtain a mixture of component (A) and at east one component (C); and
c. dispensing at least one stabilizer (B) to the mixture obtained in step b. to obtain a ternary mixture,
e. mixing the ternary mixture obtained in step c. to obtain a homogenous composition, wherein stabilizer (B) is selected from the group consisting of

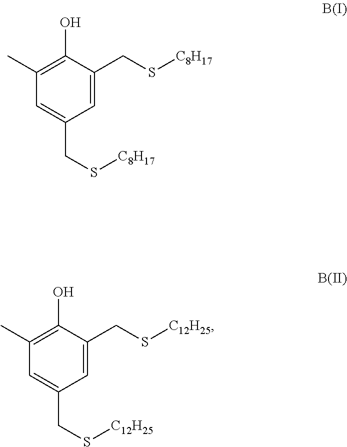

and mixtures thereof,
   and the at least one component (C) is selected from the group consisting of

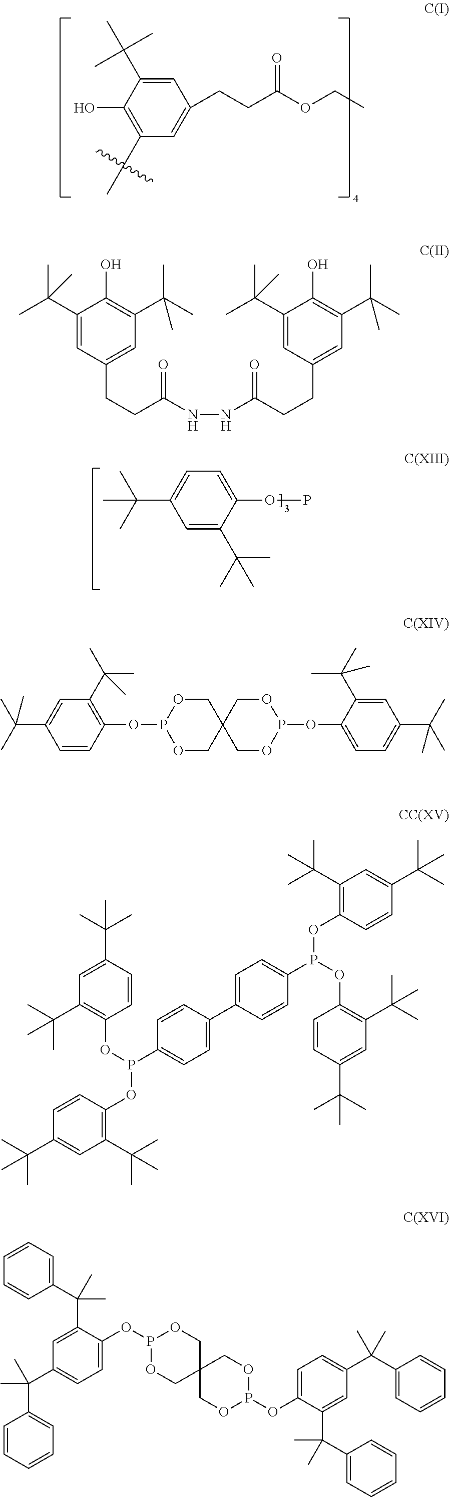

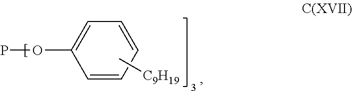

and mixtures thereof,
   and in particular the process for the preparation of a stabilizer composition (S) comprising the steps of:
a. providing the microfibrillar celluose (A);
b. providing at least one component (C) to obtain a mixture of component (A) and at least one component (C); and
c. dispensing at least one stabilizer (B) to the mixture obtained in step b. to obtain a ternary mixture,
e. mixing the ternary mixture obtained in step c. to obtain a homogenous composition, wherein stabilizer (B) is

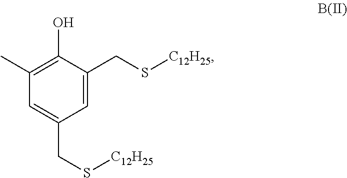

and the at least one component (C) is selected from the group consisting of

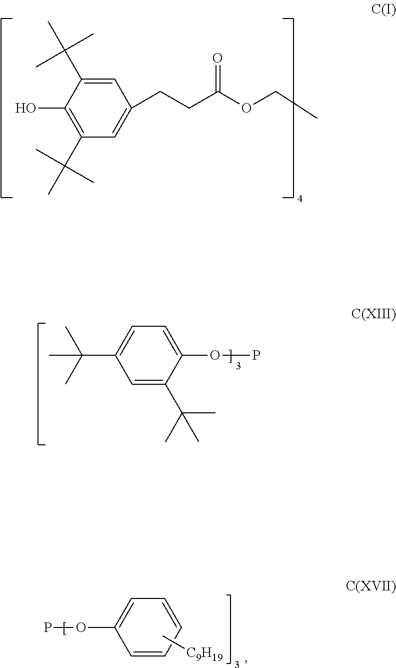

and mixtures thereof.

In another preferred embodiment, the process further comprises a step of:
d. providing at least one further component selected from the group consisting of (D) (E), polyethyleneimine polymer (F), and mixtures thereof,
   wherein component (D), component (E), and polyethyleneimine polymer (F) are as defined as above;
   more preferably the process further comprises a step of:
d1. providing at least one component (D); and
d2. providing at least one further component selected from the from the group consisting of (E), polyethyleneimine polymer (F), and a mixture thereof wherein component (D), component (E), polyethyleneimine polymer (F) are as defined as above; and
   most preferably the process further comprises a step of:
d1. providing at least one component (D);
d2. providing at least one component (E); and
d3. providing polyethyleneimine polymer (F),
   wherein component (D), component (E), polyethyleneimine polymer (F) are as defined as above.

In another preferred embodiment a process for the preparation of composition (S) comprising the steps of:
a. providing 0-50% microfibrillar cellulose (A);
b. providing 0-50% of at least one component (C) to obtain a mixture of component (A) and at least one component (C); and
c. dispensing 0-50% of at least one stabilizer (B) to the mixture obtained in step b. to obtain a ternary mixture, while heating the stabilizer (B) to a temperature between approximately 20 to 150 degrees Celsius and dispensing the melted stabilizer (B) via means of spraying the uniformly melted stabilizer (B) via a pressure nozzle up to 150 bar pressure or a dispenser
e. shearing the ternary mixture obtained step c with a high shear mixer for 10 to 30 minutes to obtain a homogenous composition in the form of a granulate,
wherein component (A), stabilizer (B) and component (C) are as above.

Within the context of the presently claimed invention, it is understood that the process steps of dispensing (adding/mixing) microfibrillar cellulose (A); stabilizer (B), component (C), component (D), component (E), and polyethyleneimine polymer (F) may be dispensed (added/mixed) in different sequence.

In another preferred embodiment, microfibrillar cellulose (A) and stabilizer (B) may be dispensed (added/mixed) to obtain a mixture followed by dispensing component (C).

In another preferred embodiment, microfibrillar cellulose (A), stabilizer (B) and optional component (D), component (E), and polyethyleneimine polymer (F) may be dispensed (added/mixed) to obtain a mixture followed by dispensing component (C).

In another preferred embodiment, microfibrillar cellulose (A), component (C) and optional component (D), component (E), and polyethyleneimine polymer (F) may be dispensed (added/mixed) to obtain a mixture followed by dispensing stabilizer (B).

In another preferred embodiment, microfibrillar cellulose (A), and optional component (D), component (E), and polyethyleneimine polymer (F) may be dispensed to obtain a mixture followed by dispensing (adding/mixing) component (C) and then stabilizer (B).

In another preferred embodiment, microfibrillar cellulose (A), and optional component (D), component (E), and polyethyleneimine polymer (F) may be dispensed (added/mixed) to obtain a mixture followed by dispensing stabilizer (B) and then component (C).

As used herein, by “spray granulation” is meant a process for producing free-flowing powder or granules that involves spraying of liquid or aerosol stabilizer (B) into a powder bed consisting of microfibrillar cellulose (A) and component (C). A variety of mixing and spraying apparatuses can be used to produce the granules; a non-limiting number of different intensive mixers and sprays are commercially available. Examples of intensive mixers that can be used for the process are batch mixers such as Eirich high-shear mixers or continuous mixers such as the Lödige Continuous Ringlayer Mixer CoriMix® CM. Examples of pressure nozzle sprays that can be used are single-phased or two-phased pressure spray nozzles as supplied, for example, by the company Schlick or by the company Spraying Systems. However, other pressure spray nozzles and built-in liquid-phase dispensers are also suitable.

In another preferred embodiment, the stabilizer (B) in the process is dispensed as liquid (melt) or as an aerosol composition, more preferably the stabilizer (B) in the process is dispensed as an aerosol composition by means of a two-phased pressure spray nozzle. The spraying pressure is up to 150 bar, preferably about 1 bar to 50 bar, even more preferably about 1 bar to 6 bar.

The temperature of the stabilizer (B) is maintained at a temperature in the range of 20 to 150° C. during dispensing in step c., more preferably the stabilizer (B) is maintained at a temperature in the range of 30 to 130° C. during dispensing in step c., even more preferably the stabilizer (B) is maintained at a temperature in the range of 40 to 130° C. during dispensing in step c., the stabilizer (B) is maintained at a temperature in the range of 50 to 130° C. during dispensing in step c., and in particular the stabilizer (B) is maintained at a temperature in the range of 60 to 120° C. during dispensing in step c.

The viscosity of the stabilizer (B) is maintained at a viscosity in the range of 2 to 250 mPas during dispensing in step c., more preferably the stabilizer (B) is maintained at a viscosity in the range of 5 to 100 mPas during dispensing in step c., even more preferably the stabilizer (B) is maintained at a viscosity in the range of 5 to 50 mPas during dispensing in step c., the stabilizer (B) is maintained at a viscosity in the range of 4 to 30 mPas during dispensing in step c., and in particular the stabilizer (B) is maintained at a viscosity in the range of 5 to 20 mPas during dispensing in step c.

The above powder consisting of microfibrillar cellulose (A), dispensed stabilizer (B) and component (C) are mixed in various proportions with preferably a high shear mixer (range of 450 to 5000 rpm, more preferably in the range of 900-5000). A high shear mixer is used to shear the material, preferably one with high shear impeller blade. The mixture is maintained at room temperature for 10 to 90 minutes and sheared at the same time to form granules. The mixing rpm is in the range of 1 to 5000 based on the diameter and/or the shape of the mixer while dispensing the liquid or aerosol stabilizer (B) to obtain a homogenous mixture. Thus, the obtained mixture is in the form of free-flowing powder or granule between 10 to 3000 μm. More preferably the obtained mixture is in the form of granules comprise of particle sizes between 500 to 2000 μm.

For example, for a mixer having inner diameter of 0.125 m, the rpm is set in the range of 450 to 5000, more preferably rpm set in the range of 900 to 5000.

Some commercially available high shear mixers that can be used for the process are the range of Eirich high-shear batch mixers or a Lödige Continuous Ringlayer Mixer CoriMix® CM.

In another preferred embodiment, in the step e. the mixing speed is in the range of 1 to 5000 rpm based on the diameter and/or the shape of the mixer, more preferably, the mixing speed is in the range of 500 to 5000 rpm based on the diameter and/or the shape of the mixer, and most preferably the mixing speed is in the range of 850 to 2000 rpm based on the diameter and/or the shape of the mixer.

In another preferred embodiment, the stabilizer (B) is maintained at a temperature in the range of 20 to 150° C. during dispensing in step c., more preferably the stabilizer (B) is maintained at a temperature in the range of 30 to 130° C. during dispensing in step c., even more preferably the stabilizer (B) is maintained at a temperature in the range of 40 to 130° C. during dispensing in step c., the stabilizer (B) is maintained at a temperature in the range of 50 to 130° C. during dispensing in step c., and in particular the stabilizer (B) is maintained at a temperature in the range of 60 to 120° C. during dispensing in step c.

In another preferred embodiment, the stabilizer (B) is dispensed at step c. using a spray head selected from, either a single-substance nozzle or two-substances nozzle of flat spray, or hollow cone, or full cone configurations with angle between 10 to 900 and spray capacity between a range of 0.01 to 100 I/min or a liquid dispenser system with volumetric pump with a dispensing range of 0.01 to 100 I/min.

In another preferred embodiment, the single-substance nozzle spray head having hollow cone spray pattern sprayed at 60° or 80° or 900 angle at pressure in the range of 1 to 50 bar, preferably 3 to 10 bar having bore hole in the range of 0.10 mm to 2.5 mm. An example for the single-substance nozzle spray head having hollow cone spray pattern spray is available from Schlick™ series 121-123.

In another preferred embodiment, the two-substance nozzle spray head having flat spray nozzle with oval-flat jet spray pattern sprayed at 10-90° angle at pressure in the range of 1 to 50 bar, has droplet size in the range of 10 μm to 150 μm. An example for the single-substance nozzle spray head having hollow cone spray pattern is available from Schlick™ series 930.

In another preferred embodiment, the two-substance nozzle spray head having full cone nozzle with circular full cone (std) or oval flat (flat spray cap) spray pattern sprayed at 10-400 angle for circular full cone and 10-700 angle for oval flat (flat spray cap) at pressure in the range of 1 to 50 bar, has droplet size in the range of 10 μm to 50 μm. An example for the two-substance nozzle spray head having full cone nozzle with circular full cone (std) or oval flat (flat spray cap) spray pattern is available from Schlick™ series 970.

In another preferred embodiment, the two-substance nozzle spray head having full cone nozzle with circular full cone spray pattern sprayed at 10-400 angle for circular full at pressure in the range of 1 to 50 bar, has droplet size in the range of 10 μm to 150 μm. An example for the two-substance nozzle spray head having full cone nozzle with circular full cone spray pattern is available from Schlick™ series 940 and 0/2-0/9.

In another preferred embodiment, the two-substance nozzle spray head having full cone nozzle with circular full cone spray pattern sprayed at 20-40° angle for circular full at pressure in the range of 1 to 50 bar, has droplet size in the range of 20 μm to 200 μm. An example for the two-substance nozzle spray head having full cone nozzle with circular full cone spray pattern is available from Schlick™ series 822-854.

In another embodiment, presently claimed invention is directed to a stabilized hot melt adhesive composition comprising:
i. at least one hot melt adhesive materials selected from the group consisting of natural rubber, synthetic rubber such as butyl rubber, ethylene-propylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymers, and mixture thereof; and
ii. a composition (S) as described above.

Hot melt adhesive (HMA), also known as hot glue, is a form of thermoplastic adhesive that is supplied in different forms ranging from solid cylindrical sticks of various diameters up to pillows or blocks in siliconized paper, designed to be melted in an electric hot glue machine (i.e. melting pots, heated ring mains, guns etc.). The application device uses a continuous-duty heating element to melt the plastic glue, which may be pushed through a gun by a mechanical trigger mechanism, or directly by the user. The glue squeezed out of the heated nozzle is initially hot enough to achieve low enough viscosity to wet the surface appropriately. The glue is tacky when hot and solidifies in a few seconds to one minute. Hot melt adhesives can also be applied by slot dies, curtain coating or spraying. There are also hot melt adhesives that maintain their tackiness after dispensing even at room temperature. Those hot melts are commonly referred to as hot melt pressure sensitive adhesives (HM-PSA)

Hot melt adhesives have long shelf life and usually can be used after prolonged period of storage. Some of the disadvantages involve thermal load of the substrate, limiting use to substrates not sensitive to higher temperatures, and loss of bond strength at higher temperatures, up to complete melting of the adhesive. This can be reduced by using a reactive adhesive that after solidifying undergoes further curing e.g., by moisture (e.g., reactive urethanes and silanes), or is cured by ultraviolet radiation.

Hot melt glues usually comprise a composition with various additives. The composition is usually formulated to have a glass transition temperature (differentiating the glassy from the rubbery state) below the lowest service temperature and a suitably high melt temperature as well. The degree of crystallization determines the open time of the adhesive. The melt viscosity and the crystallization rate (and corresponding open time) can be tailored for the application. Higher crystallization rate usually implies higher bond strength. Some polymers can form hydrogen bonds between the chains, forming pseudo-crosslinks strengthening the polymer.

The nature of the polymer, tackifier, resin and additive influence the nature of mutual molecular interaction and interaction with the substrate. Polar groups, hydroxyls and amine groups can form hydrogen bonds with polar groups on substrates like paper or wood or natural fibers. Non-polar polyolefin chains interact well with non-polar substrates. Good wetting of the substrate is essential for forming a satisfying bond between the adhesive and the substrate. More polar compositions tend to have better adhesion due to their higher surface energy. The distribution of molecular weights and degree of crystallinity influences the width of melting temperature range. Polymers with crystalline nature tend to be more rigid and have higher cohesive strength than the corresponding amorphous ones, but also transfer more strain to the adhesive-substrate interface. Higher molecular weight of the polymer chains provides higher tensile strength and heat resistance. Presence of unsaturated bonds makes the adhesive more susceptible to autoxidation and UV degradation and necessitates use of antioxidants and stabilizers. Increase of bond strength and service temperature can be achieved by formation of cross-links in the polymer after solidification. This can be achieved by using polymers undergoing curing with residual moisture (e.g., reactive polyurethanes, silicones), exposition to ultraviolet radiation, electron irradiation, or by other methods.

In another preferred embodiment, the at least one hot melt adhesive materials selected from the group consisting of natural rubber, synthetic rubber such as butyl rubber, ethylene-propylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymers.

In another preferred embodiment, the hot melt adhesive composition is stabilized against degradation due to one or more of light, oxygen and heat by providing at least one composition (S) as described above.

In another preferred embodiment, the stabilized hot melt adhesive composition further comprises at least one component (G) selected from the group consisting of;

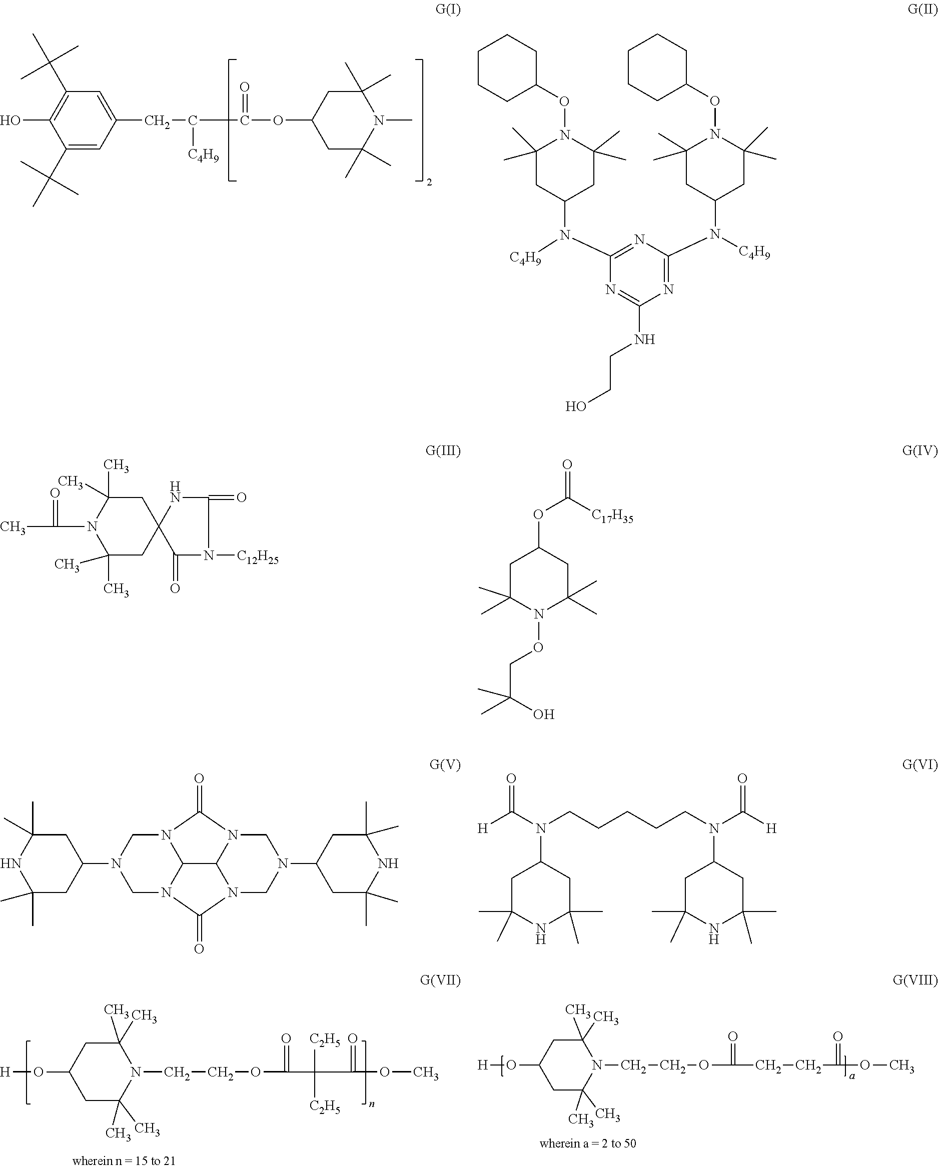

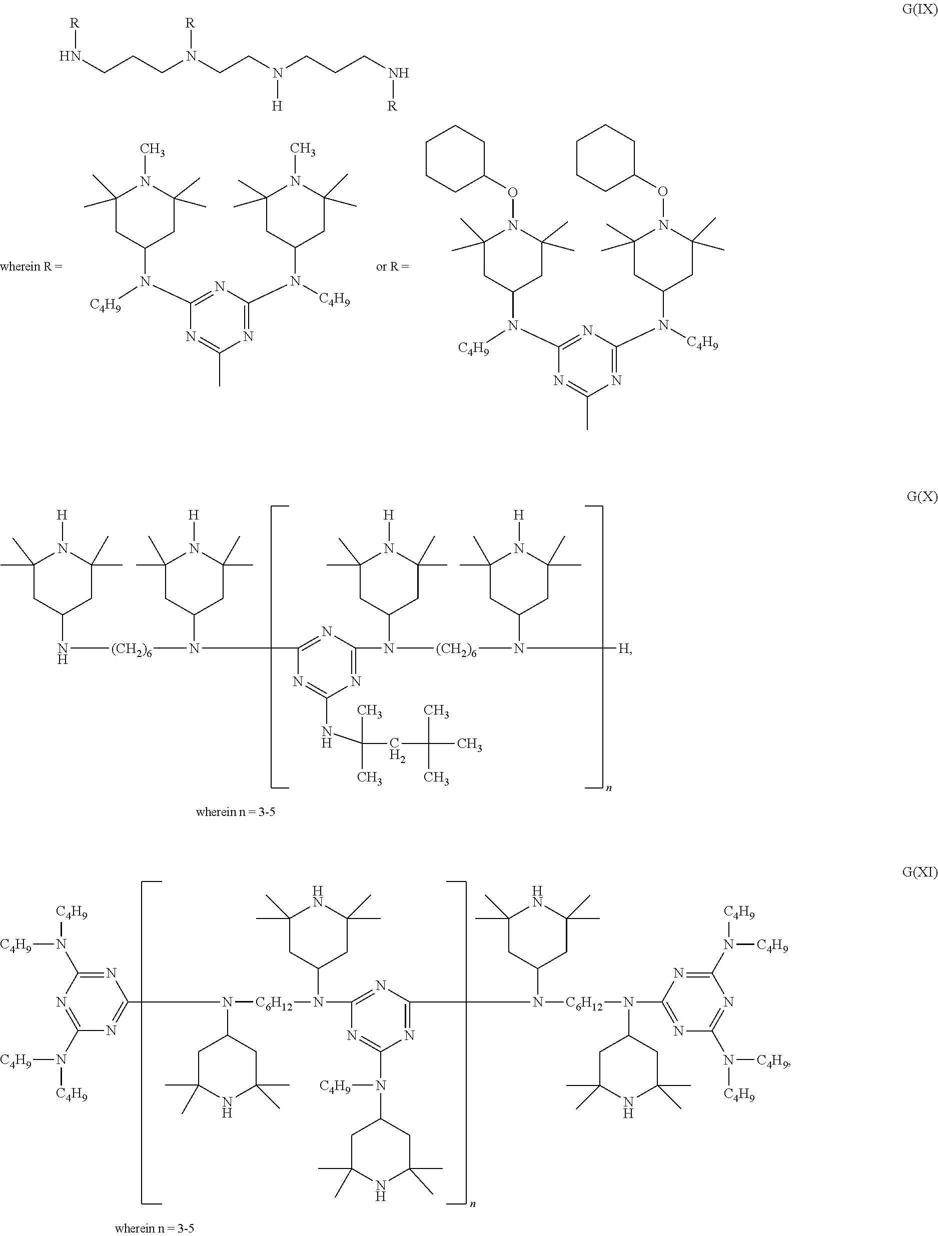

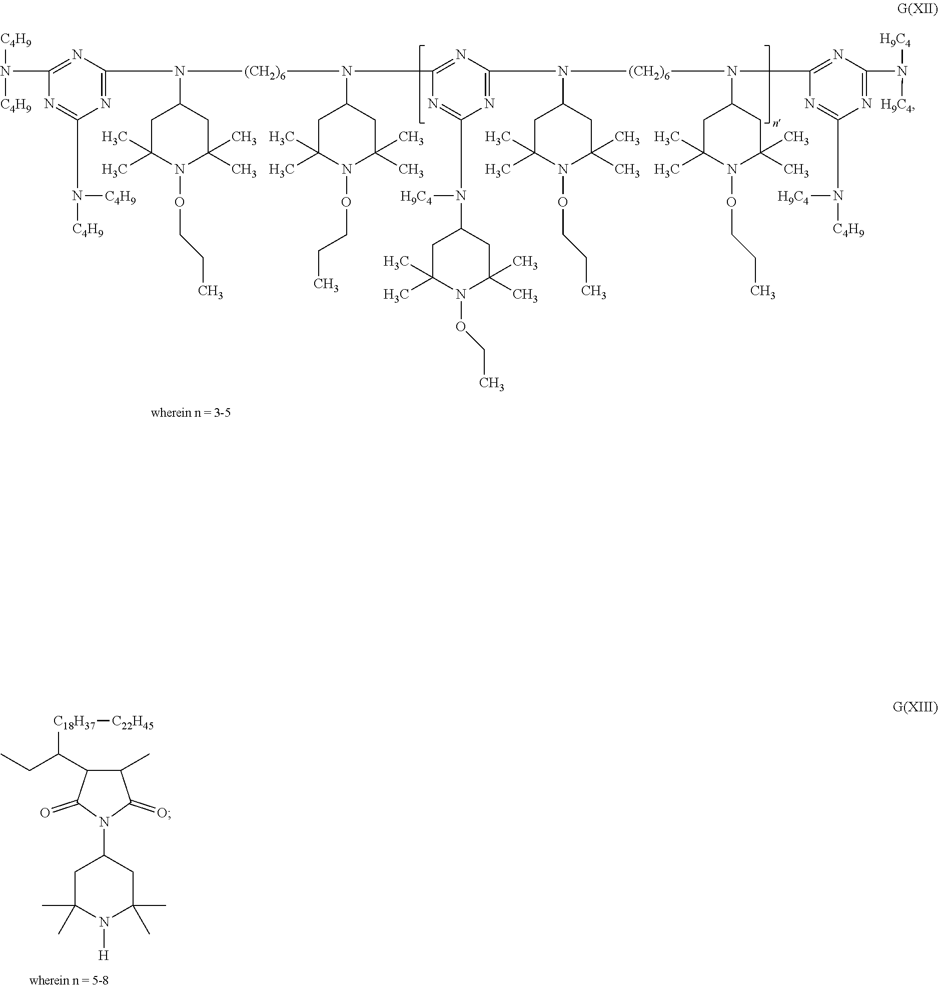

and mixtures thereof.

More preferably the stabilized hot melt adhesive composition further comprises at least one component (G) selected from the group consisting of;

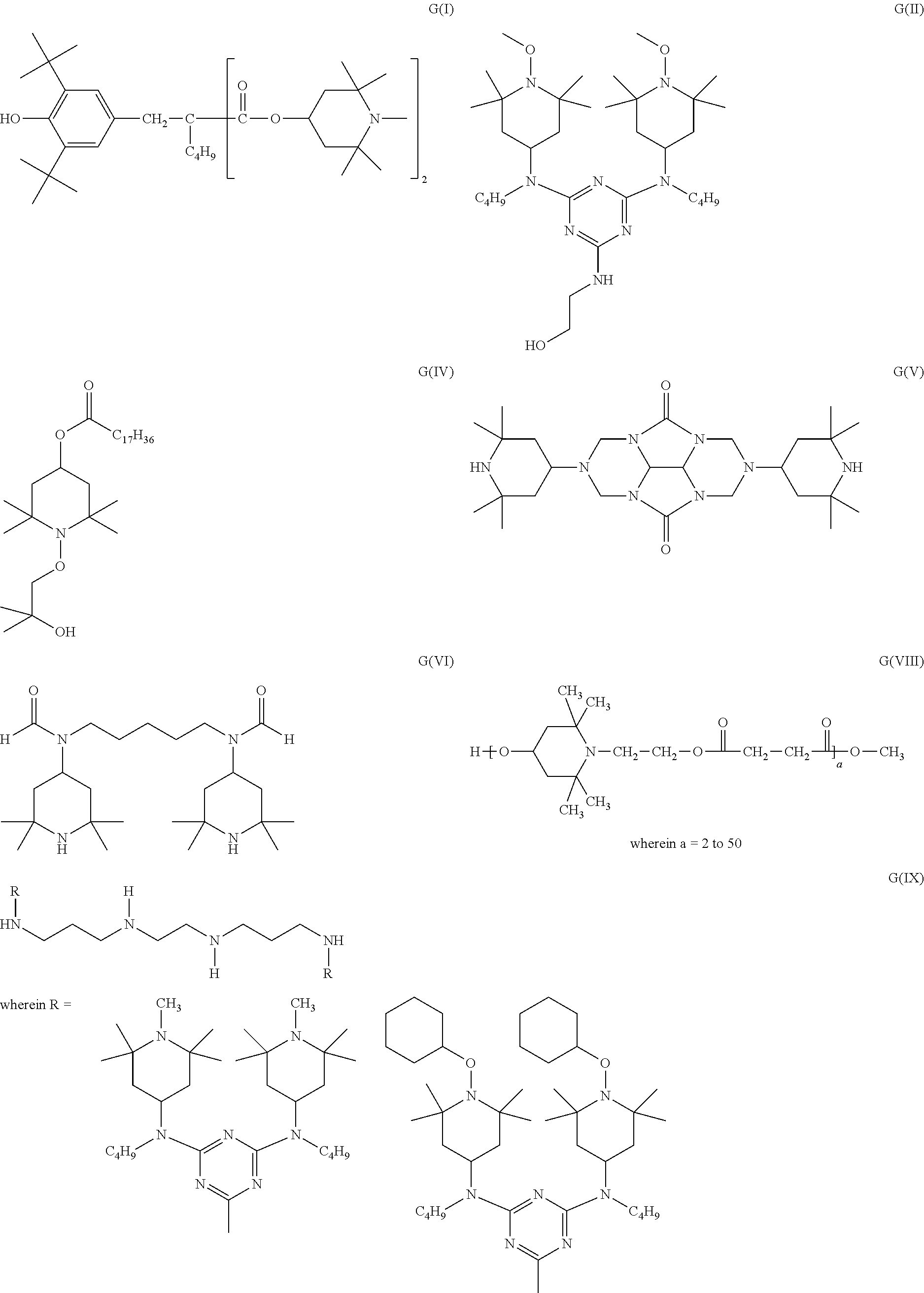

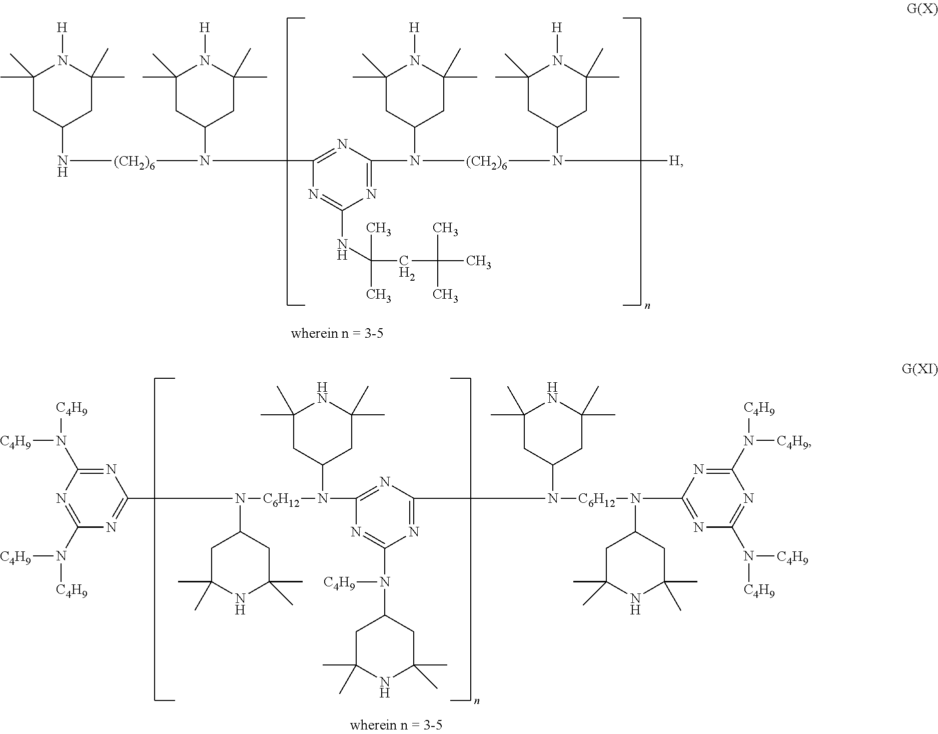

and mixtures thereof.

Most preferably the stabilized hot melt adhesive composition further comprises at least one component (G) selected from the group consisting of;

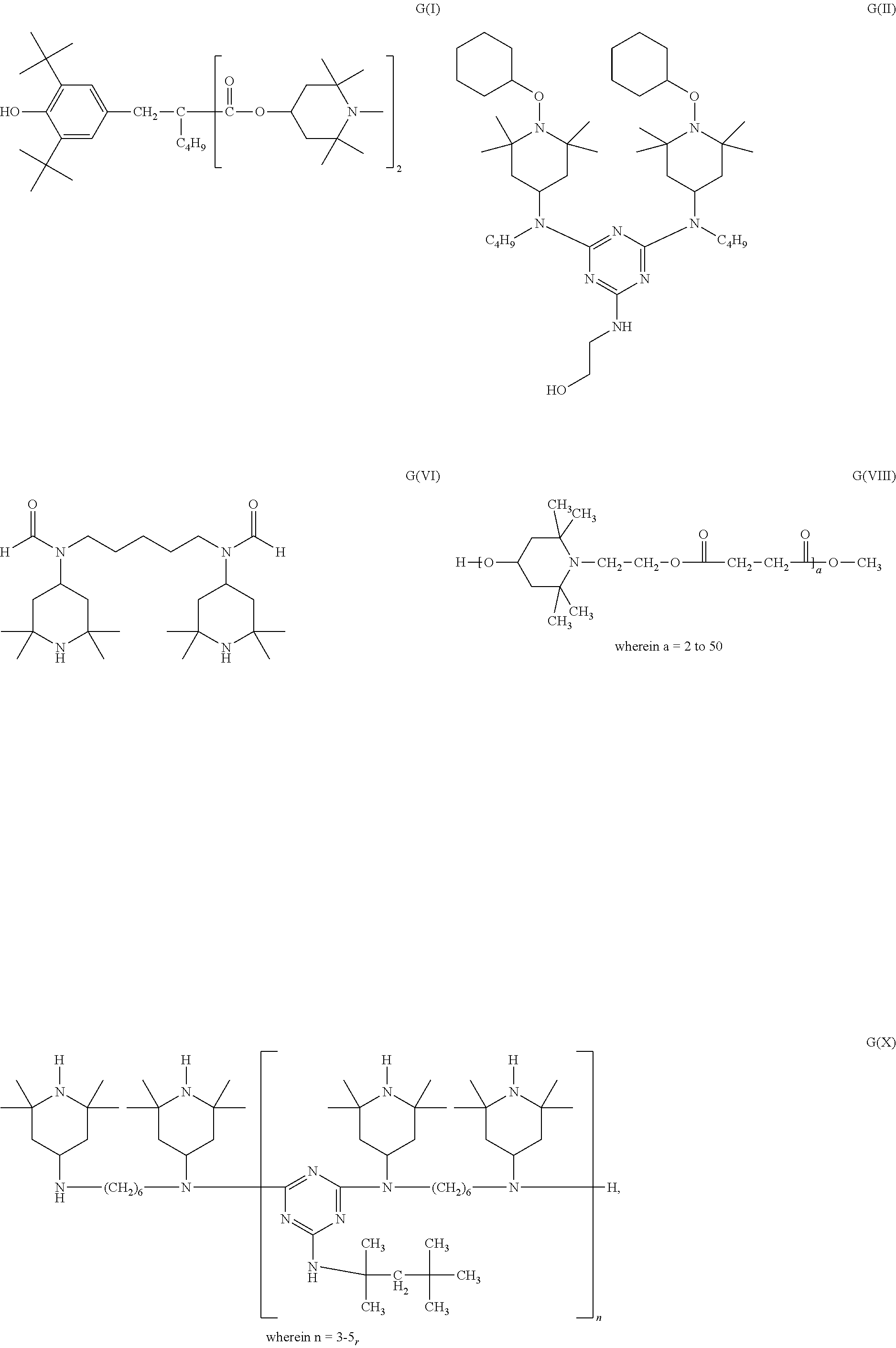

and mixtures thereof.

In another preferred embodiment, the stabilized hot melt adhesive composition according to presently claimed invention, wherein the hot melt adhesive materials are present in an amount in the range of 95 to 99 wt. % and the stabilizer composition (S) is present in amount in the range of 1 to 5 wt. %, each based on overall weight of the stabilized hot melt adhesive composition.

In another preferred embodiment, the stabilized hot melt adhesive composition further comprises one or more additives selected from the group consisting of secondary arylamine, hydroxylamine-based stabilizers, UV-absorber and inorganic stabilizer.

In another embodiment, presently claimed invention directed to a Method of stabilizing a hot melt adhesive against degradation by one or more of light, oxygen and heat, comprising the steps of:
a. providing one or more hot melt adhesive materials selected from the group consisting of natural rubber, synthetic rubber such as butyl rubber, ethylenepropylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymers, and mixture thereof; and
b. adding a composition (S) as defined above.

In another preferred embodiment, the method further comprises a step of providing at least one component (G) selected from the group consisting of;

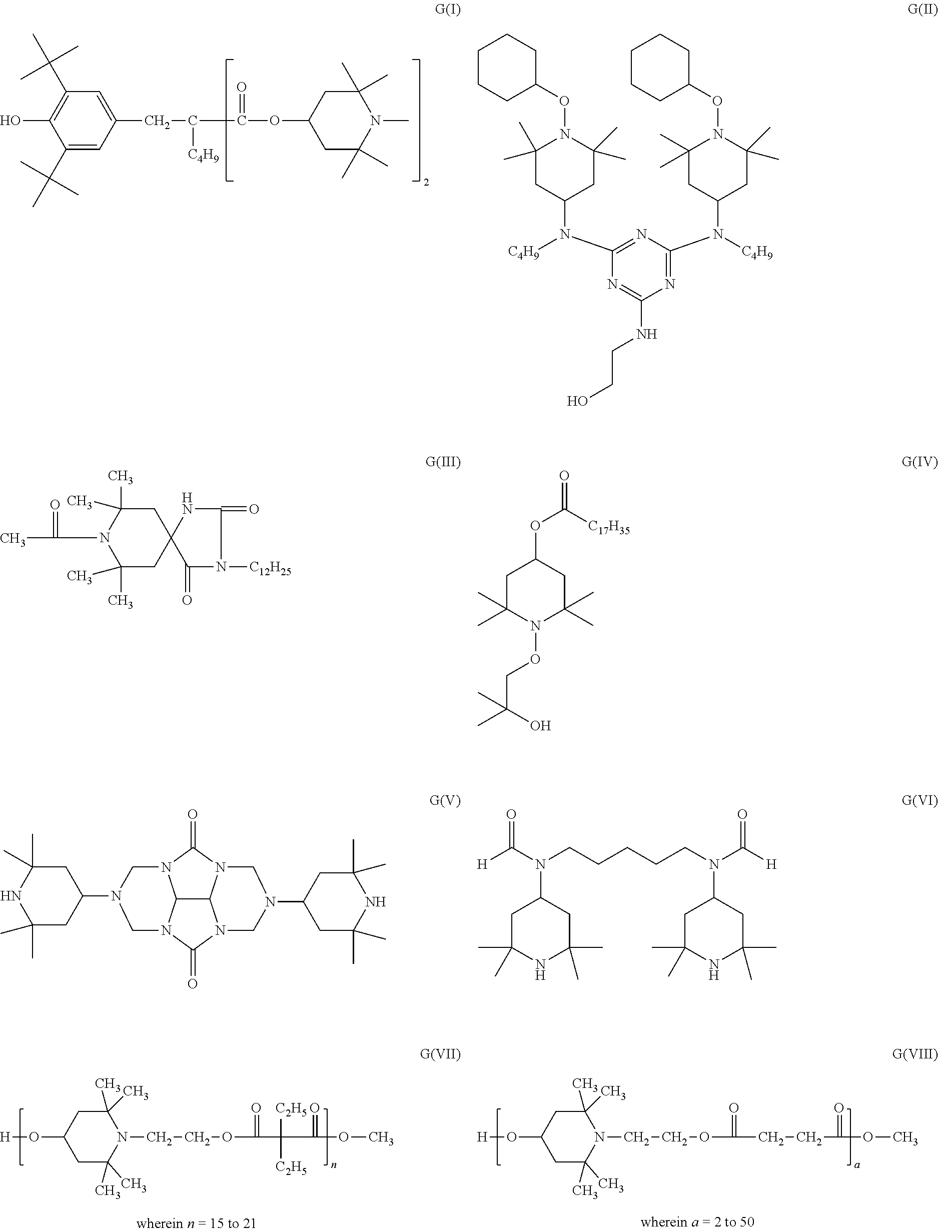

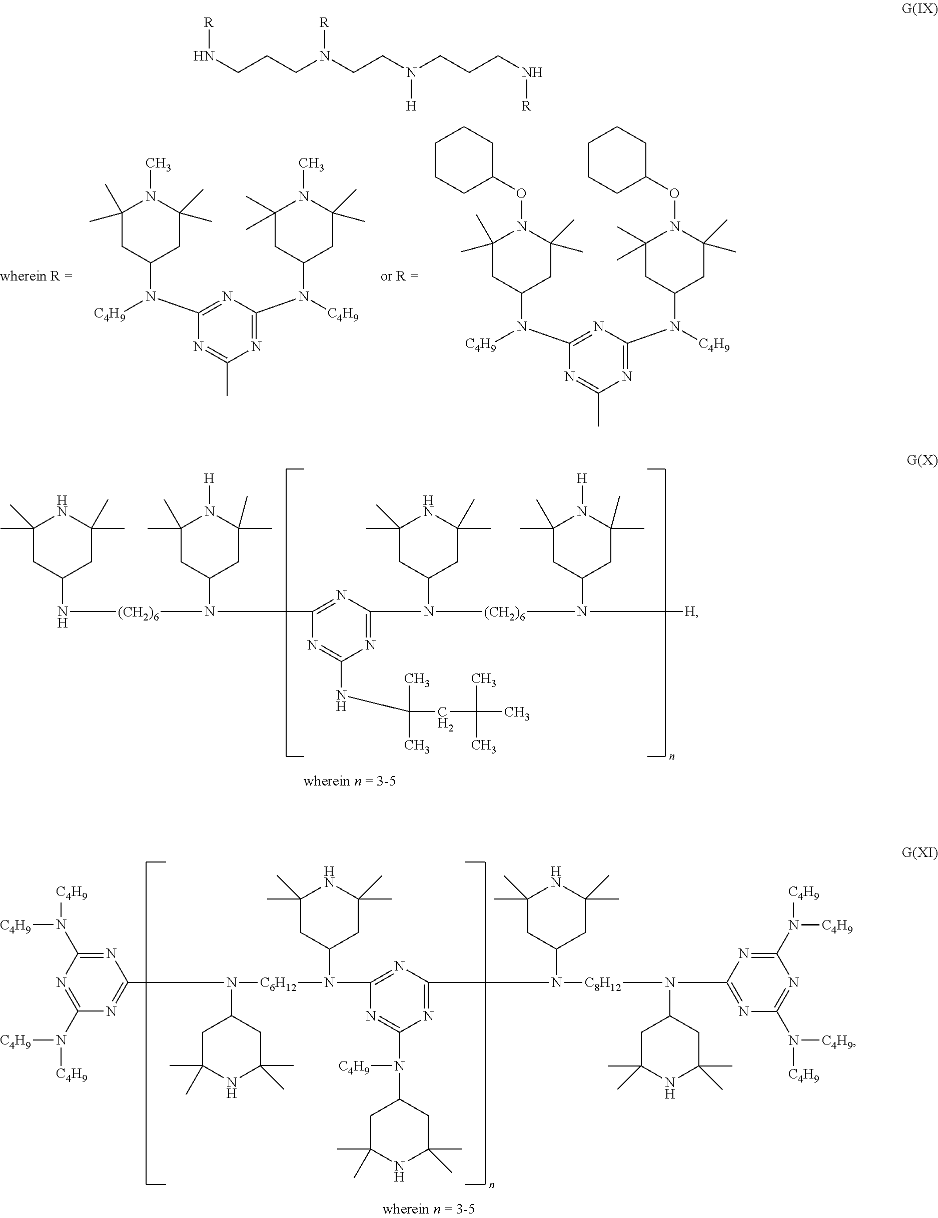

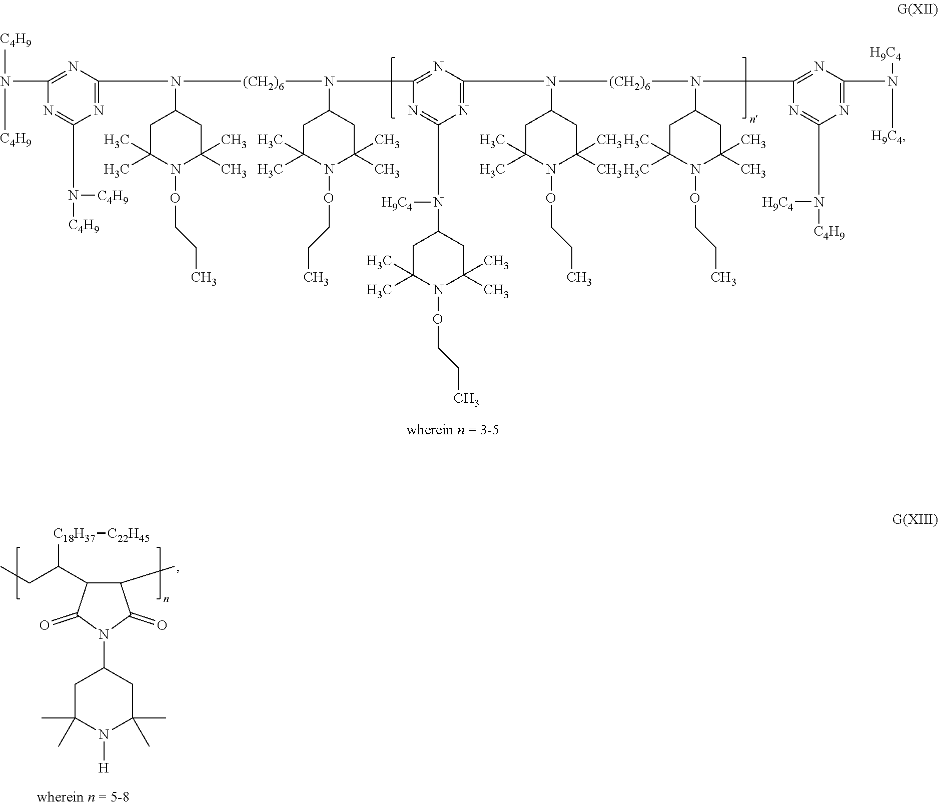

and mixtures thereof.

In another preferred embodiment, presently claimed invention is directed to the use of a composition (S) for stabilizing a hot melt adhesive, stabilizing sealants, and coatings (industrial coatings).

In another embodiment, presently claimed invention is directed to an aerosol composition comprising at least one stabilizer (B), wherein stabilizer (B) is as defined as above, more preferably the aerosol composition comprising at least one stabilizer (B) is selected from the group consisting of

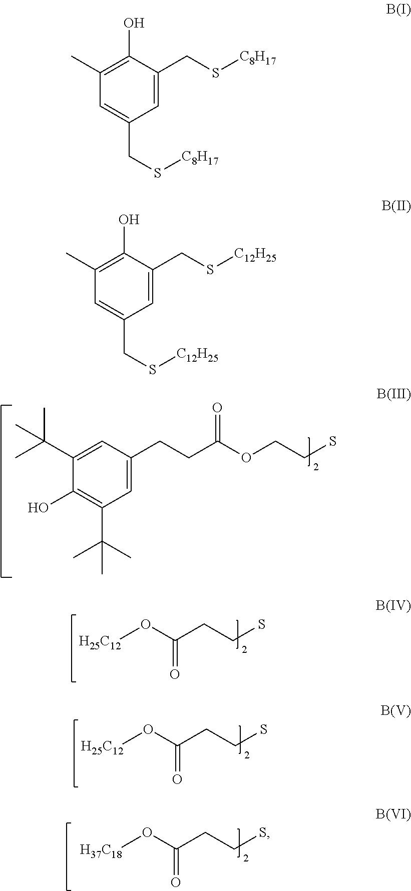

and mixtures thereof.

In another preferred embodiment, the aerosol composition comprises a dispersion medium, which is air under pressure. The pressure is in the range of 1 bar to 50 bar, more preferably the pressure is in the range of 1 bar to 30 bar, and most preferably the pressure is in the range of 1 bar to 10 bar.

The presently claimed invention is associated with at least one of the following advantages:
The stabilizer composition (S) according to presently claimed invention is obtained in the form of free-flowing powder and/or granules.
The stabilizer composition did not cake for more than 4 weeks which is stored at 100 mBar pressure at 40° C.
The stabilizer composition has storage stability of multiple weeks in the BASF accelerated test method which corresponds to greater than 1 year shelf life in the form of free-flowing powder and/or granules.
The composition (S) not only stabilized adhesive values but also increase adhesion values like shear cohesion in comparison to an alternatively stabilized HMA.
The composition (S) provides better balance between adhesive and cohesive properties in HMA.

### EMBODIMENTS

In the following, there is provided a list of embodiments to further illustrate the present disclosure without intending to limit the disclosure to the specific embodiments listed below.
1. A composition (S) comprising
   a. microfibrillar cellulose (A);
   b. at least one stabilizer compound (B) having at least one thioether functional group; and
   c. at least one component (C) selected from the group consisting of

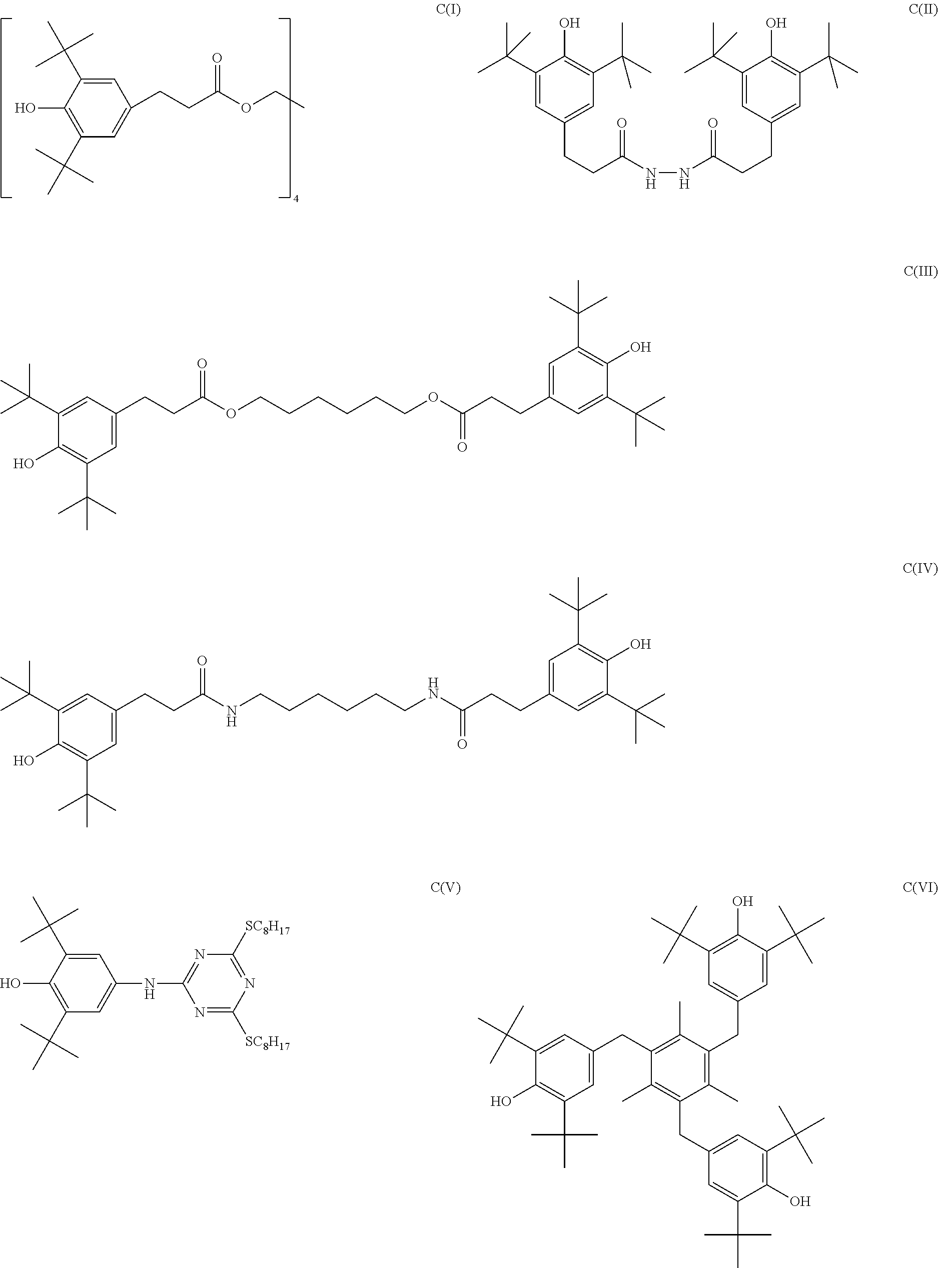

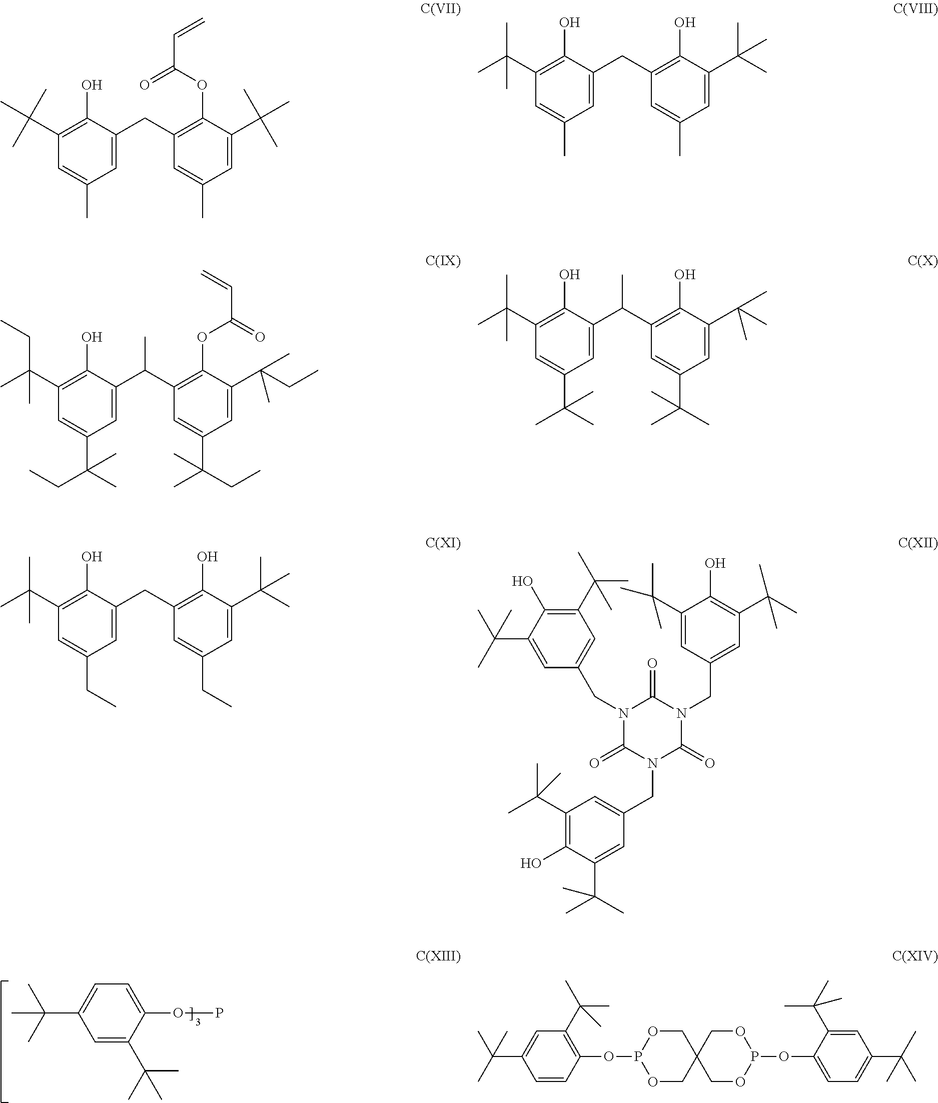

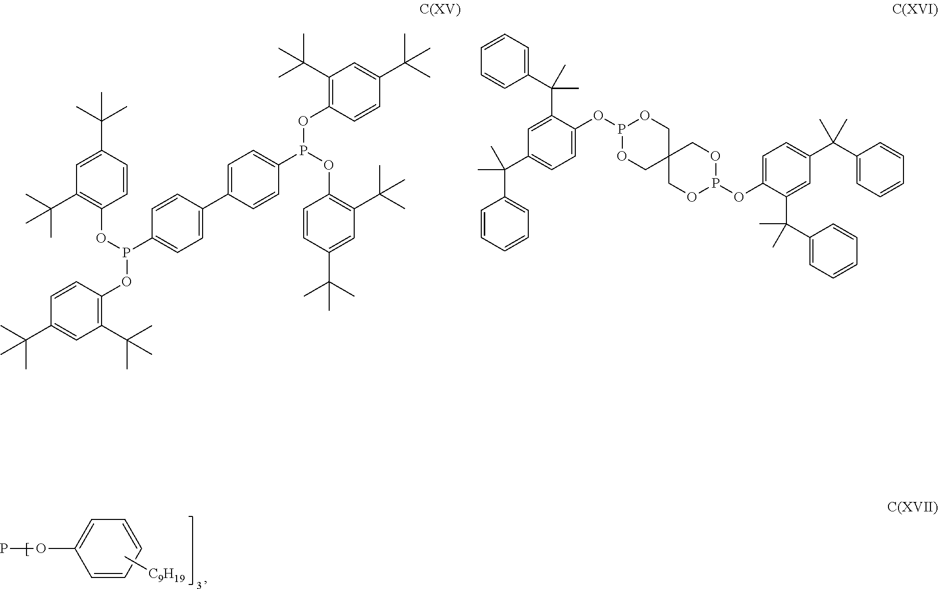

and mixture thereof,
wherein the at least one stabilizer compound (B) is absorbed on the microfibrillar cellulose (A) and the absorbed stabilizer compound (B) is at least partly coated with component (C).
2. The composition (S) according to embodiment 1 comprising
   a. microfibrillar celluose (A);
   b. at least one stabilizer (B) selected form the group consisting of

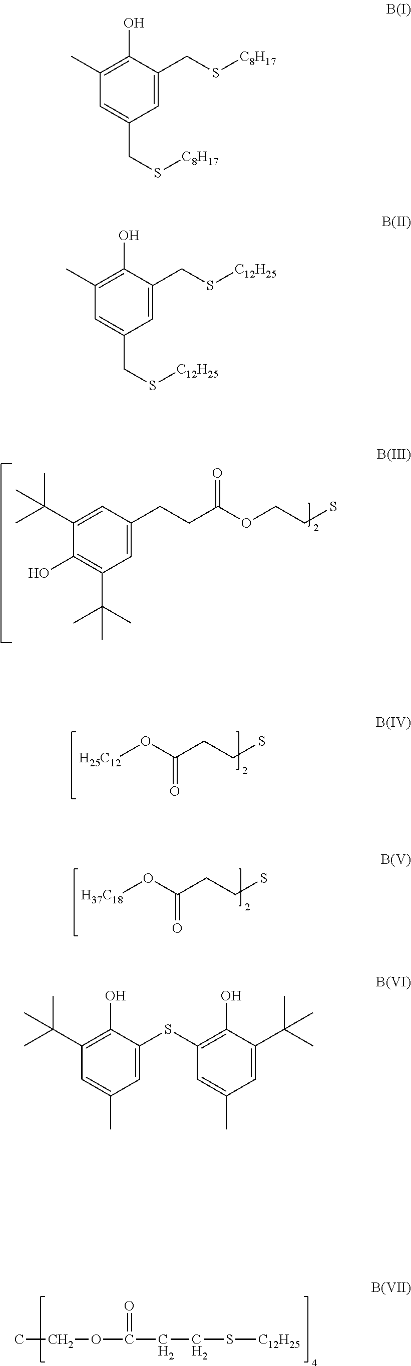

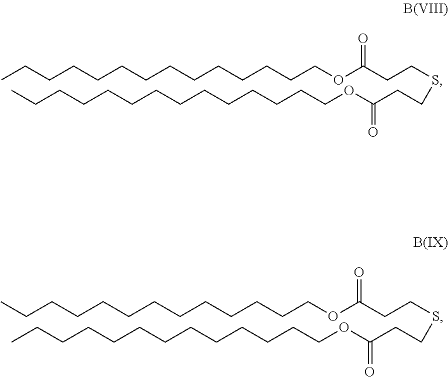 [SMILES: CCCCCCCCCCCCCCOC(=O)CCSCCC(=O)OCCCCCCCCCCCCCC ; CCCCCCCCCCCCCOC(=O)CCSCCC(=O)OCCCCCCCCCCCCC]

and mixture thereof, and
c. at least one component (C) selected from the group consisting of

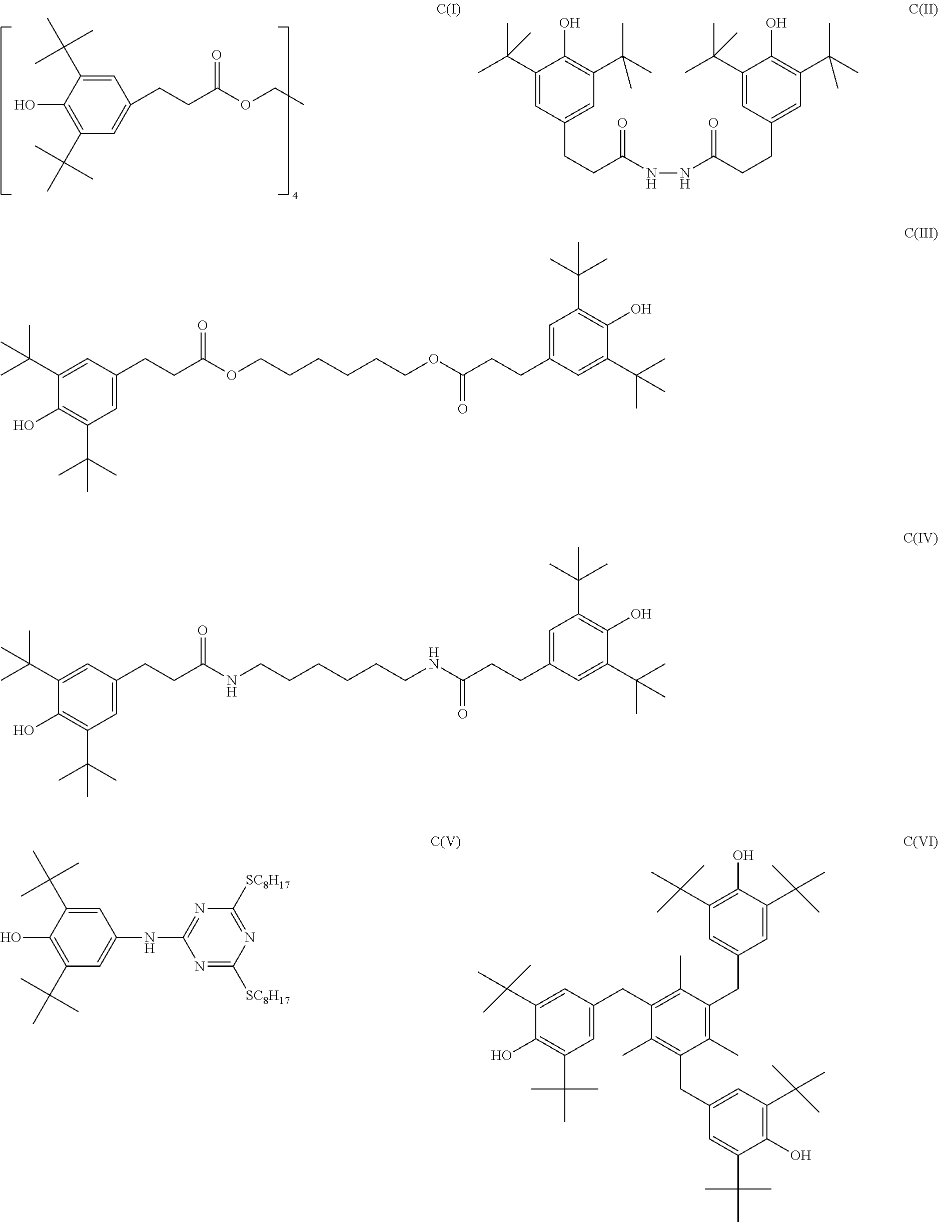

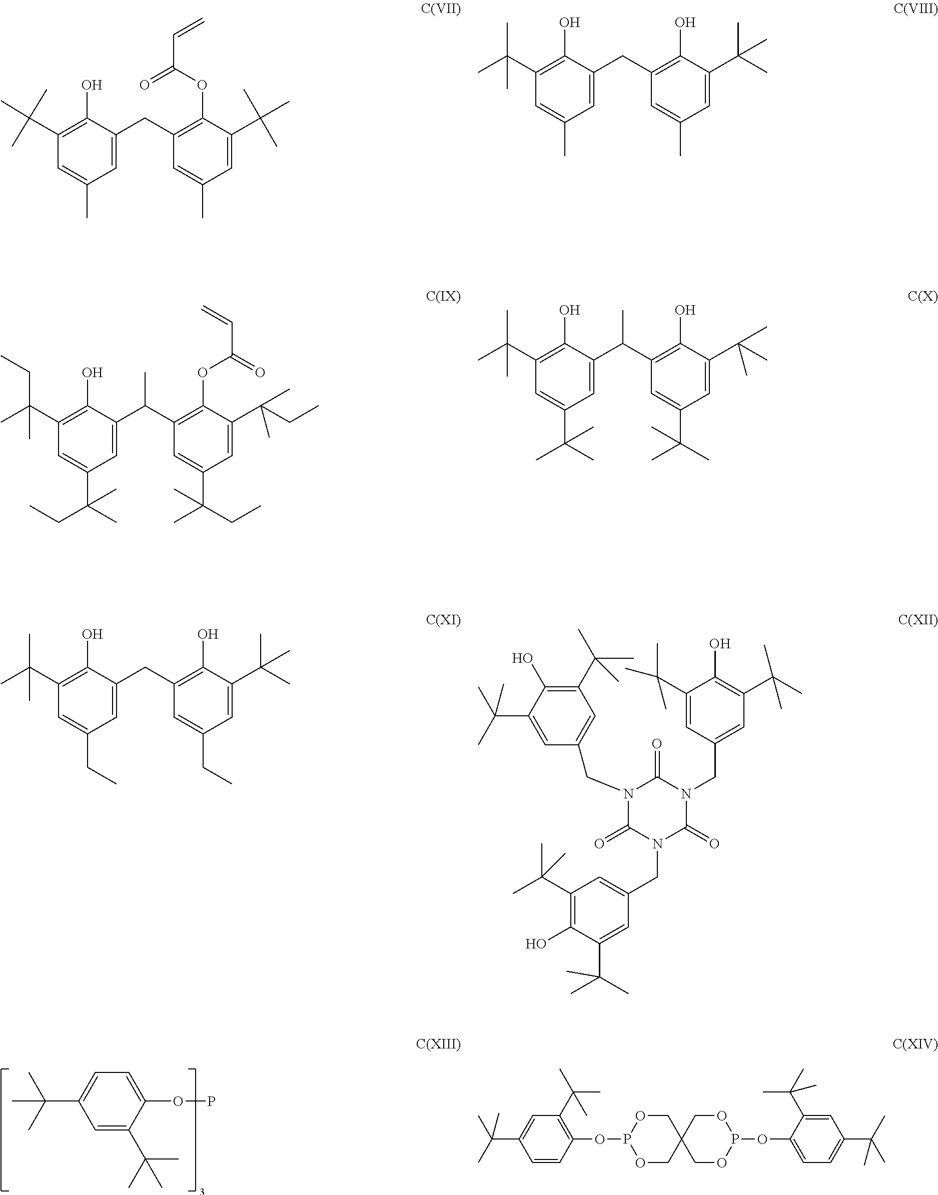

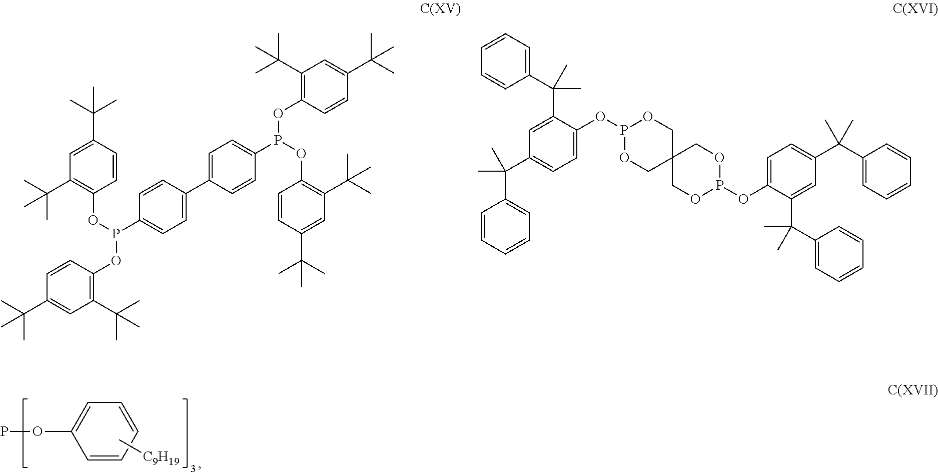

and mixture thereof,
wherein the at least one stabilizer (B) is absorbed on the microfibrillar cellulose (A) and wherein the absorbed stabilizer (B) is at least partly coated with component (C).
3. The composition (S) according to any one of the embodiments 1 to 2, wherein the microfibrillar cellulose has a length in the range of 10 to 500 μm.
4. The composition (S) according to any one of the embodiments 1 to 3, wherein the microfibrillar cellulose has a length in the range of 15 to 60 μm.
5. The composition (S) according to any one of the embodiments 1 to 4, wherein the microfibrillar cellulose has an aspect ratio in the range of 1:1 to 1:6.
6. The composition (S) according to embodiment 5, wherein the microfibrillar cellulose has an aspect ratio in the range of 1:2 to 1:4.
7. The composition (S) according to any one of the embodiments 1 to 6, wherein the at least one stabilizer (B) is B(II).
8. The composition (S) according to anyone of the embodiment 1 to 7, wherein the weight ratio of at least one stabilizer (B) to the microfibrillar cellulose (A) is in the range of 1:10 to 10:1.
9. The composition (S) according to embodiment 8, wherein the total weight ratio of at least one stabilizer (B) to the microfibrillar cellulose (A) is 1.0:1.0.
10. The composition (S) according to any one of the embodiments 1 to 9, wherein the composition comprises at least two components (C) selected from group consisting of C(I) to C(XVII) as defined in embodiment 1 or 2.
11. The composition (S) according to any one of the embodiments 1 to 10 wherein the at least one component (C) is selected from group consisting of C(I) and C(XIII).
12. The composition (S) according to anyone of the embodiment 1 or 2 or 11, wherein the total weight ratio of at least one component (C) to the microfibrillar cellulose (A) is in the range of 1:10 to 10:1.
13. The composition (S) according to embodiment 12, wherein the total weight ratio of at least one component (C) to the microfibrillar cellulose (A) is 1.0:2.0.
14. The composition (S) according to anyone of the embodiments 1 to 13, wherein the total weight ratio of at least one stabilizer (B) to the at least one component (C) is in the range of 1:10 to 10:1.
15. The composition (S) according to embodiment 14, wherein the total weight ratio of at least one stabilizer (B) to the at least one component (C) is 1.0:2.0.
16. The composition (S) according to anyone of the embodiments 1 to 15 wherein the microfibrillar cellulose (A) is present in an amount in the range of 10 to 40 wt. % based on overall weight of the composition.
17. The composition (S) according to anyone of the embodiments 1 to 15 wherein the stabilizer (B) is present in a total amount in the range of 10 to 40 wt. % based on overall weight of the composition.
18. The composition (S) according to anyone of the embodiments 1 to 17 wherein the component (C) is present in a total amount in the range of 20 to 80 wt. % based on overall weight of the composition.
19. The composition (S) according to anyone of the embodiments 1 to 18, wherein the composition has a mol weight ratio of primary to secondary antioxidant functionality of 1-10 mol % primary antioxidant functionality to 1-10 mol % secondary anti-oxidant functionality.
20. The composition (S) according to embodiment 19, the composition has a mol weight ratio of primary to secondary antioxidant functionality of 1-4 mol % primary anti-oxidant functionality to 2-5 mol % secondary antioxidant functionality.
21. The composition (S) according to embodiment 20, the composition has a mol weight ratio of primary to secondary antioxidant functionality of 3-4 mol % primary anti-oxidant functionality to 2-3 mol % secondary antioxidant functionality.
22. The composition (S) according to anyone of the embodiments 1 to 21 further comprises at least one component (D) selected from the group consisting of

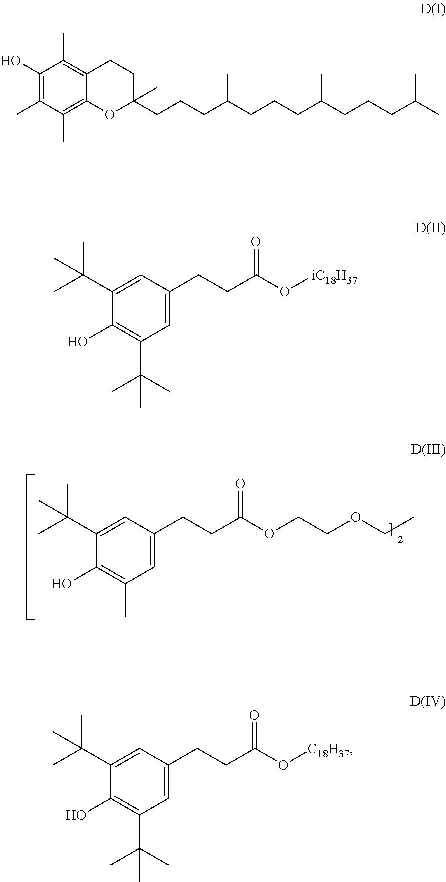

and mixture thereof.
23. The composition (S) according to anyone of the embodiments 1 to 22, wherein component (D) is present in a total amount in the range of 0 to 60 wt. % based on weight of the stabilizer (B).
24. The composition (S) according to anyone of the embodiments 1 to 23 further comprises at least one component selected from the group consisting of (E), (F) and mixtures thereof,
wherein the component (E) is selected from the group consisting of

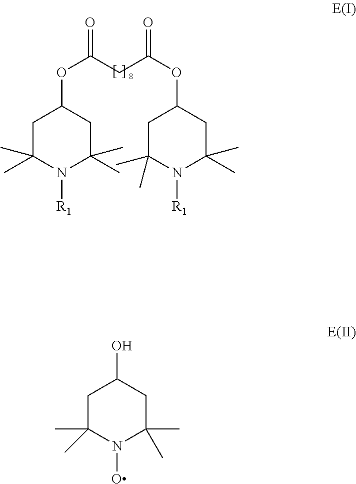

wherein R₁ is independently selected from the group consisting of H, CH₃ and OC₈H₁₇;

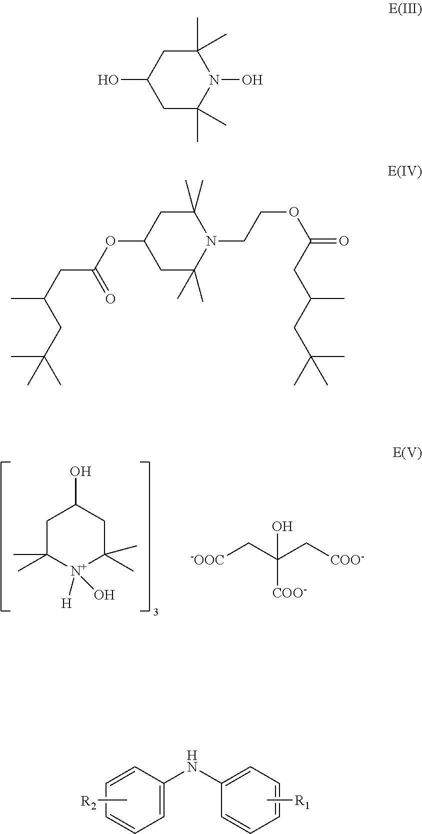

R1 and R2 independently selected form H, or C1-C20 alkyl,

E(VI),
and mixture thereof, and (F) is a polyalkylenimine polymer (F).
25. The composition (S) according to embodiment 24 wherein the polyalkylenimine polymer (F) has weight average molecular weight in the range of 500 to 50000 g/mol as determined according to GPC using THF as solvent.
26. The composition (S) according to embodiment 25 wherein the polyalkylenimine polymer (F) has weight average molecular weight in the range of 20000 to 40000 g/mol as determined according to GPC using THF as solvent.
27. The composition (S) according to any one of the embodiments 1 to 26, wherein the polyalkylenimine polymer (F) is a branched polyalkyleneimine.
28. The composition (S) according to any one of the embodiments 1 to 27, wherein the component (E) is present in a total amount in the range of 0 to 10 wt. % based on overall weight of the composition.
29. The composition (S) according to embodiment 28 wherein the component (E) is present in a total amount in the range of 2 to 8 wt. % based on overall weight of the composition.
30. The composition (S) according to any one of the embodiments 1 to 29, wherein the polyethyleneimine polymer (F) is present in a total amount in the range of 0 to 10 wt. % based on overall weight of the composition.
31. The composition (S) according to embodiment 30 wherein the polyethyleneimine polymer (F) is present in an amount in the range of 2 to 8 wt. % based on overall weight of the composition.
32. The composition (S) according to any one of the embodiments 1 to 31, wherein at least 50% of the composition has a particle size in the range of 100 to 5000 μm as determined according to ASTM D4513-11.
33. The composition (S) according to any one of the embodiments 1 to 32, wherein at least 85% of the composition has a particle size in the range of 500 to 2000 μm as determined according to ASTM D4513-11.
34. A process for the preparation of a stabilizer composition (S) comprising the steps of:
   a. providing the microfibrillar cellulose (A);
   b. providing at least one component (C) to obtain a mixture of component (A) and at least one component (C); and
   c. dispensing at least one stabilizer (B) to the mixture obtained in step b. to obtain a ternary mixture,
   e. mixing the ternary mixture obtained step c to obtain the homogenous composition,
      wherein component (A), stabilizer (B) and component (C) are as defined as above.
35. The process according to embodiments 32, wherein the process further comprises a step of:
   d. providing at least one component (D) and/or at least one component (E) and/or polyethyleneimine polymer (F),
      wherein component (D), component (E), polyethyleneimine polymer (F) are as defined as above.
36. The process according to any one of the embodiments 34 to 35, wherein the stabilizer (B) is maintained at a temperature in the range of 20 to 150° C.
37. The process according to embodiment 36, wherein the stabilizer (B) is maintained at a temperature in the range of 60 to 120° C.
38. The process according to any one of the embodiments 34 to 37, wherein the stabilizer (B) is dispensed as liquid or via a single-phased nozzle or two-phased nozzle as an aerosol composition.
39. The process according to embodiments 38, wherein the stabilizer (B) is dispensed via a single-phased nozzle or two-phased nozzle as an aerosol composition.
40. The process according to any one of the embodiments 34 to 39, wherein in the step e. the mixing has a Froude number in the range of 1 to 5000 based on the diameter and/or the shape of the reactor.
41. The process according to embodiment 40, wherein in step d. the mixing rpm is in the range of 900 to 5000.
42. The process according to embodiments 40 to 41, wherein in step d. the mixing time is in the range of 10 to 30 min.
43. A stabilized hot melt adhesive composition comprising:
   i. At least one hot melt adhesive materials selected from the group consisting of natural rubber, synthetic rubber such as butyl rubber, ethylene-propylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymers, and mixture thereof; and
   ii. a composition (S) according to anyone of the embodiments 1 to 33.
44. The stabilized hot melt adhesive composition according to claim 43 further comprises at least one component (G) selected from the group consisting of;

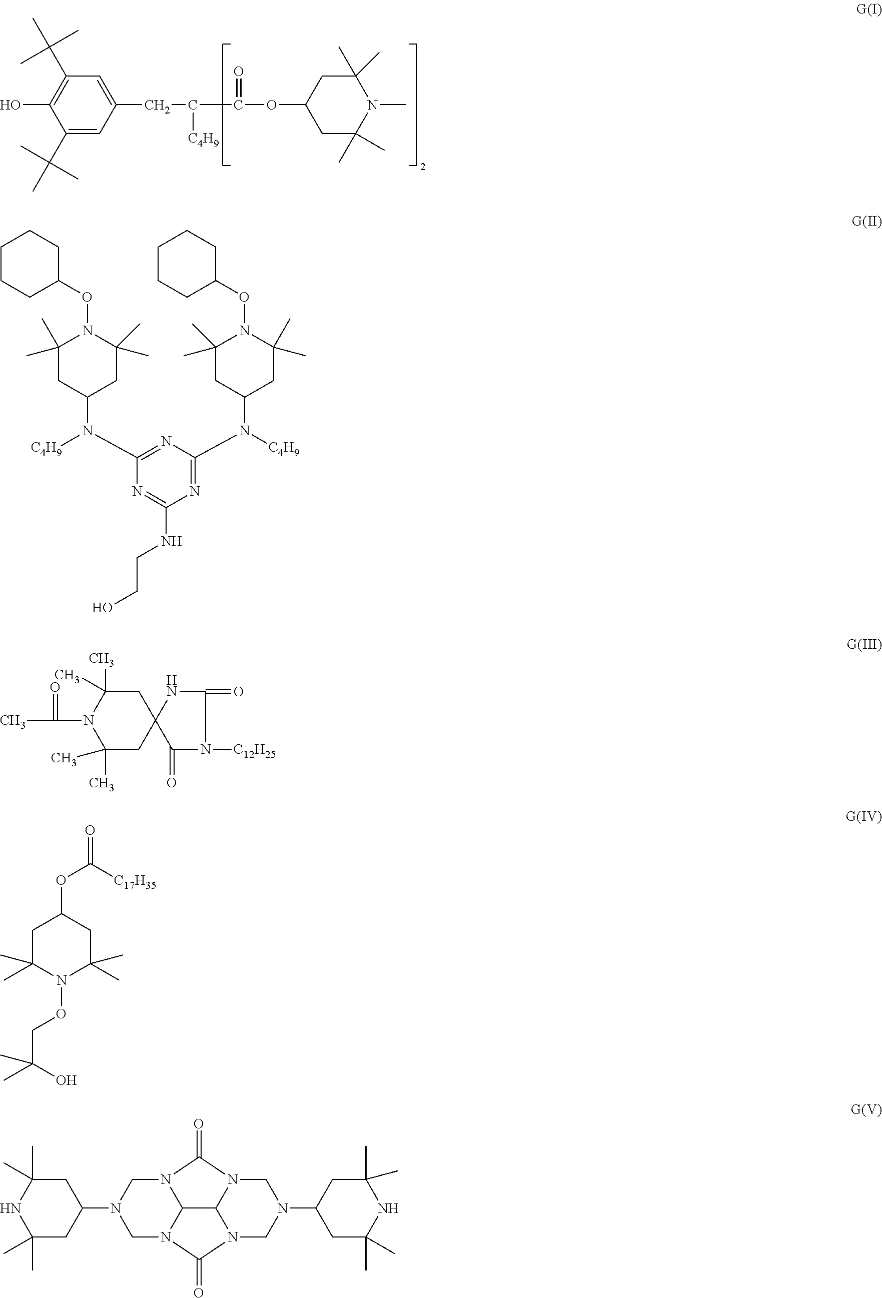

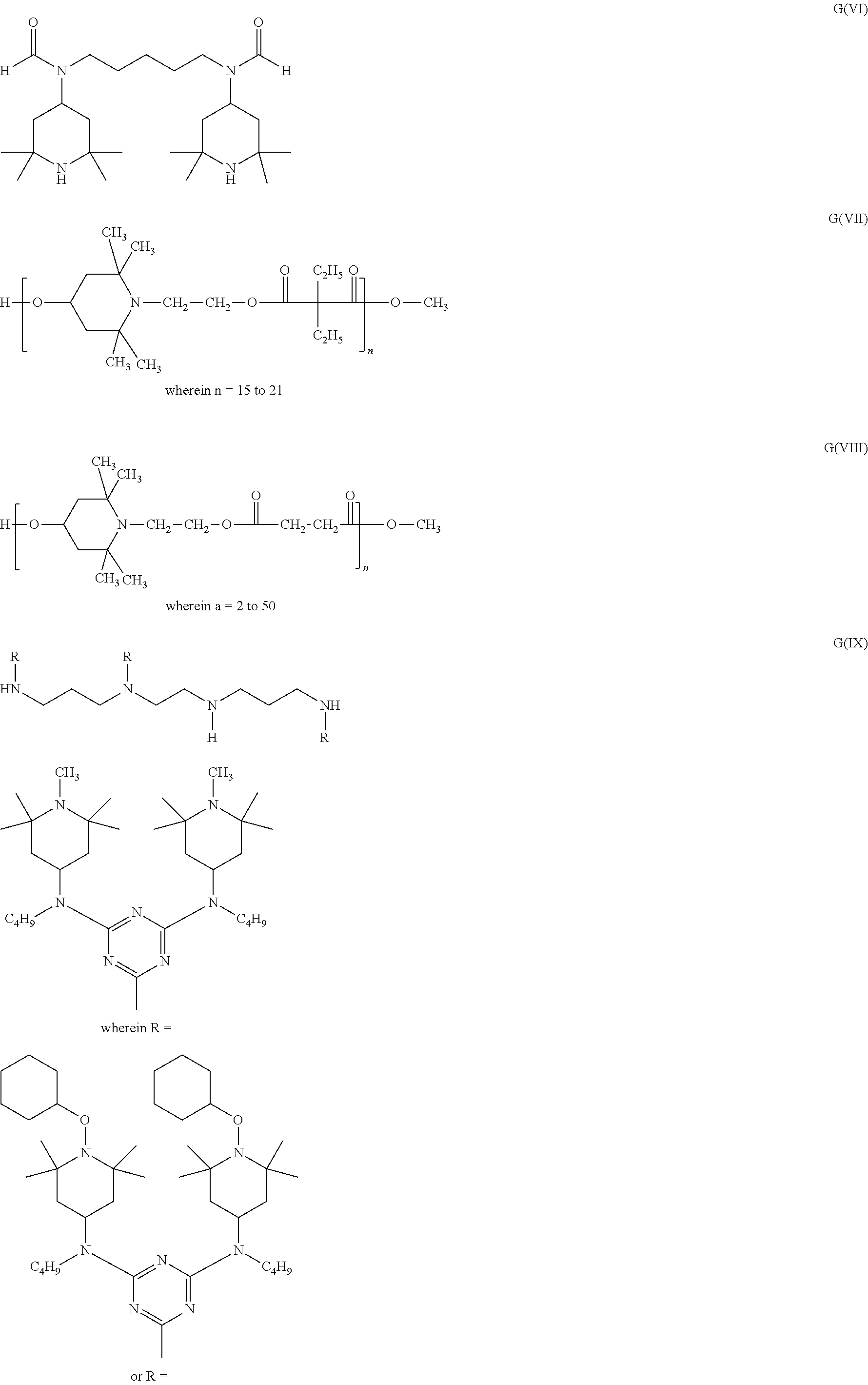

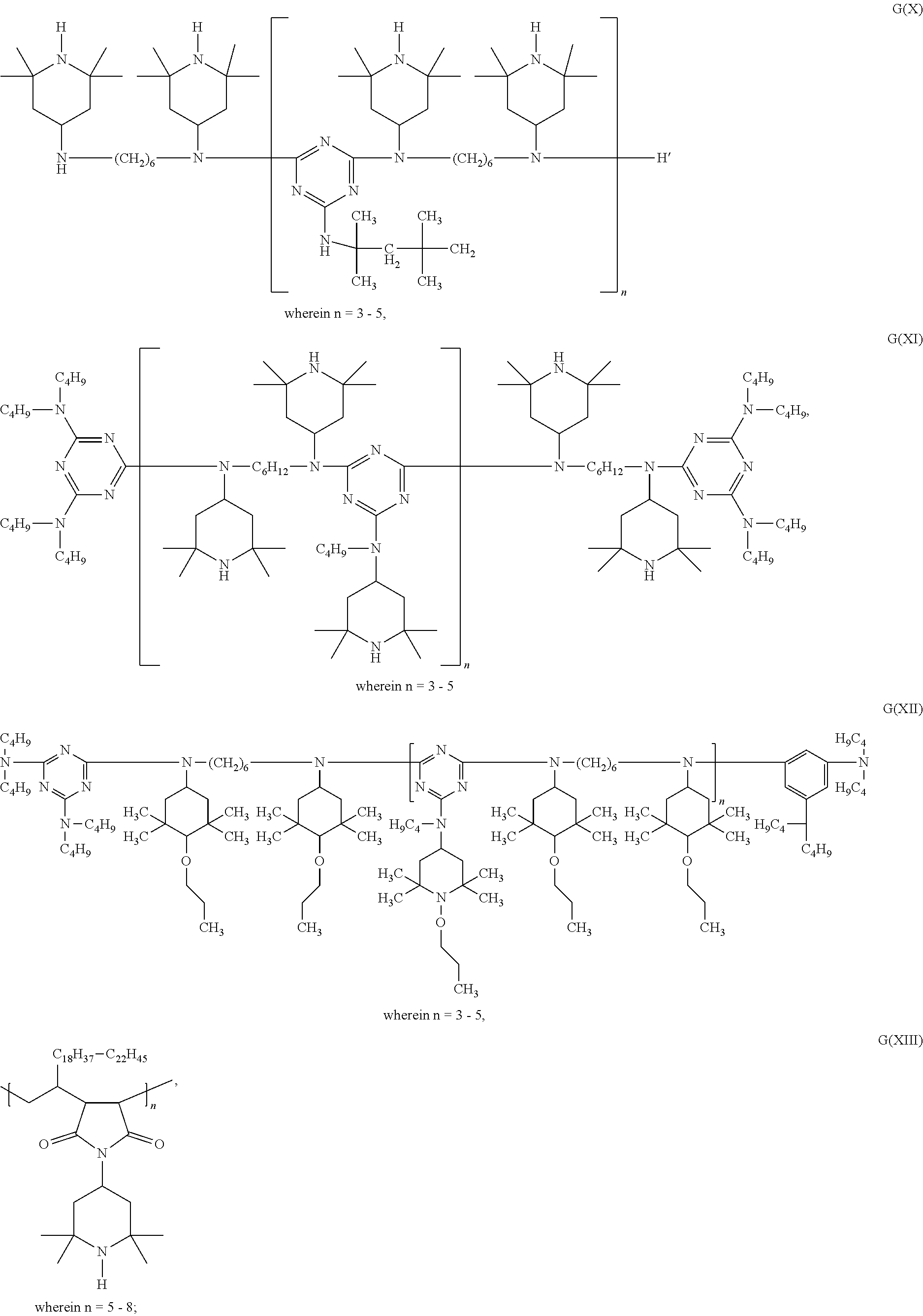

and mixture thereof.
45. The stabilized hot melt adhesive composition according to anyone of the embodiments 43 to 43, wherein the hot melt adhesive materials is present in an amount in the range of 95 to 99 wt. % and the stabilizer composition is present in amount in the range of 1 to 5 wt. %, each based on overall weight of the stabilized hot melt adhesive composition.
46 The stabilized hot melt adhesive composition according to anyone of the embodiments 43 to 45, wherein the stabilized hot melt adhesive composition further comprises one or more additives selected from the group consisting of: secondary arylamine, hydroxylamine-based stabilizers, UV-absorber and inorganic stabilizer.
47. A Method of stabilizing a hot melt adhesive against degradation by one or more of light, oxygen and heat, comprising the steps of:
   a. providing one or more hot melt adhesive materials selected from the group consisting of natural rubber, synthetic rubber such as butyl rubber, ethylenepropylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymers, and mixture thereof; and
   b. adding a composition (S) as defined in one or more of embodiments 1 to 32.
48. The method according to embodiment 47, wherein the method further comprises a step of
   c. providing at least one component (G) as defined in embodiment 44.
49. Use of a composition according to any one of the embodiments 1 to 32, for stabilizing a hot melt adhesive, stabilizing sealants, and coatings (industrial coatings).

### EXAMPLES

The presently claimed invention is illustrated in detail by non-restrictive working examples which follow. More particularly, the test methods specified hereinafter are part of the general disclosure of the application and are not restricted to the specific working examples.

Example 1-2 describes the production of spray granulates in accordance with the invention.

Example 3-4 are comparative Examples.

Example 5 relates to the production of the Irgastab 5170.

### Materials and Method

Irganox 1726 (4,6-bis(dodecylthiomethyl)-o-cresol is available from BASF SE.
Irganox 1035 (Thiodiethylene bis[3-[3,5-di-tert-butyl-4-hydroxyphenyl]propionate]) is available from BASF SE
Irganox 1010 (Pentaerythritol tetrakis[3-[3,5-di-tert-butyl-4-hydroxyphenyl]propionate) is available from BASF SE
Irgafos 168 (Tris(2,4-di-tert-Butylphenyl)phosphite) is available from BASF SE
Abrocel B 600 (microfibrillar cellulose) is available from J. RETTENMAIER & SÖHNE GmbH+Co KG
Arbocel BE 600-30 is available from J. RETTENMAIER & SÖHNE GmbH+Co KG D62779 Pressure Sensitive Adhesive available from Bühnen
Sylavalite 85 L (stabilized polyol ester of rosin based tackifier) from Arizona Chemicals
Lignostab 1198L (4-Hydroxy-2,2,6,6-tetramethyl-1-piperidinyloxyl) from BASF SE—this component was pre-deposited onto the microfibrillar cellulose before contact with at least one stabilizer compound (B) having at least one thioether functional group (for instance Irganox as mentioned in examples below).
Loxanol MI 6730 (a cationic polymer based on polyethylene imine having molar mass ˜750,000 g/mol (GPC), viscosity of ˜25,000 mPa·s (ISO 2555 Brookfield), concentration of ˜50% (ISO 3251) and density of ˜1.09 g/cm3 (ISO 51757 @20° C.) from BASF SE—this component was pre-deposited onto the microfibrillar cellulose by well-known methods such as before contact with at least one stabilizer compound (B) having at least one thioether functional group (for instance Irganox as mentioned in examples below).

### Example 1-2 (V7, V12)

The first example was conducted with the liquid phase consisting of 0.29 kg of Irganox 1726 melted at 40° C., and the powder bed of 0.812 kg of Irganox 1010 and 0.304 kg of Abrocel B 600 at room temperature. A target ratio of 1:2:1 was used. A Schlick two-phase spray head was used to dispense the liquid phase into the powder bed of an Eirich Intensive mixer, which was used to shear the product while mixing it. At dispersion speed of 18.1 g/min, the Schlick two-phase spray head provided fine atomized spray particles to the mixture. The mixture was allowed to shear for approximately 20 min.

The second example had in the liquid phase 0.29 kg of Irganox 1726 melted at 40° C., and the powder bed of 0.784 kg of Irganox 1010 and 0.329 kg of Abrocel BE 600-30 at room temperature. A target ratio of 1:2:1 was used. A Schlick two-phase spray head was used to dispense the liquid phase into the powder bed of an Eirich Intensive mixer, which was used to shear the product while mixing it. At dispersion speed of 124.3 g/min, the Schlick two-phase spray head provided fine atomized spray particles to the mixture. The mixture was allowed to shear for approximately 10 min.

This combination of equipment provides the most consistent and desirable product for commercial applications.

### Comparative Example 3-4 (V1, V2)

In Example 3, the liquid phase consisting of 0.22 kg of Irganox 1726 was melted at 100° C., and the powder bed consisted of 0.615 kg of Irganox 1010 and 0.230 kg of Abrocel B 600 at room temperature. A target ratio of 1:2:1 was used. A Schlick two-phase spray head was used to dispense the liquid phase into the powder bed of a Lödige Ploughshare mixer, which was used to shear the product while mixing it. At dispersion speed of 36.7 g/min, the Schlick two-phase spray head provided fine atomized spray particles to the mixture. The mixture was mixed for approximately 20 min. A powdery mixture with clumps were observed.

Based on Example 3, the recipe was modified by replacing the solid phase with more liquid phase, with the liquid phase consisting of 0.22 kg of Irganox 1726 and 0.258 kg of Irganox 1035 melted at 100° C., and the powder bed of 0.308 kg of Irganox 1010 and 0.230 kg of Abrocel B 600 at room temperature. The target ratio was 1:1:1:1. A Schlick two-phase spray head was used to dispense the liquid phase into the powder bed of a Lödige Ploughshare mixer, which was used to shear the product while mixing it. At dispersion speed of 12.9 g/min, the Schlick two-phase spray head provided fine atomized spray particles to the mixture. The mixture was mixed for approximately 50 min. The addition of a higher fraction of melted materials yielded large pasty clumps with no flowable powder nor granules observed.

### Example 5

The starting materials in this example were 2 kg of Irganox 1726 and 6 kg of Irganox 1035 melted at 90° C., and the powder bed consisting of 28 kg of Irganox 1035 and 4 kg of Irgafos 168. The target ratio was 1:17:3 for Irganox 1726:Irganox 1035:Irgafos 168. A Schlick single-phase spray head was used to dispense the liquid phase into the powder bed of a Lödige ploughshare mixer while the product was mixed. At dispersion speed of 1.4 kg/min, the Schlick single-phase spray head dispensed atomized spray particles into the mixture. The mixture was mixed for approximately 10 min. Clumps were observed and there was inconsistency in the powdery mixture.

TABLE 1
Classification of particles according to sizes by weight %.

| Example | <500 μm | 500-2000 μm | >2000 μm |
|---|---|---|---|
| V7 (Ex. 1) | 4.3 | 78.3 | 17.4 |
| V12 (Ex. 2) | 19.6 | 77.6 | 2.8 |
| V1 (Ex. 3) | 49.6 | 48.8 | 1.5 |
| 5170 (Ex. 5) | 50.6 | 32.3 | 17.1 |

The product of the presently claimed invention were tested for their storge stability at 100 mBar pressure at 40° C. versus composition without microfibrillar cellulose. It was observed that the composition without microfibrillar cellulose was sticky (caked) within one week of the storage while the products of the presently claimed invention were free flowing granules even after 5 weeks. The products of the presently claimed invention displayed remarkable stability at accelerated test conditions.

### Stability Test: Pressure Storage Test:

7.5 gr of the dry product is weight into an aluminum dish with a diameter of 5 cm and a weight with 3 cm diameter and 250 gr is placed on the product. The aluminum dish is placed in an oven held at 40° C. in controlled laboratory atmosphere of 21° C. and 50% rel. hum. After defined periods of time the weight is removed and observed how much of the product is baked to the bottom of the weight and rated according to the following index.

TABLE 2
Index Rating Explanation

| Rating | |
|---|---|
| 0 | No agglomeration |
| 1 | Little agglomeration, agglomerates fall easily apart |
| 2 | Agglomerates can be broken by hand (soft pressure) |
| 3 | Strong agglomeration |

TABLE 3
Storage Test Results

| | Appearance | | | | |
|---|---|---|---|---|---|
| Example | (aspect) | 1 Day | 7 Days | 14 Days | 38 Days |
| V7 (Ex. 1) | Round | 0 | 0 | 0 | ND |
| | Particles | | | | |
| V1 (Ex. 3) | Round | 0 | 0 | 0 | 0 |
| | Particles | | | | |
| 5170 (Ex. 5) | Irregular | 1 | 2 | 2 | 2 |
| | shaped | | | | |
| | Particle | | | | |

ND—not determined.

Tests are performed according to ASTM D 4499 (DIN EN ISO 10363). Results are given in Gardner color number index acc. ASTM D 6166 (Table 4). Higher numbers mean higher color, i.e. higher oxidation. The effectiveness of a stabilizer package can be ranked by the color number. Keeping lower numbers for a longer time mean better effectiveness of the radical scavenger package.

The adhesion is tested using a probe tack tester (Testing Machines Inc., machine 80-02-01) according to ASTM D2979-95 (DIN 55405). Higher gram value means higher tack and is preferred.

Peel tests at 1800 was done according to FTM 1 (FINAT Technical Handbook 7th edition, 2005) respectively ASTM D 1000. Higher values mean better adhesion

Shear adhesion testing was done according to FTM 8 respectively ASTM D-6463. Higher values mean better cohesion. Shore Hardness was performed by ASTM D 2240. Higher values mean better retention of properties.

Test were performed in a commercially available labeling adhesive D62779 from company Bühnen.

TABLE 4
Test Results were obtained with a 1%
addition of the stabilizer a follow:

| | | |
|---|---|---|
| hrs | Not Stabilized | V7 |

Gardner Color after hrs aging at 177° C. according to ASTM D 4499

| | | |
|---|---|---|
| 0 | 4 | 4 |
| 4 | 9 | 6 |
| 8 | 11 | 8 |
| 12 | 13 | 12 |

Probe Tack [gr] after aging at 177° C. according to ASTM D 4499

| | | |
|---|---|---|
| 8 | 473 | 548 |
| 12 | 427 | 538 |
| 24 | 21 | 262 |

Peel Values [N/25 mm] after aging according to ASTM D 4499

| | | |
|---|---|---|
| 12 | 5.7 | 6.2 |

Shear Values [min] after aging according to ASTM D 4499

| | | |
|---|---|---|
| 12 | 18 | 29 |

It is evident from table 3 that the stabilizer composition is highly stable for long time as powder and/or granule. Further, table 4 discloses that the stabilizer composition provides better protection against degradation, improved tack, stronger adhesion and improved shear values.

1.-49. (canceled)

50. A composition (S) comprising
a. microfibrillar cellulose (A);
b. at least one stabilizer compound (B) having at least one thioether functional group; and
c. at least one component (C) selected from the group consisting of 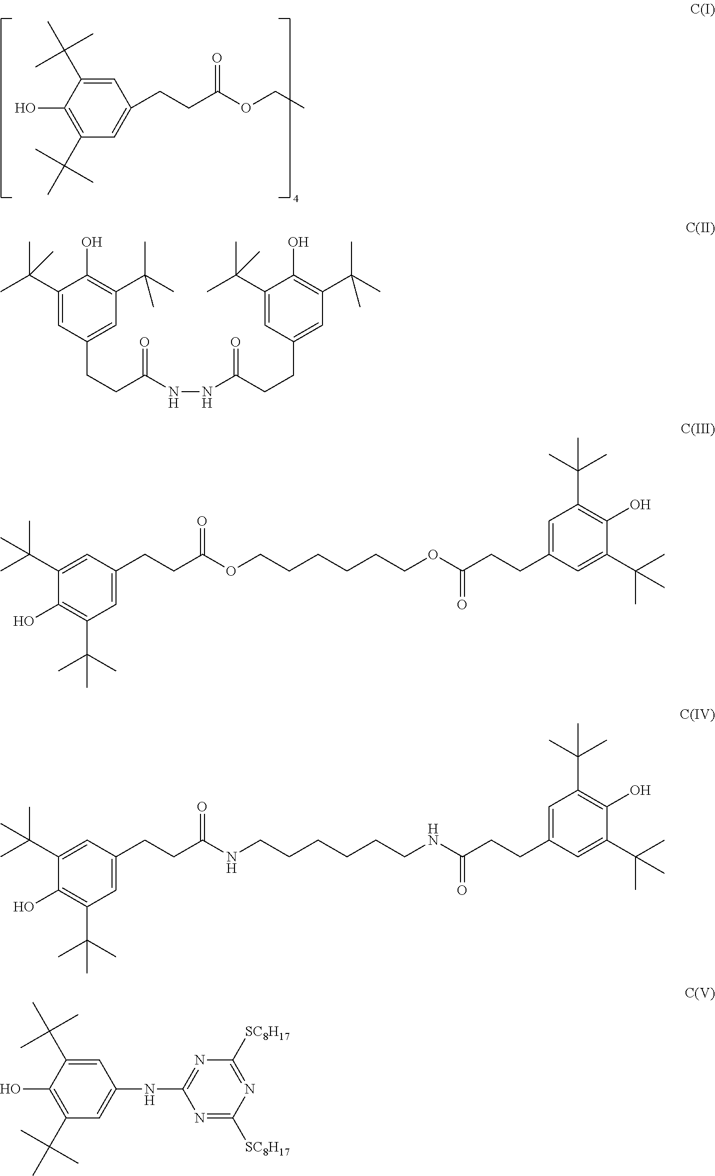 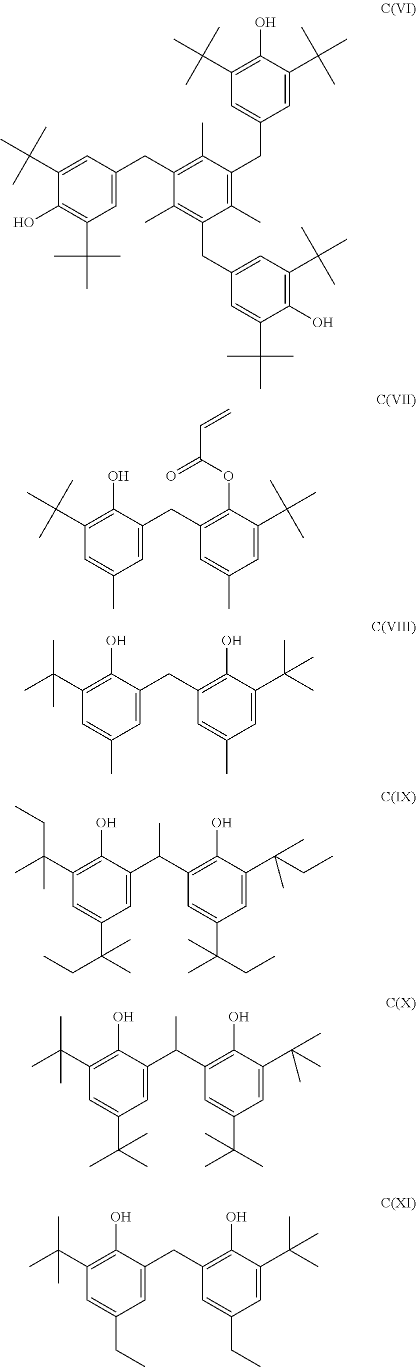 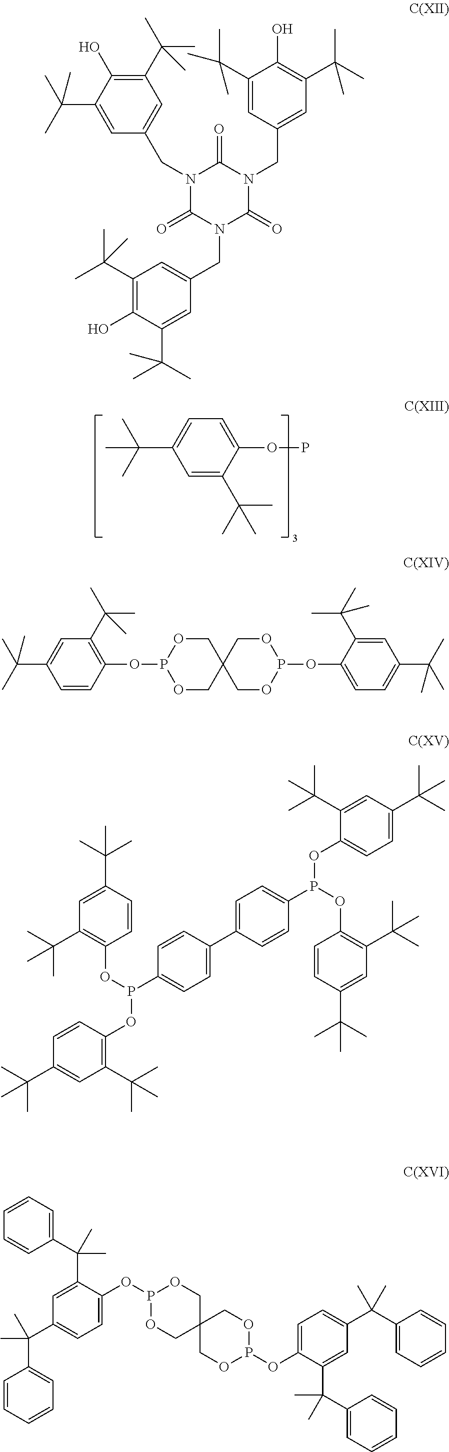 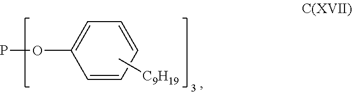
and mixtures thereof,
wherein the at least one stabilizer compound (B) is absorbed on the microfibrillar cellulose (A) and the absorbed stabilizer compound (B) is at least partly coated with component (C).

51. The composition (S) according to claim 50 comprising
a. microfibrillar cellulose (A);
b. at least one stabilizer (B) selected form the group consisting of 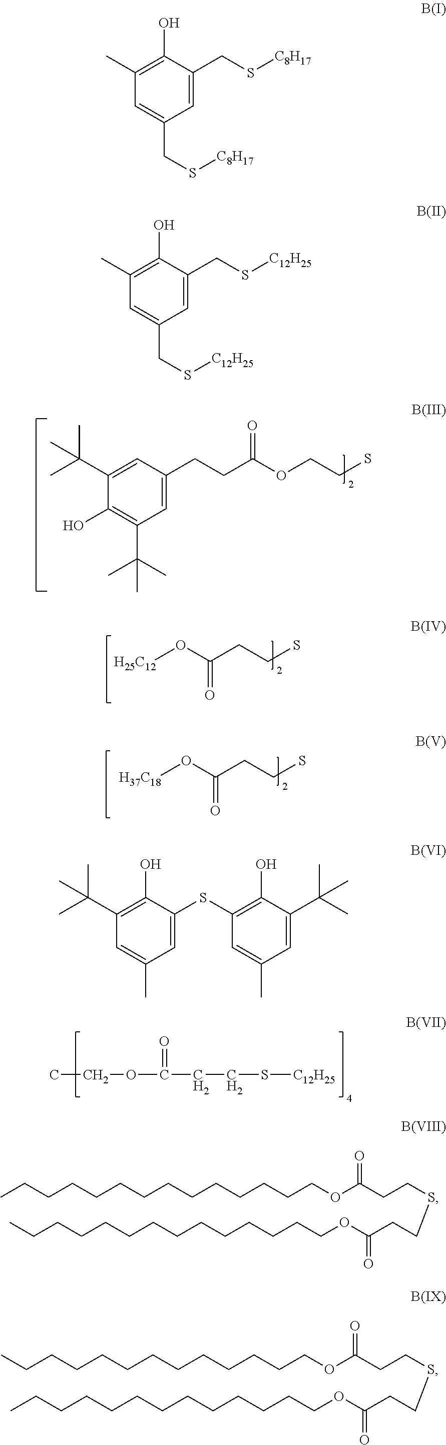
and mixtures thereof, and
c. at least one component (C) selected from the group consisting of 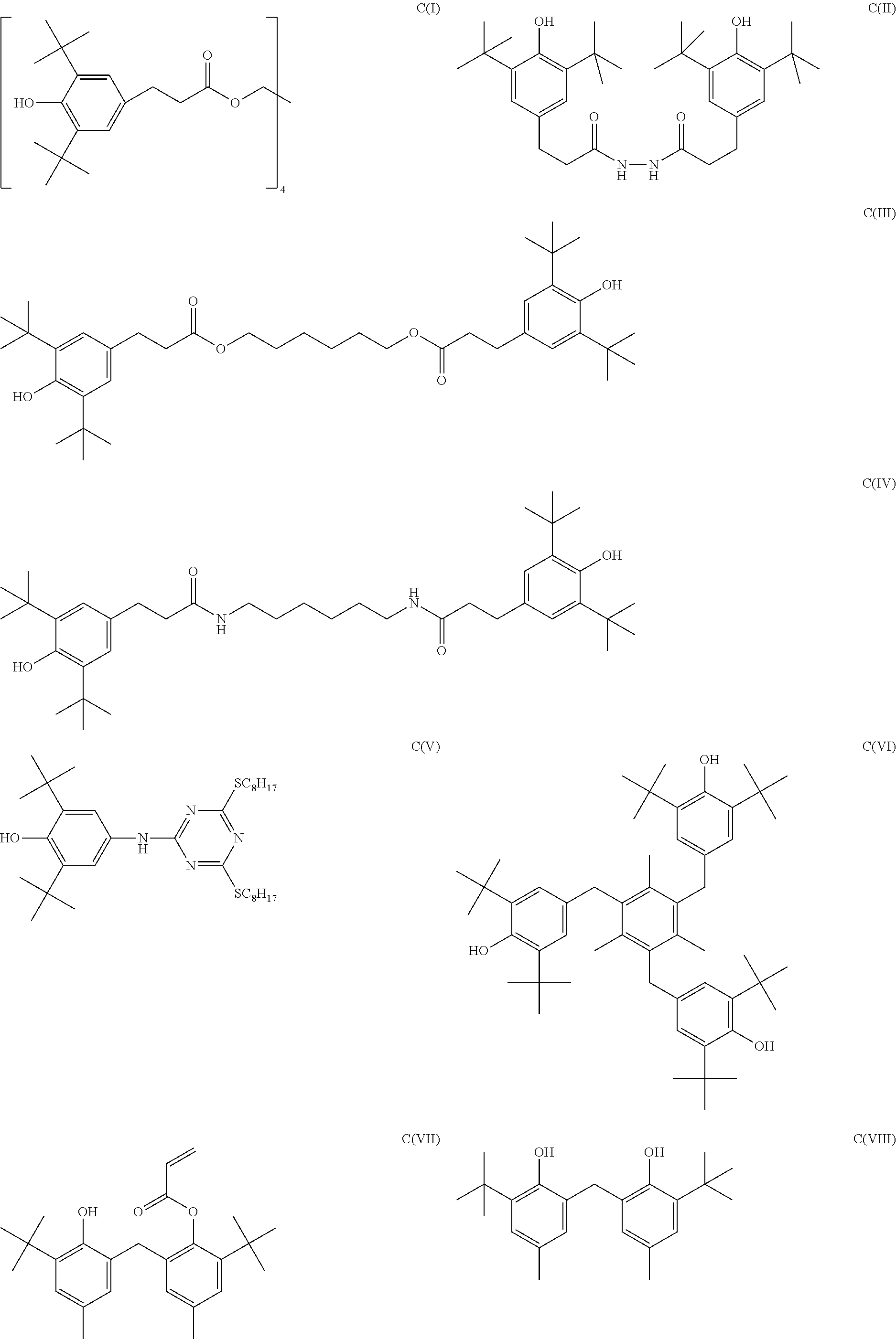 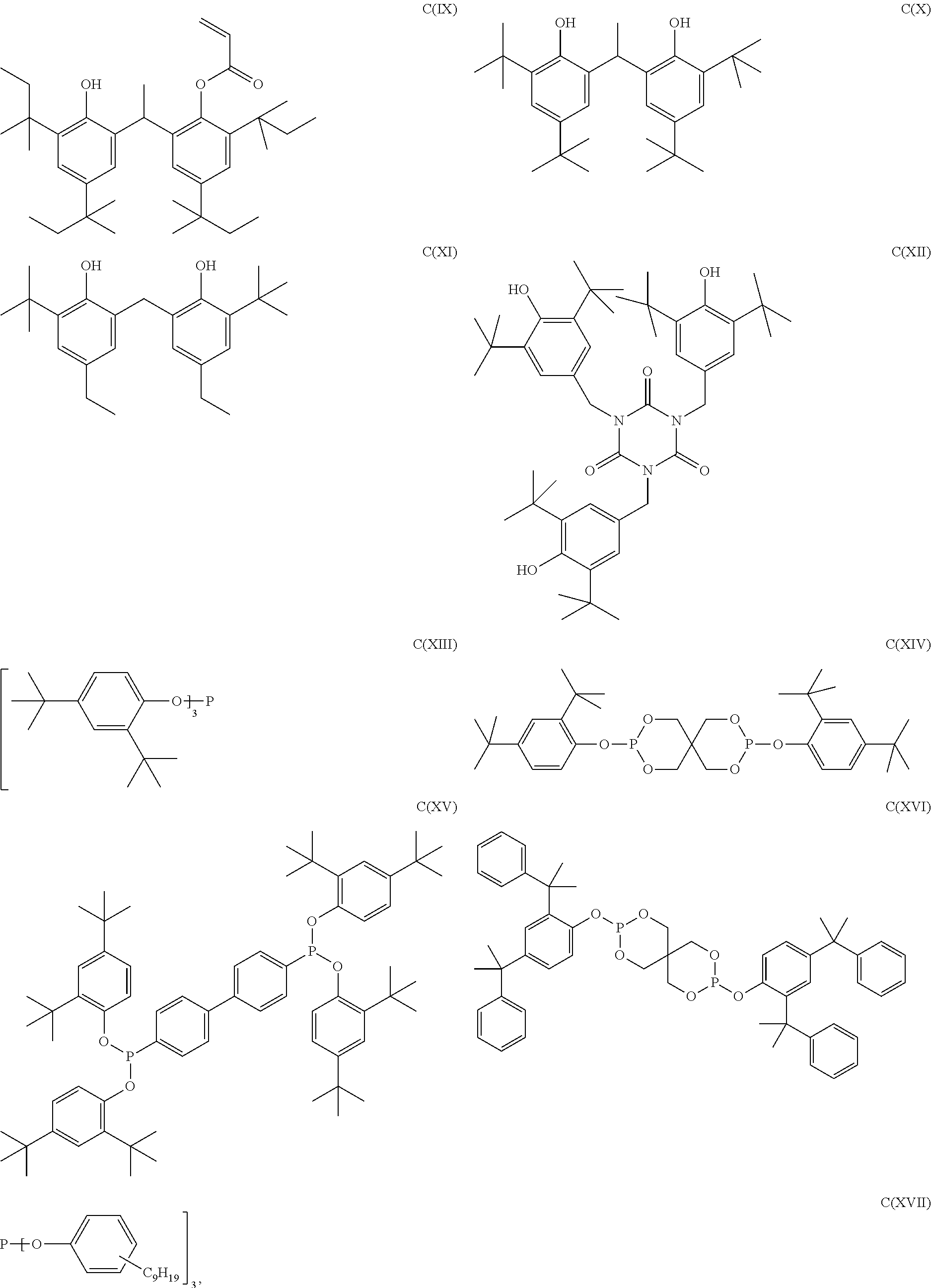
and mixtures thereof,
wherein the at least one stabilizer (B) is absorbed on the microfibrillar cellulose (A) and wherein the absorbed stabilizer (B) is at least partly coated with component (C).

52. The composition (S) according to claim 50, wherein the microfibrillar cellulose has a length in the range of 10 to 500 μm.

53. The composition (S) according to claim 50, wherein the microfibrillar cellulose has an aspect ratio in the range of 1:1 to 1:6.

54. The composition (S) according to claim 50, wherein the total weight ratio of at least one component (C) to the microfibrillar cellulose (A) is in the range of 1:10 to 10:1.

55. The composition (S) according to claim 50, wherein the total weight ratio of at least one stabilizer (B) to the at least one component (C) is in the range of 1:10 to 10:1.

56. The composition (S) according to claim 50, further comprises at least one component (D) selected from the group consisting of 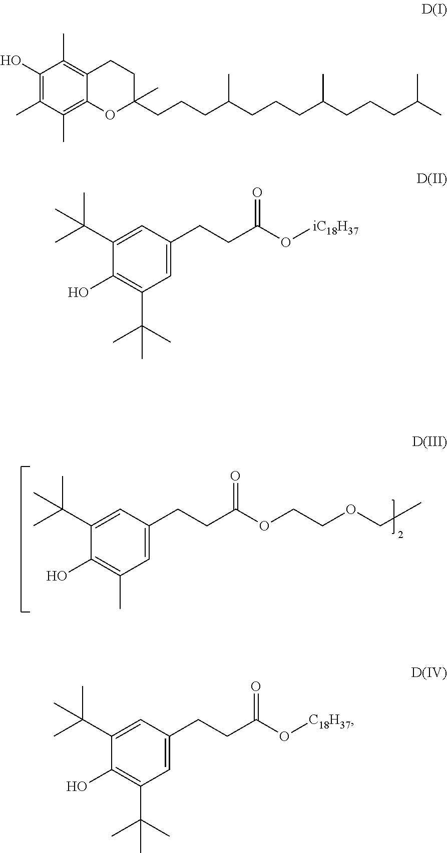
and mixtures thereof.

57. The composition (S) according to claim 50, wherein component (D) is present in a total amount in the range of 0 to 60 wt. % based on weight of the stabilizer (B).

58. The composition (S) according to claim 50, further comprises at least one component selected from the group consisting of (E), (F) and mixtures thereof,
wherein the component (E) is selected from the group consisting of 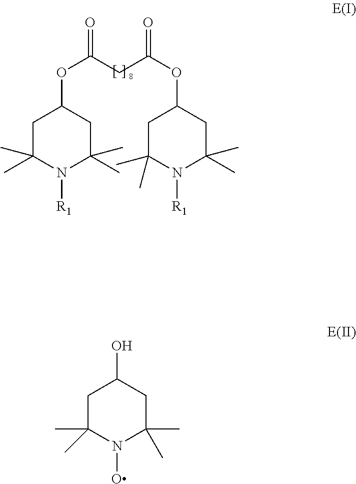
wherein R₁ is independently selected from the group consisting of H, CH₃ and OC₈H₁₇; 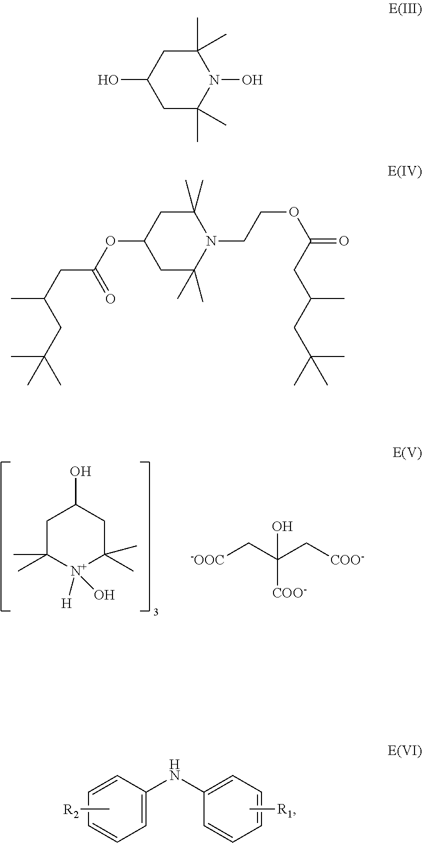
R1 and R2 independently selected form H, or C1-C20 alkyl,
and mixtures thereof, and (F) is a polyalkylenimine polymer (F).

59. The composition (S) according to claim 58, wherein the polyalkylenimine polymer (F) has weight average molecular weight in the range of 500 to 50000 g/mol as determined according to GPC using THE as solvent.

60. The composition (S) according to claim 50, wherein the polyalkylenimine polymer (F) is a branched polyalkyleneimine.

61. The composition (S) according to claim 50, wherein the component (E) is present in a total amount in the range of 0 to 10 wt. % based on overall weight of the composition.

62. A process for the preparation of a stabilizer composition (S) comprising the steps of:
a. providing the microfibrillar cellulose (A);
b. providing at least one component (C) to obtain a mixture of component (A) and at least one component (C); and
c. dispensing at least one stabilizer (B) to the mixture obtained in step b. to obtain a ternary mixture,
e. mixing the ternary mixture obtained step c to obtain the homogenous composition, wherein component (A), stabilizer (B) and component (C) are as defined as above.

63. The process according to claim 62, wherein the process further comprises a step of:
d. providing at least one component (D) and/or at least one component (E) and/or polyethyleneimine polymer (F),
wherein component (D), component (E), polyethyleneimine polymer (F) are as defined as above.

64. The process according to claim 62, wherein the stabilizer (B) is maintained at a temperature in the range of 20 to 150° C.

65. A stabilized hot melt adhesive composition comprising:
i. At least one hot melt adhesive materials selected from the group consisting of natural rubber, synthetic rubber such as butyl rubber, ethylene-propylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymers, and mixtures thereof, and
ii. a composition (S) according to claim 50.

66. The stabilized hot melt adhesive composition according to claim 65 further comprises at least one component (G) selected from the group consisting of; 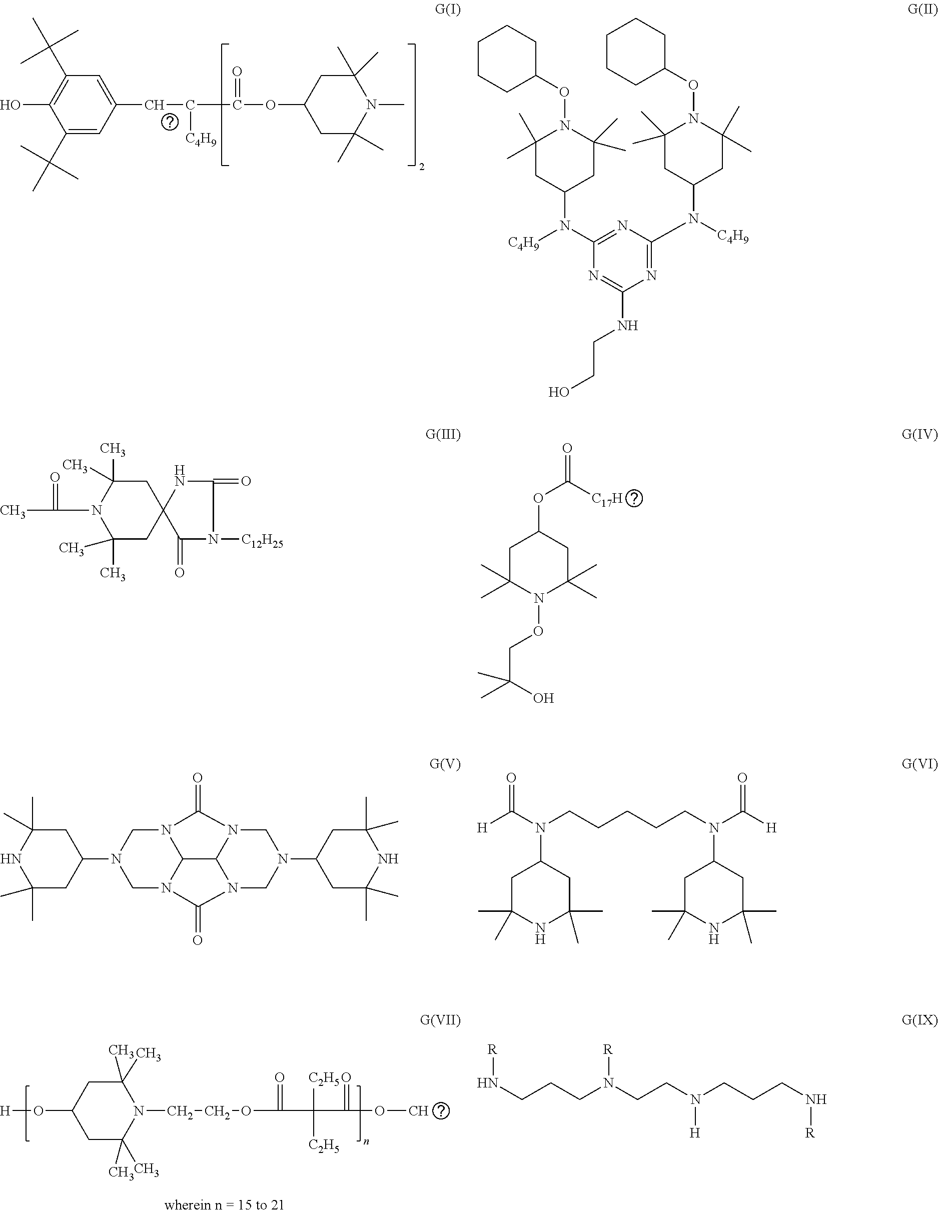 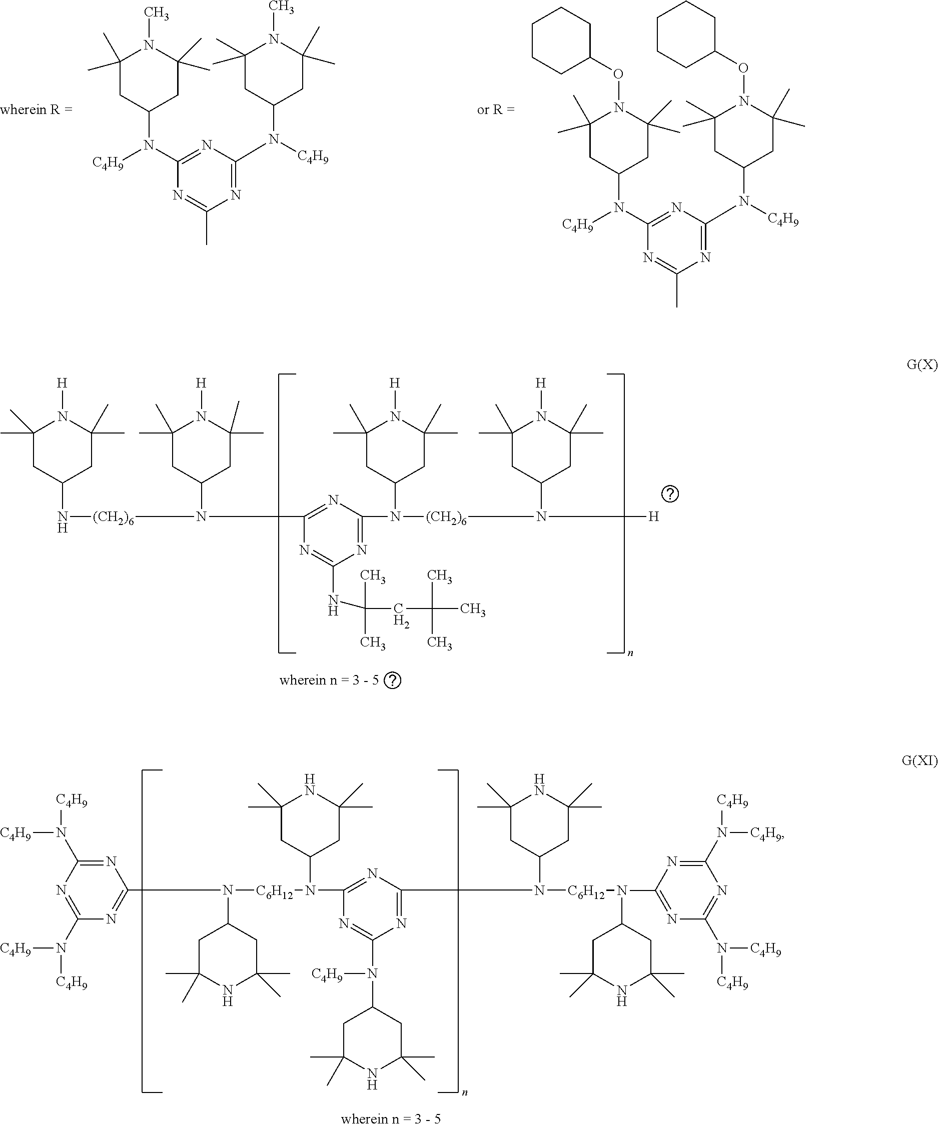 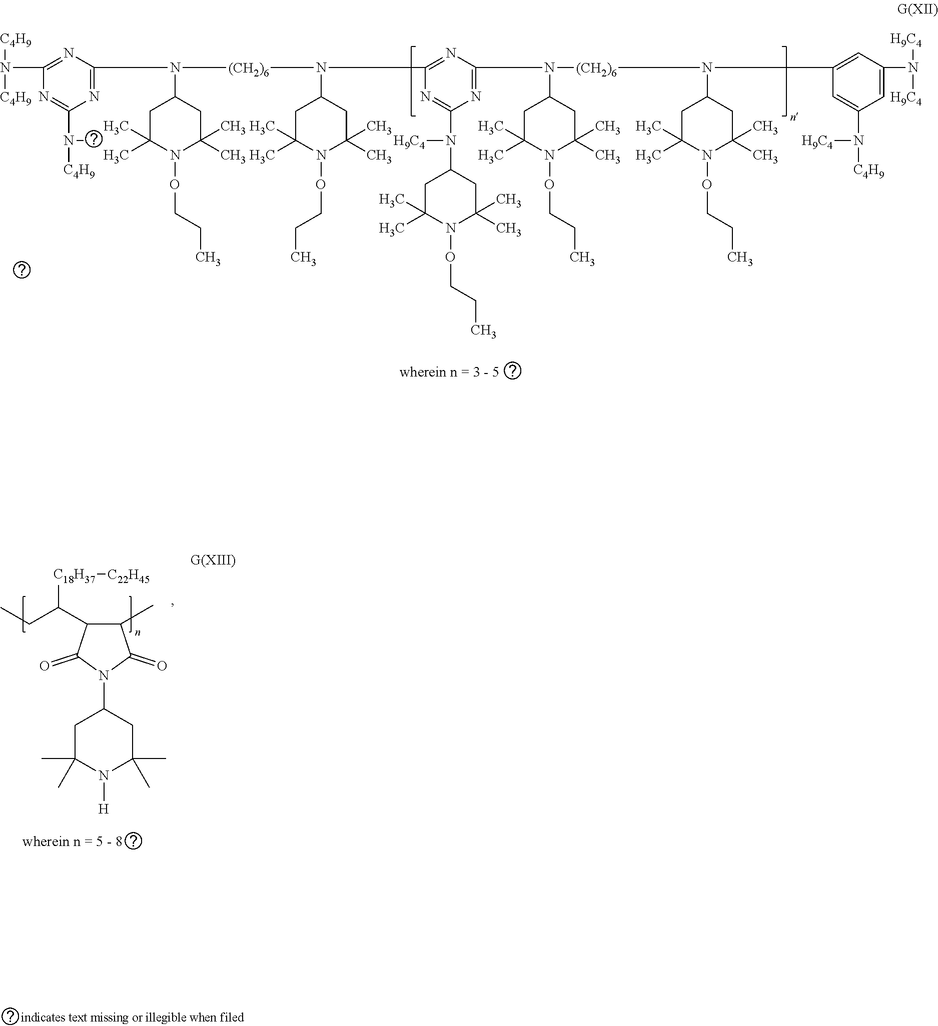
and mixtures thereof.

67. A method of stabilizing a hot melt adhesive against degradation by one or more of light, oxygen and heat, comprising the steps of:
a. providing one or more hot melt adhesive materials selected from the group consisting of natural rubber, synthetic rubber such as butyl rubber, ethylene-propylene-diene monomer (EPDM) rubber, styrenic block polymers such as styrene-isoprene-styrene (SIS) block, styrene-butadiene-styrene (SBS), styrene-ethylene-butadiene-styrene (SEBS), styrene-polyolefin-styrene SEPS other block polymers like acryl copolymer polyacrylate, ethylene vinyl acetate, polyamide, polyester, polyolefine, polyurethane, polyimide, silane-modified polyolefin, silane-modified polyether, silane-modified polyurethane and silane-modified acrylic polymers, and mixtures thereof, and
b. adding a composition (S) as defined in claim 50.

68. The method according to claim 67, wherein the method further comprises a step of
a. providing at least one component (G) selected from the group consisting of; 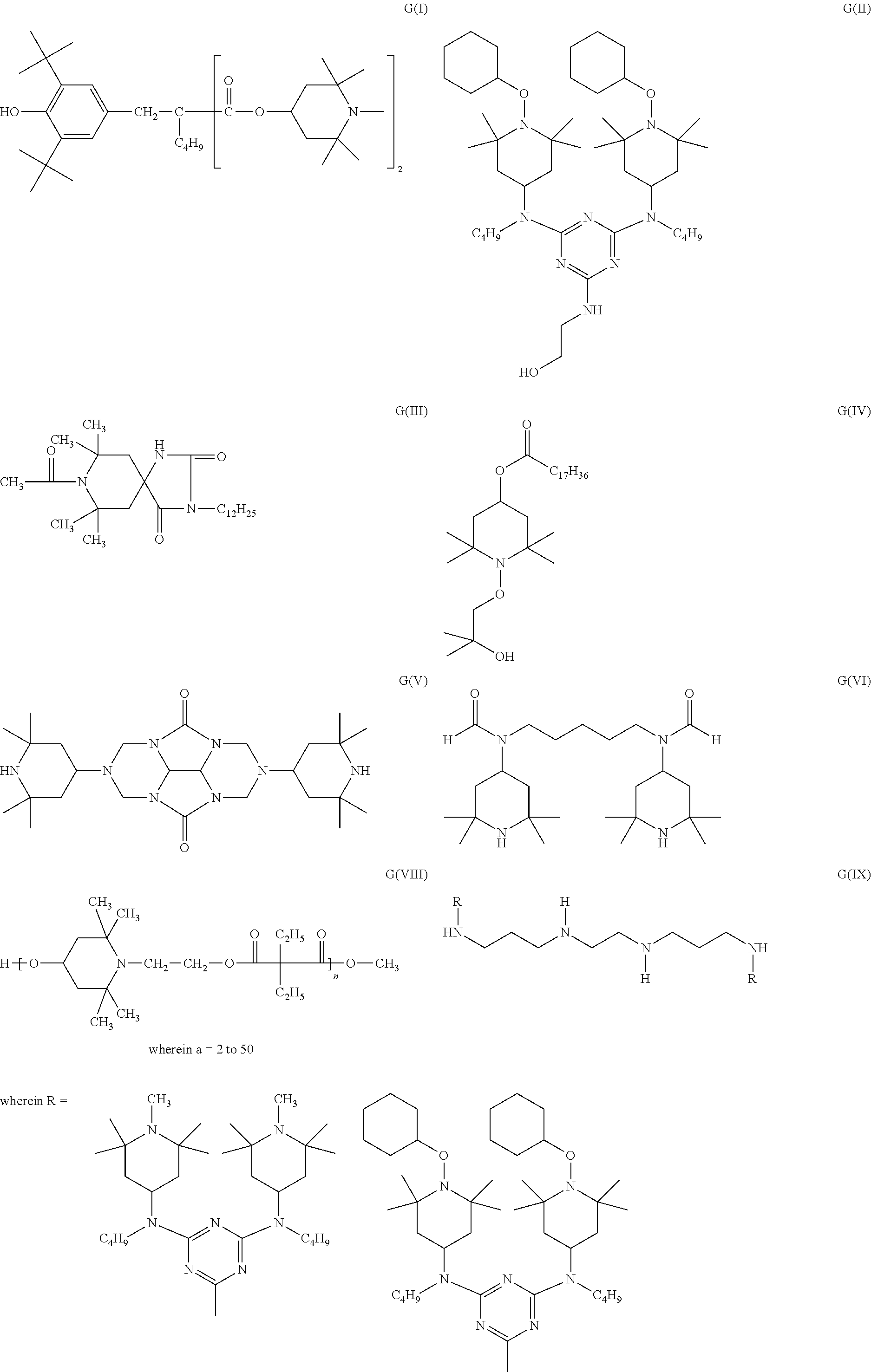 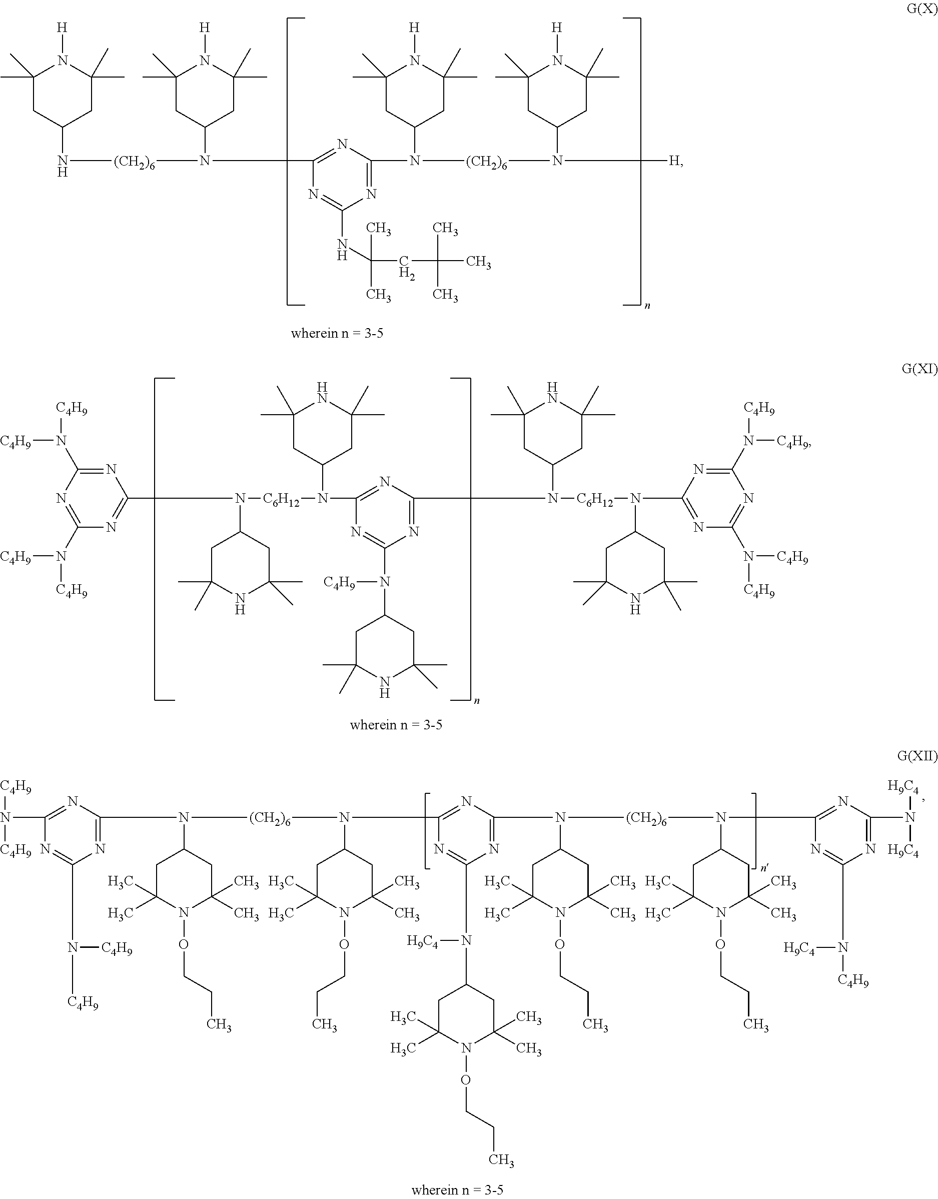 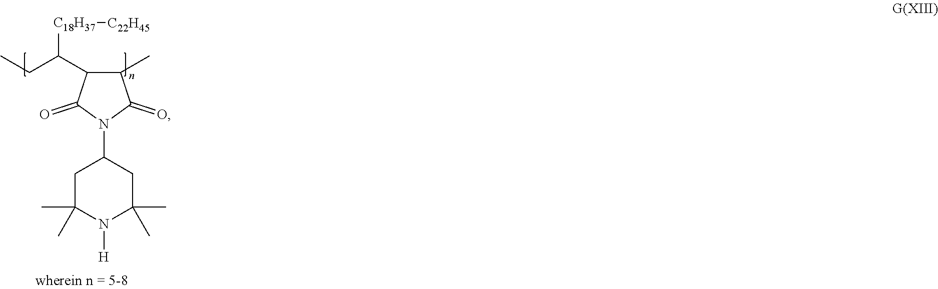
and mixtures thereof.

69. A method for stabilizing a hot melt adhesive a sealant and/or a coating comprising utilize the composition according to claim 50.
